(19) United States
(12) Patent Application Publication
(10) Pub. No.: US 2006/0223872 A1
(43) Pub. Date: Oct. 5, 2006

(54) Insecticidal phthalamide derivatives

(76) Inventors: Katsuaki Wada, Tochigi (JP); Takuya Gomibuchi, Ibaraki (JP); Yasushi Yoneta, Saitama (JP); Yuichi Otsu, Tochigi (JP); Katsuhiko Shibuya, Tochigi (JP); Hanako Matsuo, Ibaraki (JP); Rudiger Fischer, Monheim (DE)

Correspondence Address: BAYER CROPSCIENCE LP;Patent Department, 100 BAYER ROAD, PITTSBURGH, PA, 15205-9741, US

(21) Appl. No.: 10/549,080

(22) PCT Filed: Mar. 1, 2004
(86) PCT No.: PCT/EP04/02024

§ 371 Date: Feb. 2, 2006

(30) Foreign Application Priority Data
Mar. 14, 2003 (JP) 2003-70274

(51) Int. Cl. A01N 43/76; A01N 43/56; A01N 43/36; A01N 43/06; A01N 43/08; A01N 37/18

(52) U.S. Cl. 514/374; 514/396; 514/426; 514/471; 514/447; 514/616; 514/406; 548/233; 548/326.5; 548/367.4; 549/68; 548/557; 564/154; 549/424

(57) ABSTRACT

This invention relates to novel insecticidal phthalamide derivatives of formula (I) 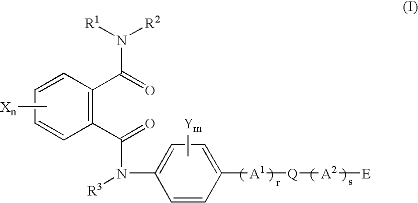
in which X, n, Y, m, R¹, R², R³, A¹, r, A², s, Q and E have the meanings given in the disclosure, to a plurality of processes for preparing these compounds, and to their use for controlling pests.

The present invention relates to novel phthalamide derivatives; to processes for their preparation and to their use as insecticides.

Certain phthalamide derivatives showing an action as insecticide are already known (cf. EP-A 0 919 542, WO 01/00575, JP-A 2001-64268, EP-A 1 006 107, JP-A 2003-40864, WO 01/21576 and WO 03/11028). Further, it is already known that certain phthalamide derivatives show an action as pharmaceutical (cf. EP-A 0 119 428).

The conventional phthalamide derivatives, however, are not fully satisfactory in terms of effects as insecticide.

There have now been found novel phthalamide derivatives of the following formula (I) 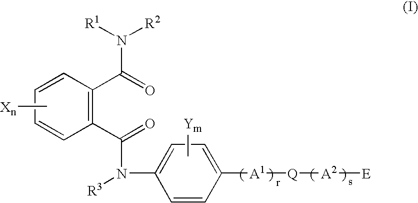
wherein
X represents hydrogen, halogen, C₁-C₆-alkyl, C₁-C₆-haloalkyl, nitro, cyano, C₁-C₆-alkylsulfonyloxy, C₁-C₆-haloalkylsulfonyloxy, phenylsulfonyloxy, C₁-C₆-alkylthio-C₁-C₆-alkyl, C₁-C₆-alkylsulfinyl-C₁-C₆-alkyl, C₁-C₆-alkylsulfonyl-C₁-C₆-alkyl, C₁-C₆-alkylsulfonylamino, bis(C₁-C₆-alkylsulfonyl)amino or C₁-C₆-alkylcarbonyloxy,
n represents 1, 2, 3 or 4,
Y represents hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-haloalkylthio or cyano,
m represents 1, 2, 3 or 4,
R¹ represents C₁-C₈-alkyl, C₁-C₈-alkyl which is mono- or poly-substituted by substituents selected from the group consisting of cyano, nitro, C₁-C₆-alkylaminosulfonyl, N,N-di(C₁-C₆-alkyl)aminosulfonyl, C₁-C₆-alkylsulfonylamino, N—C₁-C₆-alkylsulfonyl-N-C₁-C₆-alkylamino, C₁-C₆-alkyl-carbonylamino, halo-C₁-C₆-alkyl, N—C₁-C₆-alkyl-carbonyl-N-C₁-C₆-alkylamino, C₁-C₆-alkyl-thiocarbonylamino, N—C₁-C₆-alkylthiocarbonyl-N—C₁-C₆-alkylamino, C₁-C₆-alkoxyimino-C₁-C₆-alkyl, C₁-C₆-alkyl-aminocarbonyl, N,N-di(C₁-C₆-alkyl)-aminocarbonyl, C₁-C₆-alkyl-aminothiocarbonyl, N,N-di(C₁-C₆-alkyl)-aminothiocarbonyl, C₁-C₆-alkoxy-carbonylamino, C₁-C₆-alkoxy-carbonyl-C₁-C₆-alkylamino, C₁-C₆-alkylamino-carbonyloxy, N,N-di(C₁-C₆-alkyl)amino-carbonyloxy, C₁-C₆-alkoxy-thiocarbonylamino, C₁-C₆-alkoxy-thiocarbonyl-C₁-C₆-alkylamino, C₁-C₆-alkylamino-thiocarbonyloxy, N,N-di(C₁-C₆alkyl)-amino-thiocarbonyloxy, C₁-C₆-alkylthio-carbonylamino, C₁-C₆-alkylthio-carbonyl-C₁-C₆-alkylamino, C₁-C₆-alkylamino-carbonylthio, N,N-di(C₁-C₆-alkyl)amino-carbonylthio, C₃-C₆-alkylthio-thiocarbonylamino, C₁-C₆-alkylthio-thiocarbonyl-C₁-C₆-alkylamino, C₁-C₆-alkylamino-thiocarbonylthio, N,N-di(C₁-C₆-alkyl)amino-thiocarbonylthio, C₃-C₆-cycloalkyl, C₁-C₆-alkoxy-C₁-C₆-alkyl, C₁-C₆-alkylthio-C₁-C₆-alkyl, C₁-C₆-alkylsulfinyl-C₁-C₆-allyl and C₁-C₆-alkylsulfonyl-C₁-C₆-alkyl, or represents C₃-C₈-cycloalkyl which may be substituted by substituents selected from the group consisting of C₁-C₄-alkyl, C₁-C₄-alkylthio or C₁-C₂-alkylthio-C₁-C₂-alkyl,
R² represents hydrogen or C₁-C₆-alkyl,
R³ represents hydrogen or C₁-C₆-alkyl,
A¹ represents straight chain or branched chain C₁-C₈-alkylene, C₁-C₈-haloalkylene, C₂-C₈-alkenylene, C₂-C₈-haloalkenylene, C₂-C₈-alkynylene, C₂-C₈-haloalkynylene, C₁-C₈-alkylene-amino, C₁-C₈-alkylene(C₁-C₆-alkylamino), C₁-C₈-alkyleneoxy or C₁-C₈-alkylenethio,
r represents 0 or 1,
A² represents straight chain or branched chain C₁-C₈-alkylene, C₂-C₈-haloalkylene, C₂-C₈-alkenylene, C₂-C₈-haloalkenylene, C₂-C₈-alkynylene or C₂-C₈-haloalkynylene,
s represents 0 or 1,
Q represents a 5- or 6-membered heterocyclic group containing 1 to 4 hetero atoms selected from 0 to 4 nitrogen atom, 0 to 1 oxygen atom, and 0 to 1 sulphur atom, however not containing an oxygen atom and a sulphur atom at the same time, and said heterocyclic group may have one to three 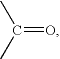
   one to three 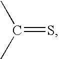
   one 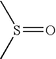
   or one 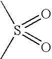
as ring constituent, and said heterocyclic group may be optionally substituted with at least one or more substituents selected from the below-mentioned group of substituents W¹ wherein said substituents may be identical or different,
W¹ represents halogen, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio, C₁-C₆-haloalkylsulfinyl, C₁-C₆-haloalkylsulfonyl, C₃-C₆-Cycloalkyl, C₁-C₆-alkylthio-C₁-C₆-alkyl, C₁-C₆-alkylsulfinyl-C₁-C₆-alkyl, C₁-C₆-alkylsulfonyl-C₁-C₆-alkyl,
E represents phenyl, biphenyl, naphthyl, pyridyl, pyridazinyl, pyrimidinyl, pyrazinyl, thienyl, furyl or pyrrolyl, wherein said group is optionally mono- or poly-substituted by substituents selected from the group W² wherein said substituents may be identical or different,
W² represents halogen, nitro, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio, C₁-C₆-haloalkylsulfinyl, C₁-C₆-haloalkylsulfonyl, C₃-C₆-cycloalkyl, C₁-C₆-alkylthio-C₁-C₆-alkyl, C₁-C₆-alkylsulfinyl-C₁-C₆-alkyl or C₁-C₆-alkylsulfonyl-C₁-C₆-alkyl, or represents C₃-C₅-allylene, C₃-C₅-haloalkylene, oxy-C₂-C₄-alkylene, oxy-C₂-C₄-haloalkylene, C₂-C₄-alkyleneoxy, C₁-C₄-haloalkyleneoxy, C₁-C₃-alkylenedioxy or C₁-C₃-haloalkylenedioxy, in case that W² are two adjacent substituents.

Depending, if appropriate, on the type and number of substituents, the compounds of the formula (I) can be present as geometrical and/or optical isomers, regioisomers and/or configurational isomers or isomer mixtures thereof of varying composition. What is claimed by the invention are both the pure isomers and the isomer mixtures.

The compounds of the formula (I) of the present invention can be obtained, for example, by the following preparation processes (a), (b), (c), (d), (e) and (f):

Preparation Process (a): in case that R² in the Formula (I) Represents Hydrogen.

A process of reacting compounds of the formula (II) 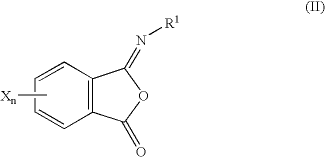
wherein R¹, X and n have the same definition as aforementioned,
with compounds of the formula all) 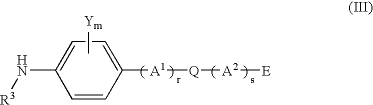
wherein R³, Y, m, A¹, r, Q, A², s and E have the same definition as aforementioned, in the presence of inert solvents.
   Preparation Process (b): in Case that R³ in the Formula (I) Represents Hydrogen Atom.
A process of reacting compounds of the formula (IV) 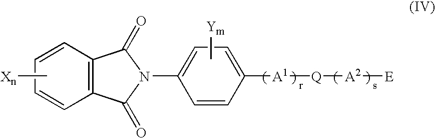
wherein X, n, Y, m, A¹, r, Q, A², s and E have the same definition as aforementioned, with compounds of the formula (V) 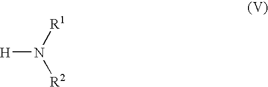
wherein R¹ and R² have the same definition as aforementioned,
in the presence of inert solvents, and if appropriate, in the presence of a base.
   Preparation Process (c):
A process of reacting a compound represented by the formula (VI) 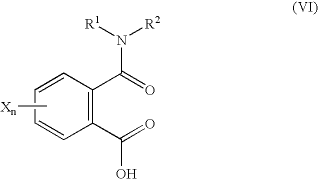
wherein X, n, R¹ and R² have the same definition as aforementioned,
with the compounds of the formula (III), 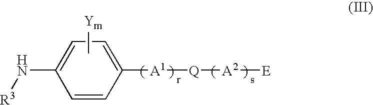
wherein R³, Y, m, A¹, r, Q, A², s and E have the same definition as aforementioned, in the presence of inert solvents.
   Preparation Process (d): in Case that R³ in the Formula (I) Represents Hydrogen Atom.
A process of reacting compounds of the formula (VII) 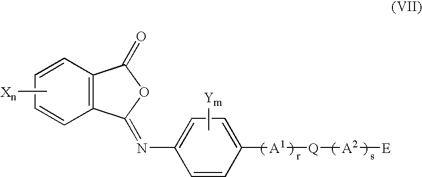
wherein X, n, Y, m, A¹, r, Q, A², s and E have the same definition as aforementioned, with the compounds of the formula (V), 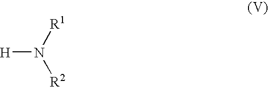
wherein R¹ and R² have the same definition as aforementioned,
in the presence of inert solvents.
   Preparation Process (e):
A process of reacting a compounds of the formula (VIII) 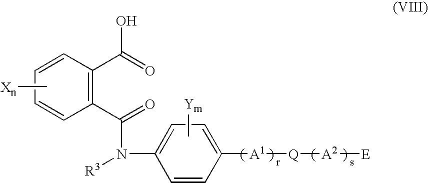
wherein X, n, R³, Y, m, A¹, r, Q, A², s and E have the same definition as aforementioned, with the compounds of the formula (V), 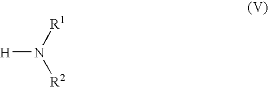
wherein R¹ and R² have the same definition as aforementioned,
in the presence of inert solvents.
   Preparation Process (f): in Case that R¹ in the Formula (I) Represents C₁-C₆-alkylsulfinyl-C₁-C₆-alkyl or C₁-C₆-alkylsulfonyl-C₁-C₆-alkyl.
A process of reacting compounds of the formula (If) 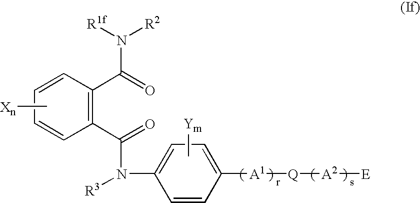
wherein R^{1f} represents C₁-C₆-alkylthio-C₁-C₆-alkyl, and
X, n, R², R³, Y, m, A¹, r, Q, A², s and E have the same definition as aforementioned, with an oxidizing agent in the presence of inert solvents.

According to the present invention, the phthalamide derivatives of the aforementioned formula (a) show strong insecticidal action.

The formula (I) provides a general definition of the phthalamide derivatives according to the invention.

Preferred substituents or ranges of radicals listed in the formulae mentioned above and below are illustrated below:
X preferably represents hydrogen, halogen, C₁-C₄-alkyl, C₁-C₄-haloalkyl, nitro, cyano, C₁-C₄-alkylsulfonyloxy, C₁-C₄-haloalkylsulfonyloxy, phenylsulfonyloxy, C₁-C₄-alkylthio-C₁-C₄ alkyl, C₁-C₄-alkylsulfonyl-C₁-C₄-alkyl, C₁-C₄-alkylsulfonyl-C₁-C₄-alkyl, C₁-C₄-alkylsulfonylamino, bis(C₁-C₄-alkylsulfonyl)amino or C₁-C₄-alkylcarbonyloxy.
X particularly preferably represents hydrogen, fluorine, chlorine, bromine, iodine, methyl, ethyl, n- or iso-propyl, n-, sec-, iso- or tert-butyl, trifluoromethyl, difluoromethyl, dichlorofluoromethyl, trichloromethyl, nitro, cyano, methylsulfonyloxy, ethylsulfonyloxy, trifluoromethylsulfonyloxy, phenylsulfonyloxy, methylthiomethyl, methylthioethyl, ethylthiomethyl, ethylthioethyl, methylsulfinylmethyl, methylsulfinylethyl, ethylsulfinylmethyl, ethylsulfinylethyl, methylsulfonylmethyl, methylsulfonylethyl, ethylsulfonylmethyl, ethylsulfonylethyl, methylsulfonylamino, ethylsulfonylamino, di(methylsulfonyl)amino, di(ethylsulfonyl)amino, methylcarbonyloxy or ethylcarbonyloxy.
X very particularly preferably represents hydrogen, fluorine, chlorine, bromine, iodine, methyl, tert-butyl, trifluoromethyl, nitro, cyano, methylsulfonyloxy, ethylsulfonyloxy, trifluoromethylsulfonyloxy, phenylsulfonyloxy, methylsulfonylamino, di(methylsulfonyl)amino or methylcarbonyloxy.
n preferably represents 1, 2 or 4.
n particularly preferably represents 1.
n furthermore, particularly preferably represents 2.
n furthermore, particularly preferably represents 4.
Y preferably represents hydrogen, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio or cyano.
Y particularly preferably represents hydrogen, fluorine, chlorine, bromine, methyl, ethyl, n- or iso-propyl, n-, sec-, iso- or tert-butyl, trifluoromethyl, difluoromethyl, dichlorofluoromethyl, trichloromethyl, methoxy, ethoxy, n- or iso-propoxy, n-, sec-, iso- or tert-butoxy, trifluoromethoxy, methylthio, ethylthio, n- or iso-propylthio, n-, sec-, iso- or tert-butylthio, trifluoromethylthio or cyano.
Y very particularly preferably represents hydrogen, chlorine, methyl, trifluoromethyl, methoxy or trifluoromethoxy.
m preferably represents 1 or 2.
m particularly preferably represents 1.
m furthermore, particularly preferably represents 2.
R¹ preferably represents C₁-C₆-alkyl, C₁-C₆-alkyl which is mono- or poly-substituted by substituents selected from the group consisting of cyano, nitro, C₁-C₄-alkylaminosulfonyl, N,N-di(C₁-C₄-alkyl)aminosulfonyl, C₁-C₄-alkylsulfonylamino, N—C₁-C₄-alkylsulfonyl-N—C₁-C₄-alkylamino, C₁-C₄-alkyl-carbonylamino, halo-C₁-C₄-alkyl, N—C₁-C₄-alkyl-carbonyl-N—C₁-C₄-alkylamino, C₁-C₄-alkyl-thiocarbonylamino, N—C₁-C₄-alkylthiocarbonyl-N—C₁-C₄-alkylamino, C₁-C₄-alkoxyimino-C₁-C₄-alkyl, C₁-C₄-alkyl-aminocarbonyl, N,N-di(C₁-C₄-alkyl) aminocarbonyl, C₁-C₄-alkyl-aminothiocarbonyl, N,N-di(C₁-C₄-alkyl)-aminothiocarbonyl, C₁-C₄-alkoxy-carbonylamino, C₁-C₄-alkoxy-carbonyl-C₁-C₄-alkylamino, C₁-C₄-alkylamino-carbonyloxy, N,N-di(C₁-C₄-alky)amino-carbonyloxy, C₁-C₄-alkoxy-thiocarbonylamino, C₁-C₄-alkoxy-thiocarbonyl-C₁-C₄-alkylamino, C₁-C₄-alkylamino-thiocarbonyloxy, N,N-di(C₁-C₄-alkyl)amino-thiocarbonyloxy, C₁-C₄-alkylthio-carbonylamino, C₁-C₄-alkylthio-carbonyl-C₁-C₄-alkylamino, C₁-C₄-alkylamino-carbonylthio, N,N-di(C₁-C₄-alkyl)amino-carbonylthio, C₁-C₄-alkylthio-thiocarbonylamino, C₁-C₄-alkylthio-thiocarbonyl-C₁-C₄-alkylamino, C₁-C₄-alkylamino-thiocarbonylthio, N,N-di(C₁-C₄-alkyl)amino-thiocarbonylthio, C₃-C₆-cycloalkyl, C₁-C₄-alkoxy-C₁-C₄-alkyl, C₁-C₄-alkylthio-C₁-C₄-alkyl, C₁-C₄-alkylsulfinyl-C₁-C₄-alkyl and C₁-C₄-alkylsulfonyl-C₁-C₄-alkyl, or represents C₃-C₆-cycloalkyl which may be substituted by C₁-C₂-alkyl, C₁-C₂-alkylthio or C₁-C₂-alkylthio-C₁-C₂-alkyl.
R¹ particularly preferably represents methyl, ethyl, n- or iso-propyl, n-, sec-, iso- or tert-butyl, n-pentyl, 1-methylbutyl, 1-ethylpropyl, n-hexyl, 1,3-dimethylbutyl; methyl, ethyl, n- or iso-propyl, n-, sec-, iso- or tert-butyl, each of which is mono- or poly-substituted by substituents selected from the group consisting of cyano, nitro, methylaminosulfonyl, ethylaminosulfonyl, N,N-di(methyl)aminosulfonyl, N,N-di(ethyl)aminosulfonyl, methylsulfonylamino, ethylsulfonylamino, N-methylsulfonyl-N-methylamino, N-ethylsulfonyl-N-methylamino, N-methylsulfonyl-N-ethylamino, N-ethylsulfonyl-N-ethylamino, methyl-carbonylamino, ethyl-carbonylamino, trifluoromethyl, pentafluoroethyl, N-methyl-carbonyl-N-methylamino, methylthio-carbonylamino, ethyl-thiocarbonylamino, N-methylthiocarbonyl-N-methylamino, methoxyimino-methyl, methoxyimino-ethyl, ethoxyimino-methyl, ethoxyimino-ethyl, methylaminocarbonyl, ethyl-aminocarbonyl, N,N-di(methyl)-aminocarbonyl, N,N-di(ethyl)-aminocarbonyl, methyl-aminothiocarbonyl, ethyl-aminothiocarbonyl, N,N-di(methyl)-aminothiocarbonyl, N,N-di(ethyl)-aminothiocarbonyl, methoxy-carbonylamino, ethoxy-carbonylamino, methoxy-carbonyl-methylamino, ethoxy-carbonyl-methylamino, methoxy-carbonyl-ethylamino, ethoxy-carbonyl-ethylamino, methylamino-carbonyloxy, ethylamino-carbonyloxy, N,N-di(methyl)amino-carbonyloxy, N,N-di(ethyl)amino-carbonyloxy, methoxy-thiocarbonylamino, ethoxy-thiocarbonylamino, methoxy-thiocarbonyl-methylamino, methoxy-thiocarbonyl-ethylamino, ethoxy-thiocarbonyl-methylamino, ethoxy-thiocarbonyl-ethylamino, methylamino-thiocarbonyloxy, ethylamino-thiocarbonyloxy, N,N-di(methyl)amino-thiocarbonyloxy, N,N-di(ethyl)amino-thiocarbonyloxy, methylthio-carbonylamino, ethylthio-carbonylamino, methylthio-carbonyl-methylamino, ethylthio-carbonyl-methylamino, methylthio-carbonyl-ethylamino, ethylthio-carbonyl-ethylamino, methylamino-carbonylthio, ethylamino-carbonylthio, N,N-di(methyl)amino-carbonylthio, N,N-di(ethyl)amino-carbonylthio, methylthio-thiocarbonylamino, ethylthio-thiocarbonylamino, methylthio-thiocarbonyl-methylamino, ethylthio-thiocarbonyl-methylamino, methylthio-thiocarbonyl-ethylamino, ethylthio-thiocarbonyl-ethylamino, methylamino-thiocarbonylthio, ethylamino-thiocarbonylthio, N,N-di(methyl)amino-thiocarbonylthio, N,N-di(methyl)amino-thiocarbonylthio, cyclopropyl, cyclopentyl, cyclohexyl, methoxy-methyl, ethoxy-methyl, methoxy-ethyl, ethoxy-ethyl, methylthiomethyl, ethylthio-methyl, methylthio-ethyl, ethylthio-ethyl, methylsulfinyl-methyl, ethylsulfinyl-methyl, methylsulfinyl-ethyl, ethylsulfinyl-ethyl, methylsulfonyl-methyl, ethylsulfonylmethyl, methylsulfonyl-ethyl, and ethylsulfonyl-ethyl; or represents cyclopropyl, cyclopentyl, cyclohexyl, each of which may be substituted by substituents selected from the group consisting of methyl, ethyl, methylthio, ethylthio, methylthiomethyl, ethylthiomethyl, methylthioethyl and ethylthioethyl.
R¹ very particularly preferably represents methyl, ethyl, n- or iso-propyl, n- or sec-butyl, n-pentyl, 1-methylbutyl, 1-ethylpropyl, 1,3-dimethylbutyl; methyl, ethyl, n- or iso-propyl, n-, sec-, iso- or tert-butyl, each of which is mono- or poly-substituted by substituents selected from the group consisting of cyano, methylaminosulfonyl, ethylaminosulfonyl, N,N-di(methyl)aminosulfonyl, N,N-di(ethyl)aminosulfonyl, N-methylsulfonyl-N-methylamino, methyl-carbonylamino, trifluoromethyl, pentafluoroethyl, methoxyimino-methyl, methoxyimino-ethyl, ethoxyimino-methyl, ethoxyimino-ethyl, methyl-aminocarbonyl, ethyl-aminocarbonyl, N,N-di(methyl)-aminocarbonyl, N,N-di(ethyl)-aminocarbonyl, methyl-aminothiocarbonyl, ethyl-aminothiocarbonyl, N,N-di(methyl)-aminothiocarbonyl, N,N-di(ethyl)-aminothiocarbonyl, methoxy-carbonylamino, methylamino-carbonyloxy, ethylamino-carbonyloxy, N,N-di(methyl)amino-carbonyloxy, N,N-di(ethyl)amino-carbonyloxy, methylamino-thiocarbonyloxy, N,N-di(methyl)amino-thiocarbonyloxy, methylamino-carbonylthio, ethylamino-carbonylthio, methylamino-thiocarbonylthio, ethylamino-thiocarbonylthio, cyclohexyl, methoxy-methyl, ethoxy-methyl, methylthio-methyl, methylsulfinyl-methyl and methylsulfonyl-methyl; or cyclopropyl, cyclopentyl, cyclohexyl, each of which may be substituted by substituents selected from the group consisting of methyl, methylthio and methylthiomethyl.
R² preferably represents hydrogen or C₁-C₄-alkyl.
R² particularly preferably represents hydrogen, methyl or ethyl.
R² very particularly preferably represents hydrogen or ethyl.
R³ preferably represents hydrogen or C₁-C₄-alkyl.
R³ particularly preferably represents hydrogen, methyl, ethyl, n- or iso-propyl.
R³ very particularly preferably represents hydrogen, methyl, ethyl or iso-propyl.
A¹ preferably represents straight chain or branched chain C₁-C₆-alkylene, C₁-C₆-haloalkylene, C₂-C₆-alkenylene, C₂-C₆-haloalkenylene, C₂-C₆-alkynylene, C₂-C₆-haloalkynylene, C₁-C₆-alkylene-amino, C₁-C₆-alkylene(C₁-C₄-alkylamino), C₁-C₆-alkyleneoxy or C₁-C₆-alkylenethio.
A¹ particularly preferably represents —CH₂—, —(CH₂)₂—, —(CH₂)₃—, —CH(CH₃)—, —OCH₂—, —CH₂O—, —O(CH₂)₂—, —(CH₂)₂O—, —CH₂—, —CH₂S—, —S(CH₂)₂— or —(CH₂)₂S—.
A¹ very particularly preferably represents —CH₂—, —(CH₂)₂—, —CH(CH₃)—, —OCH₂—, —O(CH₂)₂— or —CH₂S—.
r preferably represents 0.
r furthermore preferably represents 1.
A² preferably represents straight chain or branched chain C₁-C₆-alkylene, C₁-C₆-haloalkylene, C₂-C₆-alkenylene, C₂-C₆-haloalkenylene, C₂-C₆-alkynylene or C₂-C₆-haloalkynylene.
A² particularly preferably represents —CH₂—, —(CH₂)₂—, —(CH₂)₃—, —CH(CH₃)—, —CH₂—CH═CH—.
s preferably represents 0.
s furthermore preferably represents 1.
Q preferably represents pyridinylene, pyridazinylene, pyrimidinylene, pyrazinylene, each of which is optionally mono- or poly-substituted by substituents selected from group W¹ wherein said substituents may be identical or different, or further represents the below-mentioned groups; 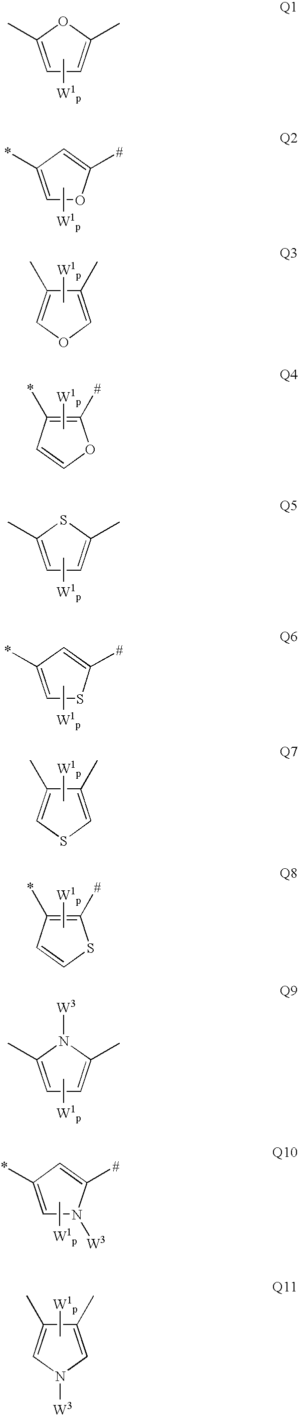 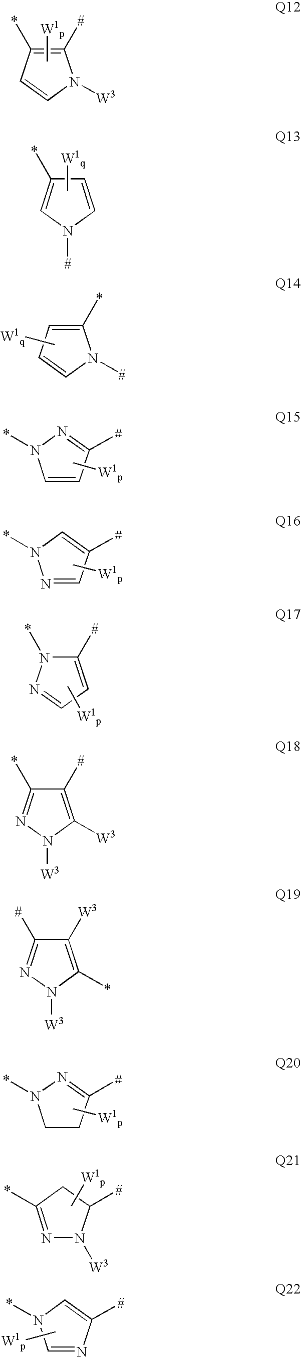 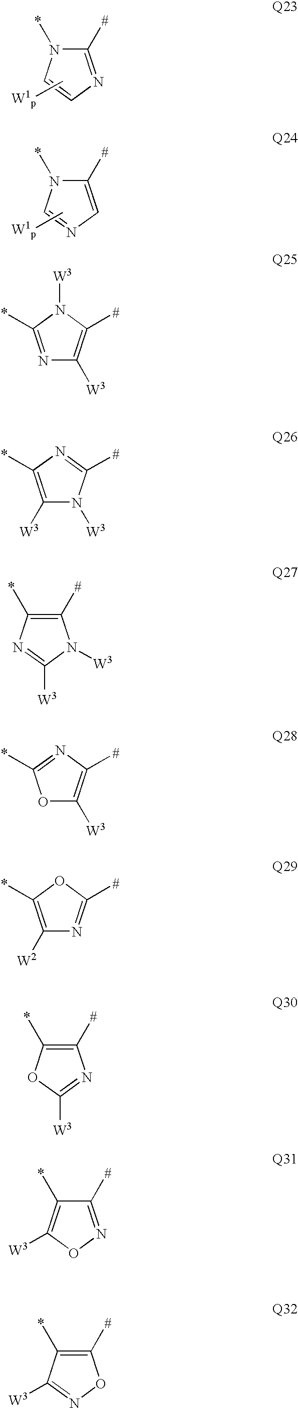 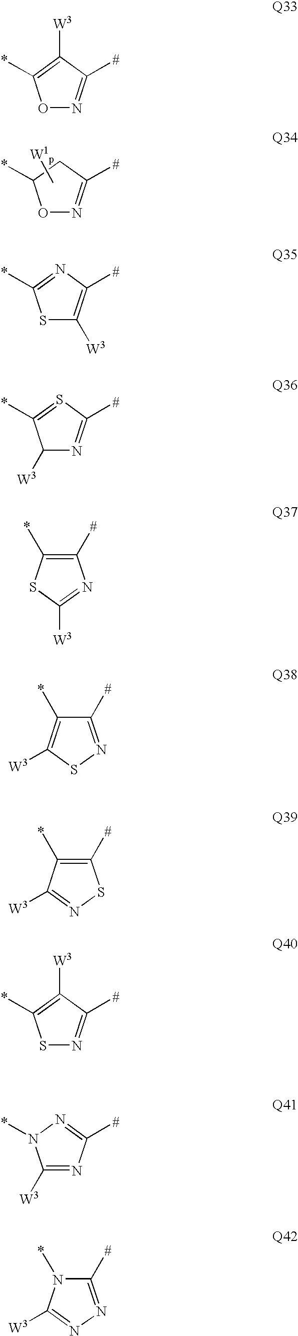 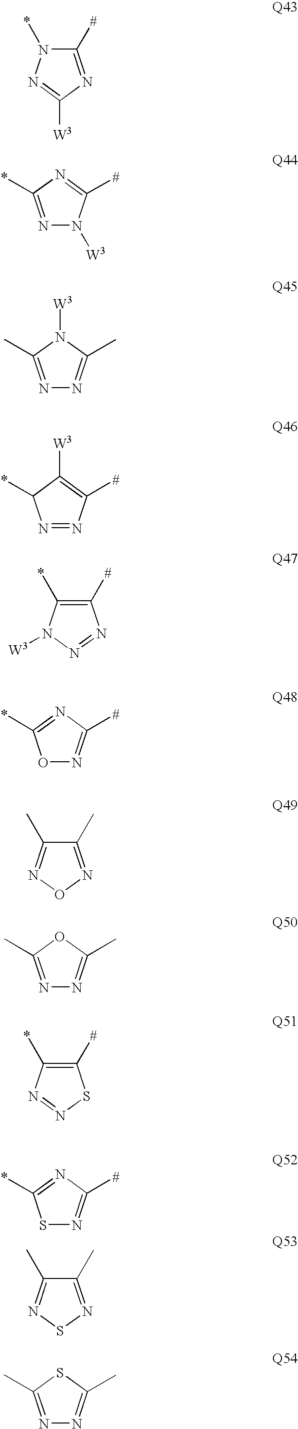 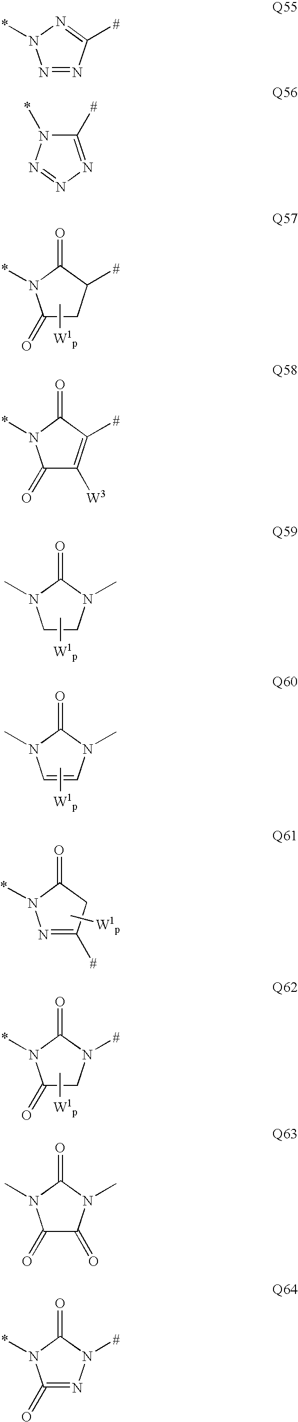 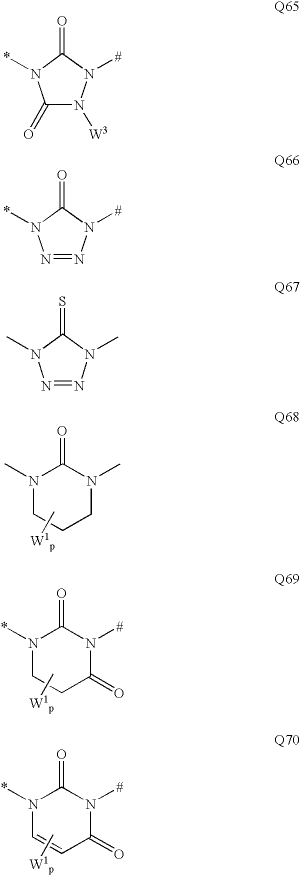
(wherein the bond marked with * connects with A¹ and the bond marked with # connects with A², or the bond marked with # connects with A¹ and the bond marked with * connects with A²)
Q particularly preferably represents Q15, Q17, Q22, Q23, Q29, Q34, Q35, Q45, Q48, Q50, Q55, Q56, Q58, Q59, Q60, Q61, Q62, Q63, Q64, Q66 and Q69.
Q very particularly preferably represents Q15.
Q furthermore very particularly preferably represents Q17.
Q furthermore very particularly preferably represents Q22.
Q furthermore very particularly preferably represents Q23.
Q furthermore very particularly preferably represents Q29.
Q furthermore very particularly preferably represents Q34.
Q furthermore very particularly preferably represents Q35.
Q furthermore very particularly preferably represents Q45.
Q furthermore very particularly preferably represents Q48.
Q furthermore very particularly preferably represents Q50.
Q furthermore very particularly preferably represents Q55.
Q furthermore very particularly preferably represents Q56.
Q furthermore very particularly preferably represents Q58.
Q furthermore very particularly preferably represents Q59.
Q furthermore very particularly preferably represents Q60.
Q furthermore very particularly preferably represents Q61.
Q furthermore very particularly preferably represents Q62.
Q furthermore very particularly preferably represents Q63.
Q furthermore very particularly preferably represents Q64.
Q furthermore very particularly preferably represents Q66.
Q furthermore very particularly preferably represents Q69.
W¹ preferably represents halogen, C₁-C₄-alkyl, C₁-C₄-alkoxy, C₁-C₄-alkylthio, C₁-C₄-alkylsulfinyl, C₁-C₄-alkylsulfonyl, C₁-C₄-haloalkyl, C₁-C₄-haloalkoxy, C₁-C₄-haloalkylthio, C₁-C₄-haloalkylsulfinyl, C₁-C₄-haloalkylsulfonyl, C₃-C₆-cycloalkyl C₁-C₄-alkylthio-C₁-C₄-alkyl, C₁-C₄-alkylsulfinyl-C₁-C₄-alkyl, C₁-C₄-alkylsulfonyl-C₁-C₄-alkyl.
W¹ particularly preferably represents methyl, ethyl, methoxy, methylthio, methylsulfinyl or methylsulfonyl.
W¹ very particularly preferably represents methyl.
E preferably represents phenyl, biphenyl, naphthyl, pyridyl, pyridazinyl, pyrimidinyl, pyrazinyl, thienyl, furyl or pyrrolyl, wherein said group is optionally mono- or poly-substituted by substituents selected from the group W² wherein said substituents may be identical or different.
E particularly preferably represents phenyl, biphenyl, 3-pyridyl, 2-thienyl, 2-furyl or 2-pyrrolyl, wherein said group is optionally mono- to tetra-substituted by substituents selected from the group W² wherein said substituents may be identical or different
E very particularly preferably represents phenyl, biphenyl, 3-pyridyl or 2-thienyl, wherein said group is optionally mono- to tetra-substituted by substituents selected from the group W² wherein said substituents may be identical or different.
W² preferably represents halogen, nitro, C₁-C₄-alkyl, C₁-C₄-alkoxy, C₁-C₄-alkylthio, C₁-C₄-alkylsulfinyl, C₁-C₄-alkylsulfonyl, C₁-C₄-haloalkyl, C₁-C₄-haloalkoxy, C₁-C₄-haloalkylthio, C₁-C₄-haloalkylsulfinyl, C₁-C₄-haloalkylsulfonyl, C₃-C₆-cycloalkyl, C₁-C₄-alkylthio-C₁-C₄-alkyl, C₁-C₄-alkylsulfinyl-C₁-C₄-alkyl or C₁-C₄-alkylsulfonyl-C₁-C₄-alkyl, or represents C₃-C₅-alkylene, C₃-C₅-haloalkylene, oxy-C₂-C₄-alkylene, oxy-C₂-C₄-haloalkylene, C₂-C₄-alkyleneoxy, C₂-C₄-haloalkyleneoxy, C₁-C₃-alkylenedioxy or C₁-C₄-haloalkylenedioxy, in case W² are two adjacent substituents.
W² particularly preferably represents fluorine, chlorine, bromine, nitro, methyl, ethyl, n- or iso-propyl, n-, sec-, iso- or tert-butyl, methoxy, ethoxy, n- or iso-propoxy, n-, see-, iso- or tert-butoxy, trifluoromethoxy, difluoromethoxy, methylthio, ethylthio, n- or iso-propylthio, n-, sec-, iso- or tert-butylthio, trifluoromethyl, difluoromethyl, dichlorofluoromethyl, trichloromethyl, trifluoromethoxy, difluoromethoxy, trifluoromethylthio, or represents —OCF₂O—, —O(CF₂)₂O—, —OCHFCF₂O—, —OCF₂CHFO—, in case W² are two adjacent substituents.
W² very particularly preferably represents fluorine, chlorine, bromine, nitro, methyl, ethyl, iso-propyl, methoxy, trifluoromethoxy, difluoromethoxy, methylthio, trifluoromethylthio, or represents —OCF₂O—, —O(CF₂)₂O—, —OCHFCF₂O—, —OCF₂CHFO—, in case W² are two adjacent substituents.
W³ represents hydrogen or has the same definition as the aforementioned W¹,
W³ preferably represents hydrogen, methyl, trifluoromethyl or methylthio.
p represents 0, 1 or 2.
p preferably represents 0.
p furthermore preferably represents 1.
q represents 0, 1, 2 or 3.
q preferably represents 0.
q furthermore preferably represents 1.

Compounds of formula (I), in which r is 0 and s is 0 are preferred.

Compounds of formula (I), in which r is 1 and s is 1 are preferred.

Compounds of formula (I), in which r is 1 and s is 9 are particularly preferred.

Compounds of formula (I), in which R² and R³ are both hydrogen are preferred.

Compounds of formula (I), in which n is 1 and X is located in 3-position are preferred.

Compounds of formula (I), in which X is iodine are preferred.

Compounds of formula (I), in which Y is methyl are preferred.

Compounds of formula (I), in which A¹ is —CH₂— are preferred.

Compounds of formula (I), in which E is mono- to tetra-substituted phenyl, where the substituents are selected from the group W², are preferred.

Compounds of formula (I), in which Q is Q66 are preferred.

The general or preferred radical definitions or illustrations listed above apply both to the end products and, correspondingly, to the starting materials and intermediates. These radical definitions can be combined with one another as desired, i.e. including combinations between the respective preferred ranges.

Preference according to the invention is given to the compounds of the formula (I) which contain a combination of the meanings listed above as being preferred.

Particular preference according to the invention is given to the compounds of the formula (I) which contain a combination of the meanings listed above as being particularly preferred.

Very particular preference according to the invention is given to the compounds of the formula (I) which contain a combination of the meanings listed above as being very particularly preferred.

In the radical definitions given above and below, carbon radicals, such as alkyl, are in each case straight-chain or branched as far as this is possible—including in combination with hetero atoms such as alkoxy.

The aforementioned preparation process (a) can be illustrated by the following reaction scheme in case, for example, that 3-(1,1-dimethyl-2-methylthioethylimino)-4-iodo-3H-isobenzofuran-1-one and 1-(4-amino-3-methylbenzyl)-4-(4-trifluoromethylphenyl)-1,4-dihydrotetrazol-5-one are used as starting materials.

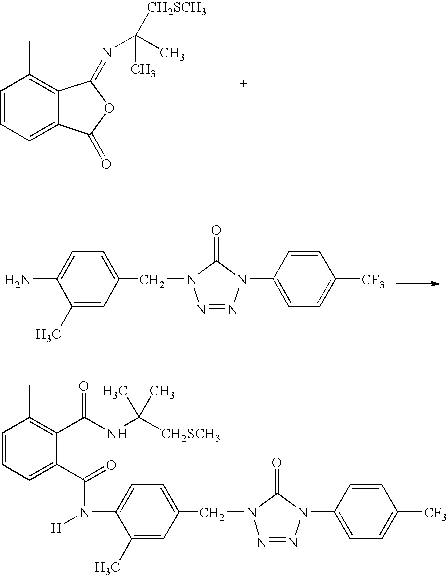

The aforementioned preparation process (b) can be illustrated by the following reaction scheme in case, for example, that 2-{2-methyl-4-[5-oxo-4-(4-trifluoromethylphenyl)-4,5-dihydrotetrazol-1-ylmethyl]phenyl}isoindole-1,3-dione and sec-butylamine are used as starting materials.

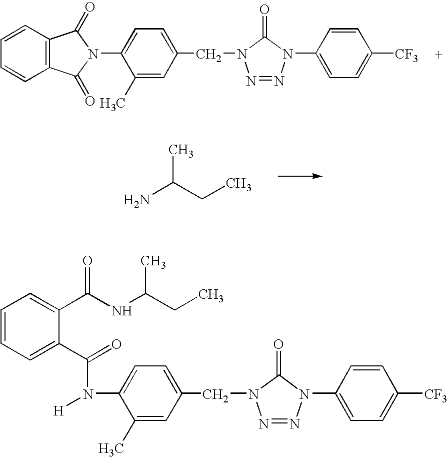

The aforementioned preparation process (c) can be illustrated by the following reaction scheme in case, for example, that N-(1-methyl-propyl)phthalamic acid and 1-(4-amino-3-methylbenzyl)-4-(4-trifluoromethylphenyl)-1,4-dihydrotetrazol-5-one are used as starting materials.

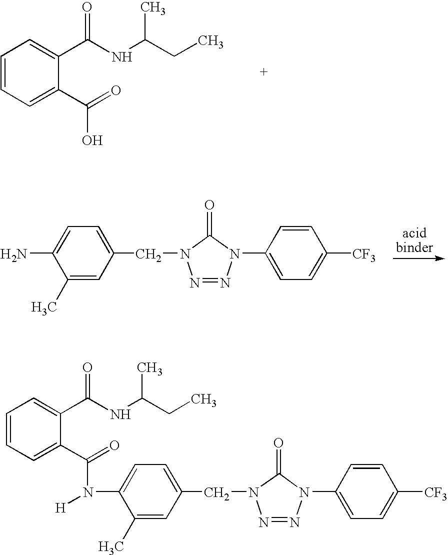

The aforementioned preparation process (d) can be illustrated by the following reaction scheme in case, for example, that 1-[4-(3-oxo-3H-isobenzofuran-1-ylideneamino)-3-methyl-benzyl]-4-(4-trifluoromethyl-phenyl)-1,4-dihydrotetrazol-5-one and sec-butylamine are used as starting materials.

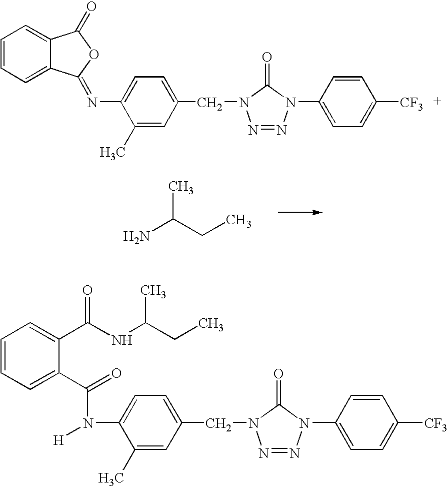

The aforementioned preparation process (e) can be illustrated by the following reaction scheme in case, for example, that N-{2-methyl-4-[5-oxo-4-(4-trifluoromethyl-phenyl)-4,5-dihydrotetrazol-1-ylmethyl]-phenyl}-phthalamic acid and sec-butylamine are used as starting materials. 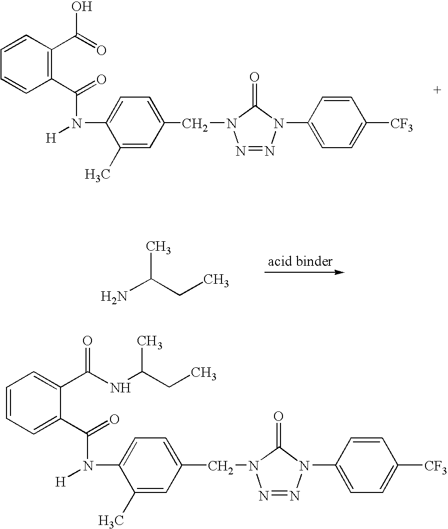
The aforementioned preparation process (f) can be illustrated by the following reaction scheme in case, for example, that N²-(1,1-dimethyl-2-methylthioethyl)-3-iodo-N¹-[2-methyl-4-(5-oxo-4-(4-trifluoromethyl-phenyl)-4,5-dihydro-tetrazol-1-ylmethyl)-phenyl]-phthalamide and m-chloroperbenzoic acid are used as starting materials.

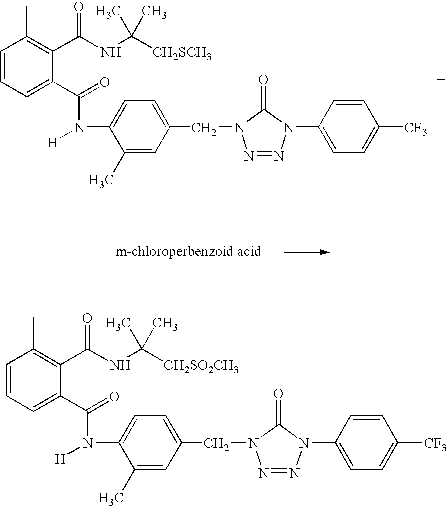

The compounds of the formula (II), starting material in the above-mentioned preparation process (a), are per se known compounds and can be easily prepared according to the process described in, for example, EP-A 0 919 542, EP-A 1 006 107.

As specific examples of the compounds of the formula (I) used as starting material in the preparation process (a) there can be mentioned the following:
3-isopropylimino-3H-isobenzofuran-1-one,
4-fluoro-3-isopropylimino-3H-isobenzofuran-1-one,
4-chloro-3-isopropylimino-3H-isobenzofuran-1-one,
4-bromo-3-isopropylimino-3H-isobenzofuran-1-one,
4-iodo-3-isopropylimino-3H-isobenzofuran-1-one,
3-isopropylimino-nitro-3H-isobenzofuran-1-one,
3-isopropylimino-5-nitro-3H-isobenzofuran-1-one,
3-(1-methyl-2-methylsulfanyl-ethylimino)-3H-isobenzofuran-1-one,
4-fluoro-3-(1-methyl-2-methylsulfanyl-ethylimino)-3H-isobenzofuran-1-one,
4-chloro-3-(1-methyl-2-methylsulfanyl-ethylimino)-3H-isobenzofuran-1-one,
4-bromo-3-(1-methyl-2-methylsulfanyl-ethylimino)-3H-isobenzofuran-1-one,
4-iodo-3-(1-methyl-2-methylsulfanyl-ethylimino)-3H-isobenzofuran-1-one,
3-(1-methyl-2-methylsulfanyl-ethylimino)-4-nitro-3H-isobenzofuran-1-one,
3-(1,1-dimethyl-2-methylsulfanyl-ethylimino)-3H-isobenzofuran-1-one,
3-(1,1-dimethyl-2-methylsulfanyl-ethylimino)-4-fluoro-3H-isobenzofuran-1-one,
4-chloro-3-(1,1-dimethyl-2-methylsulfanyl-ethylimino)-3H-isobenzofuran-1-one,
4-bromo-3-(1,1-dimethyl-2-methylsulfanyl-ethylimino)-3H-isobenzofuran-1-one,
3-(1,1-dimethyl-2-methylsulfanyl-ethylimino)-4-iodo-3H-isobenzofuran-1-one,
3-(1,1-dimethyl-2-methylsulfanyl-ethylimino)-4-nitro-3H-isobenzofuran-1-one,
3-(1,1-dimethyl-2-methylsulfanyl-ethylimino)-4-methyl-3H-isobenzofuran-1-one,
3-(1,1-dimethyl-2-methylsulfanyl-ethylimino)-5-methyl-3H-isobenzofuran-1-one,
4,7-dichloro-3-(1,1-dimethyl-2-methylsulfanyl-ethylimino)-3H-isobenzofuran-1-one,
5,6-dichloro-3-(1,1-dimethyl-2-methylsulfanyl-ethylimino)-3H-isobenzofuran-1-one,
4,5,6,7-tetrachloro-3-(1,1-dimethyl-2-methylsulfanyl-ethylimino)-3H-isobenzofuran-1-one,
3-isopropylimino-1-oxo-1,3-dihydro-isobenzofuran-4-yl methanesulfonate,
3-(1-methyl-2-methylsulfanyl-ethylimino-1-oxo-1,3-dihydro-isobenzofuranyl methanesulfonate,
3-(1,1-dimethyl-2-methylsulfanyl-ethylimino-1-oxo-1,3-dihydro-isobenzofuran-4-yl methanesulfonate.

The compounds of the formula (E), starting material in the above-mentioned preparation process (a), include novel compounds not mentioned in the existing literature as a part.

Their corresponding anilines can be obtained, for example, by a catalytic hydrogen reduction, a well-known process in the field of organic chemistry, by reducing compounds of the formula 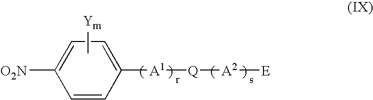
wherein Y, m, A¹, r, Q, A², s and E have the same definitions as aforementioned with hydrogen in the presence of a catalytic reduction catalyst, for example, palladium carbon, Raney nickel, platinum oxide.

Compounds of the formula (III), in which R³ corresponds alkyl, can be obtained by formylating the amino group of the anilines, further alkylating and then de-formylating. Moreover, compounds of the formula (E), in which R³ corresponds alkyl, can also be obtained by preparing a Schiff base complex by a reaction of the anilines obtained by the reduction of compounds of the formula QX) and a ketone or an aldehyde and then by catalytically reducing it.

The compounds of the above-mentioned formula (DC) are, as will be described later in detail, novel compounds.

As specific examples of the compounds of the formula (Il) there can be mentioned, for example,
1-(4-amino-3-methyl-benzyl)-1H-pyrazole,
1-(4-amino-3-methyl-benzyl)-3-methyl-1H-pyrazole,
1-(4-amino-3-methyl-benzyl)-4-methyl-1H-pyrazole,
1-(4-amino-3-methyl-benzyl)-4,5-dichloro-1H-imidazole,
1-(4-amino-3-methyl-benzyl)-1H-1,2,3-triazole,
1-(4-amino-3-methyl-benzyl)-1H-1,2,4-triazole,
1-(4-amino-3-methyl-benzyl)-1H-tetrazole,
1-(4-amino-3-methyl-benzyl)-5-methyl-1H-tetrazole,
1-(4-amino-3-methyl-benzyl)-5-(2-chloro-phenyl)-1H-tetrazole,
1-(4-amino-3-methyl-benzyl)-5-(3-trifluoromethyl-phenyl)-1H-tetrazole,
1-(4-amino-3-methyl-benzyl)-5-(4-trifluoromethyl-phenyl)-1H-tetrazole,
1-(4-amino-3-methyl-benzyl)-5-(3,5-bis-trifluoromethyl-phenyl)-1H-tetrazole,
1-(4-amino-3-methyl-benzyl)-5-(3-trifluoromethoxy-phenyl)-1H-tetrazole,
1-(4-amino-3-methyl-benzyl)-3-(4-trifluoromethyl-phenyl)-imidazolydin-2-one,
1-(4-amino-3-methyl-benzyl)-3-(4-trifluoromethyl-phenyl)-1,3-dihydro-imidazol-2-one,
1-(4-amino-3-methyl-benzyl)-3-(4-trifluoromethyl-phenyl)-imidazolydin-2,4-dione,
1-(4-amino-3-methyl-benzyl)-3-(4-trifluoromethyl-phenyl)-imidazolydin-2,4,5-trione,
1-(4-amino-3-methyl-benzyl)-3-(4-trifluoromethyl-phenyl)-1H-pyrazole,
4-(4-amino-3-methyl-benzyl)-2-(2-fluoro-phenyl)-2,4-dihydro-1,2,4-triazol-3-one,
4-(4-amino-3-methyl-benzyl)-2-(2-chloro-phenyl)-2,4-dihydro-1,2,4-triazol-3-one,
4-(4-amino-3-methyl-benzyl)-2-(2-trifluoromethyl-phenyl)-2,4-dihydro-1,2,4-triazol-3-one,
4-(4-amino-3-methyl-benzyl)-2-(3-fluoro-phenyl)-2,4-dihydro-1,2,4-triazol-3-one,
4-(4-amino-3-methyl-benzyl)-2-(3-chloro-phenyl)-2,4-dihydro-1,2,4-triazol-3-one,
4-(4-amino-3-methyl-benzyl)-2-(3-trifluoromethyl-phenyl)-2,4-dihydro-1,2,4-triazol-3-one,
2-(4-fluoro-phenyl)-4-(4-amino-3-methyl-benzyl)-2,4-dihydro-1,2,4-triazol-3-one,
4-(4-amino-3-methyl-benzyl)-2-(4-chloro-phenyl)-2,4-dihydro-1,2,4-triazol-3-one,
4-(4-amino-3-methyl-benzyl)-2-(4-trifluoromethyl-phenyl)-2,4-dihydro-1,2,4-triazol-3-one,
(4-amino-3-methyl-benzyl)-2-(3,4-bis-trifluoromethyl-phenyl)-2,4-dihydro-1,2,4-triazol-3-one,
4-(4-amino-3-methyl-benzyl)-2-(3,5-bis-trifluoromethyl-phenyl)-2,4-dihydro-1,2,4-triazol-3-one,
4-(4-amino-3-methyl-benzyl)-5-trifluoromethyl-2-(4-trifluoromethyl-phenyl)-2,4-dihydro-1,2,4-triazol-3-one,
2-(4-amino-3-methyl-benzyl)-4-(2-chloro-phenyl)-2,4-dihydro-1,2,4-triazol-3-one,
2-(4-amino-3-methyl-benzyl)-4-(4-trifluoromethyl-phenyl)-2,4-dihydro-1,2,4-triazol-3-one,
2-(4-amino-3-methyl-benzyl)-5-methyl-4-(4-trifluoromethyl-phenyl)-2,4-dihydro-1,2,4-triazol-3-one,
2-(4-amino-3-methyl-benzyl)-4-(2-chloro-phenyl)-5-methylsulfanyl-2,4-dihydro-1,2,4-triazol-3-one,
2-(4-amino-3-methyl-benzyl)-5-methylsulfanyl-4-(4-trifluoromethyl-phenyl)-2,4-dihydro-1,2,4-triazol-3-one,
1-(4-amino-3-methyl-benzyl)-4-methyl-1,4-dihydro-tetrazol-5-one,
1-(4-amino-3-methyl-benzyl)-4-methyl-1,4-dihydro-tetrazol-5-one,
1-(4-amino-3-methyl-benzyl)-4-propyl-1,4-dihydro-tetrazol-5-one,
1-(4-amino-3-methyl-benzyl)-4-isobutyl-1,4-dihydro-tetrazol-5-one,
1-(4-amino-3-methyl-benzyl)-4-(2,2,2-trifluoro-ethyl)-1,4-dihydro-tetrazol-5-one,
1-(4-amino-3-methyl-benzyl)-4-(4,4,4-trifluoro-butyl)-1,4-dihydro-tetrazol-5-one,
1-(4-amino-3-methyl-benzyl)-(3,3,3-trichloro-2-methyl-propyl)-1,4-dihydro-tetrazol-5-one,
1-(4-amino-3-methyl-benzyl)cyclopropyl-1,4-dihydro-tetrazol-5-one,
1-(4-amino-3-methyl-benzyl)-4-cyclohexyl-1,4-dihydro-tetrazol-5-one,
1-(4-amino-3-methyl-benzyl)-4-phenyl-1,4-dihydro-tetrazol-5-one,
1-(4-amino-3-methyl-benzyl)-4-(2-fluoro-phenyl)-1,4-dihydro-tetrazol-5-one,
1-(4-amino-benzyl)-4-(2-chloro-phenyl)-1,4-dihydro-tetrazol-5-one,
1-(4-amino-3-methyl-benzyl)-4-(2-chloro-phenyl)-1,4-dihydro-tetrazol-5-one,
1-[1-(4-amino-3-methyl-phenyl)-ethyl]-4-(2-chloro-phenyl)-1,4-dihydro-tetrazol-5-one,
1-(4-amino-3-methyl-benzyl)-4-(2-methyl-phenyl)-1,4-dihydro-tetrazol-5-one,
1-(4-amino-3-methyl-benzyl)-4-(2-methoxy-phenyl)-1,4-dihydro-tetrazol-5-one,
1-(4-amino-3-methyl-benzyl)-4-(2-trifluoromethyl-phenyl)-1,4-dihydro-tetrazol-5-one,
1-(4-amino-3-methyl-benzyl)-4-(2-trifluoromethoxy-phenyl)-1,4-dihydro-tetrazol-5-one,
1-(4-amino-3-methyl-benzyl)-4-(3-fluoro-phenyl)-1,4-dihydro-tetrazol-5-one,
1-(4-amino-3-methyl-benzyl)-4-(3-chloro-phenyl)-1,4-dihydro-tetrazol-5-one,
1-(4-amino-3-methyl-benzyl)-4-(3-methyl-phenyl)-1,4-dihydro-tetrazol-5-one,
1-(4-amino-benzyl)-4-(3-trifluoromethyl-phenyl)-1,4-dihydro-tetrazol-5-one,
1-(4-amino-3-methyl-benzyl)-4-(3-trifluoromethyl-phenyl)-1,4-dihydro-tetrazol-5-one,
1-(4-amino-3-methyl-benzyl)-4-(3-difluoromethoxy-phenyl)-1,4-dihydro-tetrazol-5-one,
1-(4-amino-3-methyl-benzyl)-4-(3-trifluoromethoxy-phenyl)-1,4-dihydro-tetrazol-5-one,
1-(4-amino-3-methyl-benzyl)-4-(4-fluoro-phenyl)-1,4-dihydro-tetrazol-5-one,
1-(4-amino-3-methyl-benzyl)-4-(4-chloro-phenyl)-1,4-dihydro-tetrazol-5-one,
1-(4-amino-3-methyl-benzyl)-4-(4-bromo-phenyl)-1,4-dihydro-tetrazol-5-one,
1-(4-amino-3-methyl-benzyl)-4-(4-methyl-phenyl)-1,4-dihydro-tetrazol-5-one,
1-(4-amino-3-methyl-benzyl)-4-(4-isopropyl-phenyl)-1,4-dihydro-tetrazol-5-one,
1-(4-amino-benzyl)-4-(4-trifluoromethyl-phenyl)-1,4-dihydro-tetrazol-5-one,
1-(4-amino-2-chloro-benzyl)-4-(4-trifluoromethyl-phenyl)-1,4-dihydro-tetrazol-5-one,
1-(4-amino-3-chloro-benzyl)-4-(4-trifluoromethyl-phenyl)-1,4-dihydro-tetrazol-5-one,
1-(4-amino-3-methyl-benzyl)-4-(4-trifluoromethyl-phenyl)-1,4-dihydro-tetrazol-5-one,
1-(4-amino-3-methyl-benzyl)-4-(4-difluoromethoxy-phenyl)-1,4-dihydro-tetrazol-5-one,
1-(4-amino-3-methyl-benzyl)-4-(4-trifluoromethoxy-phenyl)-1,4-dihydro-tetrazol-5-one,
1-(4-amino-3-methyl-benzyl)-4-(4-trifluoromethoxy-sulfanyl-phenyl)-1,4-dihydro-tetrazol-5-one,
1-(4-amino-3-methyl-benzyl)-4-(3′,5-bis-trifluoromethyl-biphenyl-4-yl)-1,4-dihydro-tetrazol-5-one,
1-(4-amino-3-methyl-benzyl)-4-(3′,5′-bis-trifluoromethyl-biphenyl-4-yl)-1,4-dihydro-tetrazol-5-one,
1-(4-amino-3-methyl-benzyl)-4-(4-bromo-2-fluoro-phenyl)-1,4-dihydro-tetrazol-5-one,
1-(4-amino-3-methyl-benzyl)-4-(2-fluoro-3-trifluoromethyl-phenyl)-1,4-dihydro-tetrazol-5-one,
1-(4-amino-3-methyl-benzyl)-4-(3-bromo-4-trifluoromethoxy-phenyl)-1,4-dihydro-tetrazol-5-one,
1-(4-amino-3-methyl-benzyl)-4-(3-chloro-4-trifluoromethoxy-phenyl)-1,4-dihydro-tetrazol-5-one,
1-(4-amino-3-methyl-benzyl)-4-(4-fluoro-3-fluoromethyl-phenyl)-1,4-dihydro-tetrazol-5-one,
1-(4-amino-3-methyl-benzyl)-4-(2-fluoro-5-trifluoromethyl-phenyl)-1,4-dihydro-tetrazol-5-one,
1-(4-amino-3-methyl-benzyl)-4-(4-chloro-3-trifluoromethyl-phenyl)-1,4-dihydro-tetrazol-5-one,
1-(4-amino-3-methyl-benzyl)-4-(3,4-dichloro-phenyl)-1,4-dihydro-tetrazol-5-one,
1-(4-amino-3-methyl-benzyl)-4-(3,4-bis-fluoromethyl-phenyl)-1,4-dihydro-tetrazol-5-one,
1-(4-amino-3-methyl-benzyl)-4-(3-fluoro-5-trifluoromethyl-phenyl)-1,4-dihydro-tetrazol-5-one,
1-(4-amino-3-methyl-benzyl)-4-(3,5-dichloro-phenyl)-1,4-dihydro-tetrazol-5-one,
1-(4-amino-3-methyl-benzyl)-4-(3,5-dimethoxy-phenyl)-1,4-dihydro-tetrazol-5-one,
1-(4-amino-2-chloro-benzyl)-4-(3,5-bis-fluoromethyl-phenyl)-1,4-dihydro-tetrazol-5-one,
1-(4-amino-3-chloro-benzyl)-4-(3,5-bis-trifluoromethyl-phenyl)-1,4-dihydro-tetrazol-5-one,
1-(4-amino-3-methyl-benzyl)-4-(3,5-bis-trifluoromethyl-phenyl)-1,4-dihydro-tetrazol-5-one,
1-(4-amino-2-methoxy-benzyl)-4-(3,5-bis-trifluoromethyl-phenyl)-1,4-dihydro-tetrol-5-one,
1-(4-amino-3-methoxy-benzyl)-4-(3,5-bis-trifluoromethyl-phenyl)-1,4-dihydro-tetrazol-5-one,
1-(4-amino-3,5-dimethyl-benzyl)-4-(3,5-bis-fluoromethyl-phenyl)-1,4-dihydro-tetrazol-5-one,
1-[1-(4-amino-3-methyl-phenyl)-ethyl]-4-(3,5-bis-trifluoromethyl-phenyl)-1,4-dihydro-tetrazol-5-one,
1-(4-amino-3-methyl-benzyl)-4-(3-chloro-2-methoxy-5-methyl-phenyl)-1,4-dihydro-tetrazol-5-one,
1-(4-amino-3-methyl-benzyl)-4-(2,2-difluoro-benzo[1,3]dioxol-5-yl)-1,4-dihydro-tetrazol-5-one,
1-(4-amino-3-methyl-benzyl)-4-(2,2,3,3-tetrafluoro-2,3-dihydro-benzo[1,4]dioxin-6-yl)-1,4-dihydrotetrazol-5-one,
1-(4-amino-3-methyl-benzyl) (2,2,3-trifluoro-2,3-dihydro-benzo[1,4]dioxin-6-yl)-1,4-dihydrotetrazol-5-one,
1-(4-amino-3-methyl-benzyl)-(2,3,3-trifluoro-2,3-dihydro-benzo[1,4]dioxin-6-yl)-1,4-dihydrotetrazol-5-one,
1-(4-amino-3-methyl-benzyl)-4-(2,2,3,3,7-pentafluoro-2,3-dihydro-benzo[1,4]dioxin-6-yl)-1,4-dihydro-tetrazol-5-one,
1-(4-amino-3-methyl-benzyl)-4-(3,5-dichloro-2,6-diethyl-phenyl)-1,4-dihydro-tetrazol-5-one,
1-(4-amino-3-methyl-benzyl)-4-benzyl-1,4-dihydro-tetrazol-5-one,
1-(4-amino-3-methyl-benzyl)-4-(4-fluoro-benzyl)-1,4-dihydro-tetrazol-5-one,
1-(4-amino-3-methyl-benzyl)-4-(4-chloro-phenyl)-1,4-dihydro-tetrazol-5-one,
1-(4-amino-3-methyl-benzyl)-4-(4-trifluoromethyl-phenyl)-1,4-dihydro-tetrazol-5-one,
1-(4-amino-3-methyl-benzyl)-4-[1-(2-fluoro-phenyl)ethyl]-1,4-dihydro-tetrazol-5-one,
1-(4-amino-3-methyl-benzyl)-4-[2-chloro-phenyl)ethyl]-1,4-dihydro-tetrazol-5-one,
1-(4-amino-3-methyl-benzyl)-4-[1-(2-trifluoromethyl-phenyl)-ethyl]-1,4-dihydro-tetrazol-5-one,
1-(4-amino-3-methyl-benzyl)-4-[1-(3-fluoro-phenyl)-ethyl]-1,4-dihydro-tetrazol-5-one,
1-(4-amino-3-methyl-benzyl)-4-[1-(3-chloro-phenyl)-ethyl]-1,4-dihydro-tetrazol-5-one,
1-(4-amino-3-methyl-benzyl)-4-[1-(3-trifluoromethyl-phenyl)-ethyl]-1,4-dihydro-tetrazol-5-one,
1-(4-amino-3-methyl-benzyl)-4-[1-(4-fluoro-phenyl)-ethyl]-1,4-dihydro-tetrazol-5-one,
1-(4-amino-3-methyl-benzyl)-4-[1-(4-chloro-phenyl)-ethyl]-1,4-dihydro-tetrazol-5-one,
1-(4-ammo-3-methyl-benzyl)-4-[1-(4-fluoromethyl-phenyl)-ethyl]-1,4-dihydro-tetrazol-5-one,
1-(4-amino-3-methyl-benzyl)-4-[1-(2,4-difluoro-phenyl)-ethyl]-1,4-dihydro-tetrazol-5-one,
1-(4-amino-3-methyl-benzyl)-4-[1-(2,4-dichloro-phenyl)-ethyl]-1,4-dihydro-tetrazol-5-one,
1-(4-amino-3-methyl-benzyl)-4-[1-(3,4-difluoro-phenyl)-ethyl]-1,4-dihydro-tetrazol-5-one.

The compounds of the formula (I), starting materials in the above-mentioned preparation process (b), are novel ones and can be easily obtained according to the process described in JP-A 61-246161, for example,
by reacting a compound represented by the formula 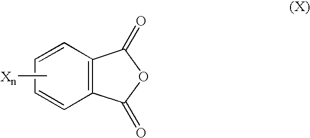
wherein X and n have the same definition as aforementioned,
with the compounds of the aforementioned formula (M) 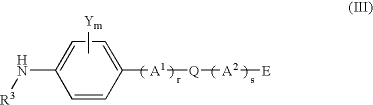
in which R³ represents a hydrogen atom and Y, m, A¹, r, Q, A², s and E have the same definitions as aforementioned.

The reaction can be conducted in an adequate diluent. As examples of the diluent used in that case there can be mentioned aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene; ethers, for example, ethyl ether, methyl ethyl ether, isopropyl ether, butyl ether, dioxane, dimethoxyethane (DME), tetrahydrofuran (THF), diethylene glycol dimethyl ether (DGM); esters, for example, ethyl acetate, amyl acetate; acid amides, for example, dimethylformamide (DMF), dimethylacetamide (DMA), N-methylpyrrolidone, 1,3-dimethyl-2-imidazolidinone, hexamethyl phosphoric triamide (HMPA); acids, for example, acetic acid.

The reaction can be conducted in a substantially wide range of temperature. It can be conducted at the temperatures in a range of generally room temperature to about 200° C., preferably room temperature to 150° C.

Although said reaction is conducted desirably under normal pressure, it can be operated also under elevated pressure or under reduced pressure.

In conducting the reaction, the aimed compounds can be obtained, for example, by reacting equimolar amount or a little excess amount of the compounds of the formula (III) to 1 mole of the compounds of the formula (X) in a diluent, for example, acetic acid.

Many of the compounds of the above-mentioned formula (X) are known (available on the market) compounds and as their specific examples there can be mentioned, phthalic anhydride,
3-fluorophthalic anhydride,
3-chlorophthalic anhydride,
3-bromophthalic anhydride,
3-iodophthalic anhydride,
3-methylphthalic anhydride,
3-nitrophthalic anhydride,
3,6-difluorophthalic anhydride,
3,6-dichlorophthalic anhydride,
4,5-dichlorophthalic anhydride,
3,4,5,6-tetrafluorophthalic anhydride,
3,4,5,6-tetrachlorophthalic anhydride,
3-methanesulfonyloxyphthalic anhydride.

Among the above-mentioned examples, 3-methanesulfonyloxyphthalic anhydride can be easily obtained from 3-hydroxyphthalic anhydride and methanesulfonyl chloride according to the process described in Tetrahedron Lett., 1988, 29, 5595-5598.

Similarly the compounds of the aforementioned formula (III), in which R³ represents a hydrogen atom, starting materials for the compounds of the formula (IV), can be easily obtained, as described in the aforementioned preparation process (a), by a catalytic hydrogen reduction of the compounds represented by the aforementioned formula (IX) having a nitro group in place of an amino group, corresponding to the amino group (R³=H) in the formula (III).

The catalytic hydrogen reduction can be conducted in an adequate diluent and as examples of the diluent used in that case there can be mentioned ethers, for example, ethyl ether, methyl ethyl ether, isopropyl ether, butyl ether, dioxane, tetrahydrofuran (THF); alcohols, for example, methanol, ethanol, isopropanol, butanol, ethylene glycol, and as catalytic reduction catalyst there can be mentioned palladium carbon, Raney nickel, platinum oxide.

It can be conducted at the temperatures generally between about 0 to about 100° C., preferably room temperature to about 80° C.

Said reaction can be operated under normal pressure to elevated pressure.

For example, an objective compound of the formula (III), in which R³ represents hydrogen, can be obtained by hydrogenation of 1 mole of the nitro compound in a diluent, for example, ethanol in the presence of 0.1-10% (w/w) palladium carbon.

Moreover, the compounds of the formula (E), in which R³ represents hydrogen, can also be obtained by a reaction with a metal etc. instead of a catalytic hydrogen reduction.

As a process using a metal etc. there can be mentioned, for example, a process of treating iron powder in acetic acid, a process of reacting zinc dust under the neutral condition (Organic Syntheses Collective Vol. II, p. 447), a process of reacting stannic chloride under an acidic condition (Organic Syntheses Collective Vol. II, p. 254), a process of reacting titanium trichloride under the neutral condition, etc.

As specific examples of the compounds of the formula (M), in which R³ represents a hydrogen atom, there can be mentioned, for example,
1-(4-amino-3-methyl-benzyl)-1H-pyrazole,
1-(4-amino-3-methyl-benzyl)-3-methyl-1H-pyrazole,
1-(4-amino-3-methyl-benzyl)-4-methyl-1H-pyrazole,
1-(4-amino-3-methyl-benzyl)-4,5-dichloro-1H-imidazole,
1-(4-amino-3-methyl-benzyl)-1H-1,2,3-triazole,
1-(4-amino-3-methyl-benzyl)-1H-1,2,4-triazole,
1-(4-amino-3-methyl-benzyl-1H-tetrazole,
1-(4-amino-3-methyl-benzyl)-5-methyl-1H-tetrazole,
1-(4-amino-3-methyl-benzyl)-5-(2-chloro-phenyl)-1H-tetrazole,
1-(4-amino-3-methyl-benzyl)-5-(3-trifluoromethyl-phenyl)-1H-tetrazole,
1-(4-amino-3-methyl-benzyl)-5-(4-trifluoromethyl-phenyl)-1H-tetrazole,
1-(4-amino-3-methyl-benzyl)-5-(3,5-bis-trifluoromethyl-phenyl)-1H-tetrazole,
1-(4-amino-3-methyl-benzyl)-5-(3-trifluoromethoxy-phenyl)-1H-tetrazole,
1-(4-amino-3-methyl-benzyl)-3-(4-trifluoromethyl-phenyl)-imidazolydin-2-one,
1-(4-amino-3-methyl-benzyl)-3-(4-trifluoromethyl-phenyl)-1,3-dihydro-imidazol-2-one,
1-(4-amino-3-methyl-benzyl)-3-(4-trifluoromethyl-phenyl)-imidazolydin-2,4-dione,
1-(4-amino-3-methyl-benzyl)-3-(4-trifluoromethyl-phenyl)-imidazolydin-2,4,5-trione,
1-(4-amino-3-methyl-benzyl)-3-(4-trifluoromethyl-phenyl)-1H-pyrazole,
4-(4-amino-3-methyl-benzyl)-2-(2-fluoro-phenyl)-2,4-dihydro-1,2,4-triazol-3-one,
4-(4-amino-3-methyl-benzyl)-2-(2-chloro-phenyl)-2,4-dihydro-1,2,4-triazol-3-one,
4-(4-amino-3-e-methyl-benzyl)-2-(2-trifluoromethyl-phenyl)-2,4-dihydro-1,2,4-triazol-3-one,
4-(4-amino-3-methyl-benzyl)-2-(3-fluoro-phenyl)-2,4-dihydro-1,2,4-triazol-3-one,
4-(4-amino-3-methyl-benzyl)-2-(3-chloro-phenyl)-2,4-dihydro-1,2,4-triazol-3-one,
4-(4-amino-3-methyl-benzyl)-2-(3-trifluoromethyl-phenyl)-2,4-dihydro-1,2,4-triazol-3-one,
2-(4-fluoro-phenyl)-4-(4-amino-3-methyl-benzyl)-2,4-dihydro-1,2,4-triazol-3-one,
4-(4-amino-3-methyl-benzyl)-2-(4-chloro-phenyl)-2,4-dihydro-1,2,4-triazol-3-one,
4-(4-amino-3-methyl-benzyl)-2-(4-trifluoromethyl-phenyl)-2,4-dihydro-1,2,4-triazol-3-one,
4-(4-amino-3-methyl-benzyl)-2-(3,4-bis-trifluoromethyl-phenyl)-2,4-dihydro-1,2,4-triazol-3-one,
4-(4-amino-3-methyl-benzyl)-2-(3,5-bis-trifluoromethyl-phenyl)-2,4-dihydro-1,2,4-triazol-3-one,
4-(4-amino-3-methyl-benzyl)-5-trifluoromethyl-2-(4-trifluoromethyl-phenyl)-2,4-dihydro-1,2,4-triazol-3-one,
2-(4-amino-3-methyl-benzyl)(2-chloro-phenyl)-2,4-dihydro-1,2,4-triazol-3-one,
2-(4-amino-3-methyl-benzyl)-4-(4-trifluoromethyl-phenyl)-2,4-dihydro-1,2,4-triazol-3-one,
2-(4-amino-3-methyl-benzyl)-4-methyl-4-(4-trifluoromethyl-phenyl)-2,4-dihydro-1,2,4-triazol-3-one,
2-(4-amino-3-methyl-benzyl)-4-(2-chloro-phenyl)-5-methylsulfanyl-2,4-dihydro-1,2,4-triazol-3-one,
2-(4-amino-3-methyl-benzyl)-5-methylsulfanyl-4,4-trifluoromethyl-phenyl)-2,4-dihydro-1,2,4-triazol-3-one,
1-(4-amino-3-methyl-benzyl)-4-methyl-1,4-dihydro-tetrazol-5-one,
1-(4-amino-3-methyl-benzyl)-4-ethyl-1,4-dihydro-tetrazol-5-one,
1-(4-amino-3-methyl-benzyl)-4-propyl-1,4-dihydro-tetrazol-5-one,
1-(4-amino-3-methyl-benzyl)-4-isobutyl-1,4-dihydro-tetrazol-5-one,
1-(4-amino-3-methyl-benzyl)-4-(2,2,2-trifluoro-ethyl)-1,4-dihydro-tetrazol-5-one,
1-(4-amino-3-methyl-benzyl)-4-(4,4,4-trifluoro-butyl)-1,4-dihydro-tetrazol-5-one,
1-(4-amino-3-methyl-benzyl) (3,3,3-trichloro-2-methyl-propyl)-1,4-dihydro-tetrazol-5-one,
1-(4-amino-3-methyl-benzyl)cyclopropyl-1,4-dihydro-tetrazol-5-one,
1-(4-amino-3-methyl-benzyl)-4-cyclohexyl-1,4-dihydro-tetrazol-5-one,
1-(4-amino-3-methyl-benzyl)-4-phenyl-1,4-dihydro-tetrazol-5-one,
1-(4-amino-3-methyl-benzyl)-4-(2-fluoro-phenyl)-1,4-dihydro-tetrazol-5-one,
1-(4-amino-benzyl)-4-(2-chloro-phenyl)-1,4-dihydro-tetrazol-5-one,
1-(4-amino-3-methyl-benzyl)-4-(2-chloro-phenyl)-1,4-dihydro-tetrazol-5-one,
1-[1-(4-amino-3-methyl-phenyl)-ethyl]-4-(2-chloro-phenyl)-1,4-dihydro-tetrazol-5-one,
1-(4-amino-3-methyl-benzyl-4-(2-methyl-phenyl)-1,4-dihydro-tetrazol-5-one,
1-(4-amino-3-methyl-benzyl)-4-(2-methoxy-phenyl)-1,4-dihydro-tetrazol-5-one,
1-(4-amino-3-methyl-benzyl)-4-(2-trifluoromethyl-phenyl)-1,4-dihydro-tetrazol-5-one,
1-(4-amino-3-methyl-benzyl)-4-(2-trifluoromethoxy-phenyl)-1,4-dihydro-tetrazol-5-one,
1-(4-amino-3-methyl-benzyl)-4-(3-fluoro-phenyl)-1,4-dihydro-tetrazol-5-one,
1-(4-amino-3-methyl-benzyl)-4-(3-chloro-phenyl)-1,4-dihydro-tetrazol-5-one,
1-(4-amino-3-methyl-benzyl)-4-(3-methyl-phenyl)-1,4-dihydro-tetrazol-5-one,
1-(4-amino-benzyl)-4-(3-trifluoromethyl-phenyl)-1,4-dihydro-tetrazol-5-one,
1-(4-amino-3-methyl-benzyl)-4-(3-trifluoromethyl-phenyl)-1,4-dihydro-tetrazol-5-one,
1-(4-amino-3-methyl-benzyl)-4-(3-difluoromethoxy-phenyl)-1,4-dihydro-tetrazol-5-one,
1-(4-amino-3-methyl-benzyl)-4-(3-trifluoromethoxy-phenyl)-1,4-dihydro-tetrazol-5-one,
1-(4-amino-3-methyl-benzyl)-4-(4-fluoro-phenyl)-1,4-dihydro-tetrazol-5-one,
1-(4-amino-3-methyl-benzyl)-4-(4-chloro-phenyl)-1,4-dihydro-tetrazol-5-one,
1-(4-amino-3-methyl-benzyl)-4-(4-bromo-phenyl)-1,4-dihydro-tetrazol-5-one,
1-(4-amino-3-methyl-benzyl)-4-(4-methyl-phenyl)-1,4-dihydro-tetrazol-5-one,
1-(4-amino-3-methyl-benzyl)-4-(4-isopropyl-phenyl)-1,4-dihydro-tetrazol-5-one,
1-(4-amino-benzyl)-4-(4-trifluoromethyl-phenyl)-1,4-hydro-tetrazol-5-one,
1-(4-amino-2-chloro-benzyl)-4-(4-trifluoromethyl-phenyl)-1,4-dihydro-tetrazol-5-one,
1-(4-amino-3-chloro-benzyl)-4-(4-trifluoromethyl-phenyl)-1,4-dihydro-tetrazol-5-one,
1-(4-amino-3-methyl-benzyl)-4-(4-trifluoromethyl-phenyl)-1,4-dihydro-tetrazol-5-one,
1-(4-amino-3-methyl-benzyl)-4-(4-difluoromethoxy-phenyl)-1,4-dihydro-tetrazol-5-one,
1-(4-amino-3-methyl-benzyl)-4-(4-trifluoromethoxy-phenyl)-1,4-dihydro-tetrazol-5-one,
1-(4-amino-3-methyl-benzyl)-4-(4-trifluoromethylsulfanyl-phenyl)-1,4-dihydro-tetrazo-5-one,
1-(4-amino-3-methyl-benzyl)-4-(4′-trifluoromethyl-biphenyl-4-yl)-1,4-dihydro-tetrazol-5-one,
1-(4-amino-3-methyl-benzyl)-4-(3′,5′-bis-trifluoromethyl-biphenyl-4-yl)-1,4-dihydro-tetrazol-5-one,
1-(4-amino-3-methyl-benzyl)-4-(4-bromo-2-fluoro-phenyl)-1,4-dihydro-tetrazol-5-one,
1-(4-amino-3-methyl-benzyl)-4-(2-fluoro-3-trifluoromethyl-phenyl)-1,4-dihydro-tetrazol-5-one,
1-(4-amino-3-methyl-benzyl)-4-(3-bromo-4-trifluoromethoxy-phenyl)-1,4-dihydro-tetrazol-5-one,
1-(4-amino-3-methyl-benzyl)-4-(3-chloro-2-methoxy-phenyl)-1,4-dihydro-tetrazol-5-one,
1-(4-amino-3-methyl-benzyl)-4-(4-fluoro-3-trifluoromethyl-phenyl)-1,4-dihydro-tetrazol-5-one,
1-(4-amino-3-methyl-benzyl)-4-(2-fluoro-5-trifluoromethyl-phenyl)-1,4-dihydro-tetrazol-5-one,
1-(4-amino-3-methyl-benzyl)-4-(4-chloro-3-trifluoromethyl-phenyl)-1,4-dihydro-tetrazol-5-one,
1-(4-amino-3-methyl-benzyl)-4-(3,4-dichloro-phenyl)-1,4-dihydro-tetrazol-5-one,
1-(4-amino-3-methyl-benzyl)-4-(3,4-bis-trifluoromethyl-phenyl)-1,4-dihydro-tetrazol-5-one,
1-(4-amino-3-methyl-benzyl)-4-(3-fluoro-5-trifluoromethyl-phenyl-1,4-dihydro-tetrazol-5-one,
1-(4-amino-3-methyl-benzyl)-4-(3,5-dichloro-phenyl)-1,4-dihydro-tetrazol-5-one,
1-(4-amino-3-methyl-benzyl)-4-(3,5-dichloro-phenyl)-1,4-dihydro-tetrazol-5-one,
1-(4-amino-2-chloro-benzyl)-4-(3,5-bis-trifluoromethyl-phenyl)-1,4-dihydro-tetrazol-5-one,
1-(4-amino-3-chloro-benzyl)-4-(3,5-bis-trifluoromethyl-phenyl)-1,4-dihydro-tetrazol-5-one,
1-(4-amino-3-methyl-benzyl)-4-(3,5-bis-trifluoromethyl-phenyl)-1,4-dihydro-tetrazol-5-one,
1-(4-amino-2-methoxy-benzyl)-4-(3,5-bis-fluoromethyl-phenyl)-1,4-dihydro-tetrazol-5-one,
1-(4-amino-3-methoxy-benzyl)-4-(3,5-bis-trifluoromethyl-dihydro-tetrazol-5-one,
1-(4-amino-3,5-dimethyl-benzyl)-4-(3,5-bis-trifluoromethyl-phenyl)-1,4-dihydro-tetrazol-5-one,
1-[1-(4-amino-3-methyl-phenyl)ethyl]-4-(3,5-bis-trifluoromethyl-phenyl)-1,4-dihydro-tetrazol-5-one,
1-(4-amino-3-methyl-benzyl)-4-(3-chloro-2-methoxy-5-methyl-phenyl)-1,4-dihydro-tetrazol-5-one,
1-(4-amino-3-methyl-benzyl)-4-(2,2-difluoro-benzo[1,3]dioxol-5-yl)-1,4-dihydro-tetrazol-5-one,
1-(4-amino-3-methyl-benzyl)-4-(2,2,3,3-tetrafluoro-2,3-dihydro-benzo[1,4]dioxin-6-yl)-1,4-dihydrotetrazol-5-one,
1-(4-amino-3-methyl-benzyl)-4-(2,2,3-trifluoro-2,3-dihydro-benzo[1,4]dioxin-6-yl)-1,4-dihydrotetrazol-5-one,
1-(4-amino-3-methyl-benzyl)-4-(2,3,3-trifluoro-2,3-dihydro-benzo[1,4]dioxin-6-yl)-1,4-dihydrotetrazol-5-one,
1-(4-amino-3-methyl-benzyl)-4-(2,2,3,3,7-pentafluoro-2,3-dihydro-benzo[1,4]dioxin-6-yl)-1,4-dihydro-tetrazol-5-one,
1-(4-amino-3-methyl-benzyl)-4-(3,5-chloro-2,6-diethyl-phenyl)-1,4-dihydro-tetrazol-5-one,
1-(4-amino-3-methyl-benzyl)-4-benzyl-1,4-dihydro-tetrazol-5-one,
1-(4-amino-3-methyl-benzyl)-4-(4-fluoro-benzyl)-1,4-dihydro-tetrazol-5-one,
1-(4-amino-3-methyl-benzyl)-4-(4-chloro-phenyl)-1,4-dihydro-tetrazol-5-one,
-(4-amino-3-methyl-benzyl)-4-(4-trifluoromethyl-phenyl)-1,4-dihydro-tetrazol-5-one,
1-(4-amino-3-methyl-benzyl)-4-[1-(2-fluoro-phenyl)ethyl]-1,4-dihydro-tetrazol-5-one,
1-(4-amino-3-methyl-benzyl)-4-[1-(2-chloro-phenyl)-ethyl]-1,4-dihydro-tetrazol-5-one,
1-(4-amino-3-methyl-benzyl)-4-[1-(2-trifluoromethyl-phenyl)-ethyl]-1,4-dihydro-tetrazol-5-one,
1-(4-amino-3-methyl-benzyl)-4-[1-(3-fluoro-phenyl)-ethyl]-1,4-dihydro-tetrazol-5-one,
1-(4-amino-3-methyl-benzyl)-4-[1-(3-chloro-phenyl)-ethyl]-1,4-dihydro-tetrazol-5-one,
1-(4-amino-3-methyl-benzyl)-4-[1-(3-trifluoromethyl-phenyl)-ethyl]-1,4-dihydro-tetrazol-5-one,
1-(4-amino-3-methyl-benzyl)-4-[1-(4-fluoro-phenyl)-ethyl]-1,4-dihydro-tetrazol-5-one,
1-(4-amino-3-methyl-benzyl)-4-[1-(4-chloro-phenyl)-ethyl]-1,4-dihydro-tetrazol-5-one,
1-(4-amino-3-methyl-benzyl)-4-[1-(4-trifluoromethyl-phenyl)-ethyl]-1,4-dihydro-tetrazol-5-one,
1-(4-amino-3-methyl-benzyl)-4-[1-(2,4-difluoro-phenyl)-ethyl]-1,4-dihydro-tetrazol-5-one,
1-(4-amino-3-methyl-benzyl)-4-[1-(2,4-dichloro-phenyl)-ethyl]-1,4-dihydro-tetrazol-5-one,
1-(4-amino-3-methyl-benzyl)-4-[1-(3,4-difluoro-phenyl)-ethyl]-1,4-dihydro-tetrazol-5-one.

The compounds of the above-mentioned formula (IX) are novel compounds and can be obtained, for example, by reacting compounds of the formula 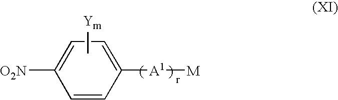
wherein Y, m, A¹ and r have the same definition as aforementioned and
M represents chloro, bromo or methylsulfonyloxy,
and compounds of the formula 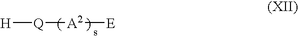
wherein Q, A², s and E have the same definition as aforementioned.

The compounds of the above-mentioned formula (XI) are compounds well known in the field of organic chemistry (cf. Chem. Abstr. 1963, 58, 3444e; Bull. Soc. Chim. Fr. 1934, 539-545; J. Chem. Res. Miniprint, 1987, 8, 2133-2139; J. Chem. Soc. B 1967, 1154-1158; J. Chem. Soc. 1961, 221-222; J. Amer. Chem. Soc. 1989, 111, 5880-5886). Specifically there can be mentioned as examples
4-nitrobenzyl chloride, (available on the market)
4-bromobenzyl chloride, (available on the market)
2-chloro-4-nitrobenzyl chloride,
2-methyl-4-nitrobenzyl chloride,
2-methoxy-4-nitrobenzyl chloride,
3-chloro-4-nitrobenzyl chloride,
3-methyl-4-nitrobenzyl chloride,
3-methoxy-4-nitrobenzyl chloride,
4-nitrobenzyl methanesulfonate,
2-chloro-4-nitrobenzyl methanesulfonate,
2-methyl-4-nitrobenzyl methanesulfonate,
2-methoxy-4-nitrobenzyl methanesulfonate,
3-chloro-4-nitrobenzyl methanesulfonate,
3-methyl-4-nitrobenzyl methanesulfonate,
3-methoxy-4-nitrobenzyl methanesulfonate,
1-(3-chloro-4-nitro-phenyl)-ethyl methanesulfonate,
1-(3-methyl-4-nitro-phenyl)-ethyl methanesulfonate,
1-(3-methoxy-4-nitro-phenyl)-ethyl methanesulfonate.

The nitro-substituted benzoic acids and their esters, starting materials for the compounds of the formula (XI) are known from the literature (cf., for example, Chem. Ber. 1919, 52, 1083; Bull. Soc. Chim. Fr. 1962, 2255-2261; Tetrahedron 1985, 115-118; Chem. Pharm. Bull., 1993, 41, 894-906).

The compounds of the above-mentioned formula (XII) include known compounds and as their specific examples there can be mentioned,
1H-pyrrole,
3-methyl-1H-pyrrole,
2,5-dimethyl-1H-pyrrole,
1H-pyrazole,
3-methyl-1H-pyrazole,
4-methyl-1H-pyrazole,
4-chloro-1H-pyrazole,
3,5-dimethyl-1H-pyrazole,
1H-imidazole,
4-methyl-1H-imidazole,
4,5-dichloro-1H-imidazole,
1H-[1,2,3]-triazole,
1H-[1,2,4]-triazole,
1H-tetrazole,
5-methyl-1H-tetrazole,
5-phenyl-1H-tetrazole,
5-(2-chloro-phenyl)-1H-tetrazole,
5-(4-chloro-phenyl)-1H-tetrazole,
5-(3-trifluoromethyl-phenyl)-1H-tetrazole,
5-(4-trifluoromethyl-phenyl)-1H-tetrazole,
5-(3,5-bis-trifluoromethyl-phenyl)-1H-tetrazole,
5-(3-trifluoromethoxy-phenyl)-1H-tetrazole,
succinimide,
1-(4-trifluoromethyl-phenyl)-imidazolidin-2-one
1-(4-trifluoromethyl-phenyl)-1,3-dihydro-imidazol-2-one,
3-(4-trifluoromethyl-phenyl)-imidazolidin-2,4-dione
2-(2-chloro-phenyl)-2,4-dihydro-[1,2,4]triazol-3-one,
2-(2-trifluoromethyl-phenyl)-2,4-dihydro-[1,2,4]triazol-3-one,
2-(3-fluoro-phenyl)-2,4-dihydro-[1,2,4]triazol-3-one,
2-(3-chloro-phenyl)-2,4-dihydro-[1,2,4]triazol-3-one,
2-(3-trifluoromethyl-phenyl)-2,4-dihydro-[1,2,4]triazol-3-one,
2-(4-fluoro-phenyl)-2,4-dihydro-[1,2,4]triazol-3-one,
2-(4-chloro-phenyl)-2,4-dihydro-[1,2,4]triazol-3-one,
2-(4-trifluoromethyl-phenyl)-2,4-dihydro-[1,2,4]triazol-3-one,
2-(3,4-bis-trifluoromethyl-phenyl)-2,4-dihydro-[1,2,4]triazol-3-one,
2-(3,5-bis-trifluoromethyl-phenyl)-2,4-dihydro-[1,2,4]triazol-3-one,
5-trifluoromethyl-2-(4-trifluoromethyl-phenyl)-2,4-dihydro-[1,2,4]triazol-3-one,
4-(2-chloro-phenyl)-2,4-dihydro-[1,2,4]triazol-3-one,
4-(4-trifluoromethyl-phenyl)-2,4-dihydro-[1,2,4]triazol-3-one,
5-methyl-4-(4-trifluoromethyl-phenyl)-2,4-dihydro-[1,2,4]triazol-3-one,
4-(2-chloro-phenyl)-5-methylsulfanyl-2,4-dihydro-[1,2,4]triazol-3-one,
5-methylsulfanyl-4-(4-trifluoromethyl-phenyl)-2,4-dihydro-[1,2,4]triazol-3-one,
1-methyl-1,4-dihydro-tetrazol-5-one,
1-ethyl-1,4-dihydro-tetrazol-5-one,
1-propyl-1,4-dihydro-tetrazol-5-one,
1-isobutyl-1,4-dihydro-tetrazol-5-one,
1-(2,2,2-trifluoro-ethyl) 1,4-dihydro-tetrazol-5-one,
1-(4,4,4-trifluoro-butyl)-1,4-dihydro-tetrazol-5-one,
1-(3,3,3-trichloro-2-methyl-propyl)-1,4-dihydro-tetrazol-5-one,
1-cyclopropyl-1,4-dihydro-tetrazol-5-one,
1-cyclohexyl-1,4-dihydro-tetrazol-5-one,
1-phenyl-1,4-dihydro-tetrazol-5-one,
1-(2-fluoro-phenyl)-1,4-dihydro-tetrazol-5-one,
1-(2-chloro-phenyl)-1,4-dihydro-tetrazol-5-one,
1-(2-methyl-phenyl)-1,4-dihydro-tetrazol-5-one,
1-(2-methoxy-phenyl)-1,4-dihydro-tetrazol-5-one,
1-(2-trifluoromethyl-phenyl)-1,4-dihydro-tetrazol-5-one,
1-(2-trifluoromethoxy-phenyl)-1,4-dihydro-tetrazol-5-one,
1-(3-fluoro-phenyl)-1,4-dihydro-tetrazol-5′-one,
1-(3-chloro-phenyl)-1,4-dihydro-tetrazol-5-one,
1-(3-methyl-phenyl)-1,4-dihydro-tetrazol-5-one,
1-(3-trifluoromethyl-phenyl)-1,4-dihydro-tetrazol-5-one,
1-(3-difluoromethoxy-phenyl)-1,4-dihydro-tetrazol-5-one,
1-(3-trifluoromethoxy-phenyl)-1,4-dihydro-tetrazol-5-one,
1-(4-fluoro-phenyl)-1,4-dihydro-tetrazol-5-one,
1-(4-chloro-phenyl)-1,4-dihydro-tetrazol-5-one,
1-(4-bromo-phenyl)-1,4-dihydro-tetrazol-5-one,
1-(4-methyl-phenyl)-1,4-dihydro-tetrazol-5-one,
1-(4-isopropyl-phenyl)-1,4-dihydro-tetrazol-5-one,
1-(4-trifluoromethyl-phenyl)-1,4-dihydro-tetrazol-5-one,
1-(4′-trifluoromethoxy-phenyl)-1,4-dihydro-tetrazol-5-one,
1-(4-trifluoromethoxy-phenyl)-1,4-dihydro-tetrazol-5-one,
1-(4-trifluoromethylsulfanyl-phenyl)-1,4-dihydro-tetrazol-5-one,
1-(4′-trifluoromethyl-biphenyl-4-yl)-1,4-dihydro-tetrazol-5-one,
1-(3′,5′-bis-trifluoromethyl-biphenylyl)-1,4-dihydro-tetrazol-5-one,
1-(4-bromo-2-fluoro-phenyl-1,4-dihydro-tetrazol-5-one,
1-(2-fluoro-3-trifluoromethyl-phenyl)-1,4-dihydro-tetrazol-5-one,
1-(3-bromo-4-trifluoromethoxy-phenyl)-1,4-dihydro-tetrazol-5-one,
1-(3-chloro-4-trifluoromethoxy-phenyl)-1,4-dihydro-tetrazol-5-one,
1-(4-fluoro-3-trifluoromethyl-phenyl)-1,4-dihydro-tetrazol-5-one,
1-(2-fluoro-5-trifluoromethyl-phenyl)-1,4-dihydro-tetrazol-5-one,
1-(4-chloro-3-trifluoromethyl-phenyl)-1,4-dihydro-tetrazol-5-one,
1-(3,4-dichloro-phenyl)-1,4-dihydro-tetrazol-5-one,
1-(3,4-dichloro-phenyl)-1,4-dihydro-tetrazol-5-one,
1-(3,4-bis-trifluoromethyl-phenyl)-1,4-dihydro-tetrazol-5-one,
1-(3-fluoro-5-trifluoromethyl-phenyl)-1,4-dihydro-tetrazol-5-one,
1-(3,5-dichloro-phenyl)-1,4-dihydro-tetrazol-5-one,
1-(3,5-dimethoxy-phenyl)-1,4-dihydro-tetrazol-5-one,
1-(3,5-bis-trifluoromethyl-phenyl)-1,4-dihydro-tetrazol-5-one,
1-(3-chloro-2-methoxy-5-methyl-phenyl)-1,4-dihydro-tetrazol-5-one,
1-(2,2-difluoro-benzo[1,3]dioxol-5-yl)-1,4-dihydro-tetrazol-5-one,
1-(2,2,3,3-tetrafluoro-2,3-dihydro-benzo[1,4]dioxin-6-yl)-1,4-dihydro-tetrazol-5-one,
1-(2,2,3-trifluoro-2,3-dihydro-benzo[1,4]dioxin-6-yl)-1,4-dihydro-tetrazol-5-one,
1-(2,3,3-trifluoro-2,3-dihydro-benzo[1,4]dioxin-6-yl)-1,4-dihydro-tetrazol-5-one,
1-(2,2,3,3,7-pentafluoro-2,3-dihydro-benzo[1,4]dioxin-6-yl)-1,4-dihydro-tetrazol-5-one,
1-(3,5-dichloro-2,6-diethyl-phenyl)-1,4-dihydro-tetrazol-5-one,
1-thiophen-2-yl-1,4-dihydro-tetrazol-5-one,
1-benzyl-1,4-dihydro-tetrazol-5-one,
1-(4-fluoro-benzyl)-1,4-dihydro-tetrazol-5-one,
1-(4-chloro-benzyl)-1,4-dihydro-tetrazol-5-one,
1-(4-trifluoromethyl-benzyl)-1,4-dihydro-tetrazol-5-one,
1-[1-(2-fluoro-phenyl)-ethyl]-1,4-dihydro-tetrazol-5-one,
1-[1-(2-chloro-phenyl)-ethyl]-1,4-dihydro-tetrazol-5-one,
1-[1-(2-trifluoromethyl-phenyl)-ethyl]-1,4-dihydro-tetrazol-5-one,
1-[1-(3-fluoro-phenyl)-ethyl]-1,4-dihydro-tetrazol-5-one,
1-[1-(3-chloro-phenyl)-ethyl]-1,4-dihydro-tetrazol-5-one,
1-[1-(3-trifluoromethyl-phenyl)-ethyl]-1,4-dihydro-tetrazol-5-one,
1-[1-(4-fluoro-phenyl)-ethyl]-1,4-dihydro-tetrazol-5-one,
1-[1-(4-chloro-phenyl)-ethyl]-1,4-dihydro-tetrazol-5-one,
1-[1-(4-trifluoromethyl-phenyl)-ethyl]-1,4-dihydro-tetrazol-5-one,
1-[1-(2,4-difluoro-phenyl)-ethyl]-1,4-dihydro-tetrazol-5-one,
1-[1-(2,4-dichloro-phenyl)-ethyl]-1,4-dihydro-tetrazol-5-one,
1-[1-(3,4-difluoro-phenyl)-ethyl]-1,4-dihydro-tetrazol-5-one.

Furthermore, there can be provided from the processes described in the literature, for example, 1-(4-trifluoromethyl-phenyl)imidazolidin-2,4,5-trione from 4-trifluoromethylphenylurea (cf. J. Chem. Soc. Perkin Trans. 2, 1977, 934, according to the process described in Chem. Ber. 1907, 40, 3737), there can be provided 3-(4-trifluoromethyl-phenyl)-1H-pyrazole from 4-trifluoromethylacetophenone, available on the market (cf. Synthesis 2001, 55-62), and further there can be provided 2-phenyl-2,4-dihydro-1,2,4-triazol-3-one and 2-(2-fluorophenyl)-2,4-dihydro-1,2,4-triazol-3-one (cf. J. Prakt. Chem. 1907, 75, 131), and furthermore, there can be provided 1-mono-(or di-)(trifluoromethyl)phenyl-1,4-dihydro-tetrazol-5-one by a reaction of mono-(or di-)(trifluoromethyl)phenyl isocyanate and known trimethylsilyl azide (cf. EP-A 0 146 279, Chem. Pharm. Bull., 1996, 44,314-327).

The process to prepare the compounds of the above-mentioned formula (In) can be conducted in an adequate diluent. As examples of the diluent used in that case there can be mentioned aliphatic, alicyclic and aromatic hydrocarbons (may be optionally chlorinated), for example, pentane, hexane, cyclohexane, petroleum ether, ligroine, benzene, toluene, xylene, dichloromethane; ethers, for example, ethyl ether, methyl ethyl ether, isopropyl ether, butyl ether, dioxane, dimethoxyethane (DME), tetrahydrofuran (THF), diethylene glycol dimethyl ether (DGM); ketones, for example, acetone, methyl ethyl ketone (MEK), methyl isopropyl ketone, methyl isobutyl ketone (MIBK); nitrites, for example, acetonitrile, propionitrile, acrylonitrile; esters, for example, ethyl acetate, amyl acetate; acid amides, for example, dimethylformamide (DMF), dimethylacetamide (DMA), N-methylpyrrolidone, 1,3-dimethyl-2-imidazolidinone, hexamethyl phosphoric triamide (HMPA).

The reaction can be conducted in the presence of an acid binder and as such an acid binder there can be mentioned, as inorganic base, hydrides, hydroxides, carbonates, bicarbonates, etc. of alkali metals and alkaline earth metals, for example, sodium hydride, lithium hydride, sodium hydrogen carbonate, potassium hydrogen carbonate, sodium carbonate, potassium carbonate, lithium hydroxide, sodium hydroxide, potassium hydroxide, calcium hydroxide; inorganic alkali metal, amides, for example, lithium amide, sodium amide, potassium amide; as organic base, alcoholates, tertiary amines, dialkylaminoanilines and pyridines, for example, triethylamine, 1,1,4,4-tetramethylethylenediamine (TMEDA), N,N-dimethylaniline, N,N-diethylaniline, pyridine, 4-dimethylaminopyridine (DMAP), 1,4-diazabicyclo[2.2.2]octane (DABCO) and 1,8-diazabicyclo[5.4.0]undec-7-ene (DBU).

The reaction can also be conducted by a process using a phase-transfer catalyst. As examples of the diluent used in that case there can be mentioned water; aliphatic, alicyclic and aromatic hydrocarbons (may be optionally chlorinated), for example, pentane, hexane, cyclohexane, petroleum ether, ligroine, benzene, toluene, xylene; ethers, for example, ethyl ether, methyl ethyl ether, iso-propyl ether, butyl ether, dioxane, dimethoxyethane (DME), tetrahydrofuran (THF), diethylene glycol dimethyl ether (DGM).

As examples of phase-transfer catalyst there can be mentioned, quaternary ions, for example, tetramethylammonium bromide, tetrapropylammonium bromide, tetrabutylammonium bromide, tetrabutylammonium bissulfate, tetrabutylammonium iodide, trioctylmethylammonium chloride, benzyltriethylammonium bromide, butylpyridinium bromide, heptylpyridinium bromide, benzyltriethylammonium chloride; crown ethers, for example, dibenzo-18-crown-6, dicyclohexyl-18-crown-6, 18-crown-6; cryptands, for example, [2.2.2]-cryptate, [2.1.1]-cryptate, [2.2.1]-cryptate, [2.2.B]-cryptate, [2O2O2S]-cryptate, [3.2.2]-cryptate.

The reaction can be conducted in a substantially wide range of temperature. It can be conducted at the temperatures in a range of generally about 0° C. to about 200° C., preferably room temperature to about 150° C. Although said reaction is conducted desirably under normal pressure, it can be operated also under elevated pressure or under reduced pressure.

In conducting the reaction, the aimed compounds can be obtained, for example, by reacting 1 mole amount to a little excess amount of a compound of the formula (XII) to 1 mole of the compounds of the formula (XI) in a diluent, for example, DMF, in the presence of potassium carbonate.

As specific examples of the compounds of the aforementioned formula (IX), obtained according to the above-mentioned process, there can be mentioned, for example,
1-(4-nitro-benzyl)-1H-pyrrole,
1-(3-methyl-4-nitro-benzyl)-1H-pyrazole,
3-methyl-1-(3-methyl-4-nitro-benzyl)-1H-pyrazole,
4-methyl-1-(3-methyl-nitro-benzyl)-1H-pyrazole,
4,5-dichloro-1-(3-methyl-4-nitro-benzyl)-1H-imidazole,
1-(3-methyl-4-nitro-benzyl)-1H-1,2,3-triazole,
1-(3-methyl-4-nitro-benzyl)-H-1,2,4-triazole,
1-(3-methyl-4-nitro-benzyl)-1H-tetrazole,
5-methyl-1-(3-methyl-4-nitro-benzyl)-1-H-tetrazole,
5-(2-chloro-phenyl)-1-(3-methyl-4-nitro-benzyl)-1H-tetrazole,
5-(3-trifluoromethyl-phenyl)-1-(3-methyl-4-nitro-benzyl)-1H-tetrazole,
5-(4-trifluoromethyl-phenyl)-1-(3-methyl-4-nitro-benzyl)-1H-tetrazole,
5-(3,5-bis-trifluoromethyl-phenyl)-1-(3-methyl-4-nitro-benzyl)-1H-tetrazole,
5-(3-trifluoromethoxy-phenyl)-1-(3-methyl-4-nitro-benzyl)-1H-tetrazole,
1-(3-methyl-4-nitro-benzyl)-3-(4-trifluoromethyl-phenyl)-imidazolidin-2-one,
1-(3-methyl-4-nitro-benzyl)-3-(4-trifluoromethyl-phenyl)-1,3-dihydro-imidazol-2-one,
1-(3-methyl-4-nitro-benzyl)-3-(4-trifluoromethyl-phenyl)-imidazolidin-2,4-dione,
1-(3-methyl-4-nitro-benzyl)-3-(4-trifluoromethyl-phenyl)-imidazolidin-2,4,5-trione,
1-(3-methyl-4-nitro-benzyl)-3-(4-trifluoromethyl-phenyl)-1H-pyrazole,
2-(2-fluoro-phenyl)-4-(3-methyl-4-nitro-benzyl)-2,4-dihydro-1,2,4-triazol-3-one,
2-(2-chloro-phenyl)-4-(3-methyl-4-nitro-benzyl)-2,4-dihydro-1,2,4-triazol-3-one,
4-(3-methyl-4-nitro-benzyl)-2-(2-trifluoromethyl-phenyl)-2,4-dihydro-1,2,4-triazol-3-one,
2-(3-fluoro-phenyl)-4-(3-methyl-4-nitro-benzyl)-2,4-dihydro-1,2,4-triazol-3-one,
2-(3-chloro-phenyl)-4-(3-methyl-4-nitro-benzyl)-2,4-dihydro-1,2,4-triazol-3-one,
4-(3-methyl-4-nitro-benzyl)-2-(3-trifluoromethyl-phenyl)-2,4-dihydro-1,2,4-triazol-3-one,
2-(4-fluoro-phenyl)-4-(3-methyl-4-nitro-benzyl)-2,4-dihydro-1,2,4-triazol-3-one,
2-(4-chloro-phenyl)-4-(3-methyl-4-nitro-benzyl)-2,4-dihydro-1,2,4-triazol-3-one,
4-(3-methyl-4-nitro-benzyl)-2-(4-trifluoromethyl-phenyl)-2,4-dihydro-1,2,4-triazol-3-one,
2-(3,4-bis-trifluoromethyl-phenyl)-4-(3-methyl-4-nitro-benzyl)-2,4-dihydro-1,2,4-triazol-3-one,
2-(3,5-bis-trifluoromethyl-phenyl)-4-(3-methyl-4-nitro-benzyl)-2,4-dihydro-1,2,4-triazol-3-one,
4-(3-methyl-4-nitro-benzyl)-5-trifluoromethyl-2-(4-trifluoromethyl-phenyl)-2,4-dihydro-1,2,4-triazol-3-one,
4-(2-chloro-phenyl)-2-(3-methyl-4-nitro-benzyl)-2,4-dihydro-1,2,4-triazol-3-one,
2-(3-methyl-4-nitro-benzyl)-4-(4-trifluoromethyl-phenyl)-2,4-dihydro-1,2,4-triazol-3-one,
5-methyl-2-(3-methyl-4-nitro-benzyl)-4-(4-trifluoromethyl-phenyl)-2,4-dihydro-1,2,4-triazol-3-one,
4-(2-chloro-phenyl)-2-(3-methyl-4-nitro-benzyl)-5-methylsulfanyl-2,4-dihydro-1,2,4-triazol-3-one,
2-(3-methyl-4-nitro-benzyl)-5-methylsulfanyl-4-(4-trifluoromethyl-phenyl)-2,4-dihydro-1,2,4-triazol-3-one,
1-methyl-4-(3-methyl-4-nitro-benzyl)-1,4-dihydro-tetrazol-5-one,
1-ethyl-4-(3-methyl-4-nitro-benzyl)-1,4-dihydro-tetrazol-5-one,
1-propyl-4-(3-methyl-4-nitro-benzyl)-1,4-dihydro-tetrazol-5-one,
1-isobutyl-4-(3-methyl-4-nitro-benzyl)-1,4-dihydro-tetrazol-5-one,
1-(3-methyl-4-nitro-benzyl)-4-(2,2,2-trifluoro-ethyl)-1,4-dihydro-tetrazol-5-one,
1-(3-methyl-4-nitro-benzyl)-4-(4,4,4-trifluoro-butyl)-1,4-dihydro-tetrazol-5-one,
1-(3-methyl-4-nitro-benzyl)-4-(3,3,3-trichloro-2-methyl-propyl)-1,4-dihydro-tetrazol-5-one,
1-cyclopropyl-4-(3-methyl-4-nitro-benzyl)-1,4-dihydro-tetrazol-5-one,
1-cyclohexyl-4-(3-methyl-4-nitro-benzyl)-1,4-dihydro-tetrazol-5-one,
1-(3-methyl-4-nitro-benzyl)-4-phenyl-1,4-dihydro-tetrazol-5-one,
1-(2-fluoro-phenyl)(3-methyl-4-nitro-benzyl)-1,4-dihydro-tetrazol-5-one,
1-(2-chloro-phenyl)-4-(4-nitro-benzyl)-1,4-dihydro-tetrazol-5-one,
1-(2-chloro-phenyl)-4-(3-methyl-4-nitro-benzyl)-1,4-dihydro-tetrazol-5-one,
1-(2-chloro-phenyl)-4-[1-(3-methyl-4-nitro-phenyl)-ethyl]-1,4-dihydro-tetrazol-5-one,
1-(3-methyl-4-nitro-benzyl)-4-(2-methyl-phenyl)-1,4-dihydro-tetrazol-5-one,
1-(3-methyl-4-nitro-benzyl)-4-(2-methoxy-phenyl)-1,4-dihydro-tetrazol-5-one,
1-(3-methyl-4-nitro-benzyl)-4-(2-trifluoromethyl-phenyl)-1,4-dihydro-tetrazol-5-one,
1-(3-methyl-4-nitro-benzyl)-4-(2-trifluoromethoxy-phenyl)-1,4-dihydro-tetrazol-5-one,
1-(3-fluoro-phenyl)-4-(3-methyl-4-nitro-benzyl)-1,4-dihydro-tetrazol-5-one,
1-(3-chloro-phenyl)-4-(3-methyl-4-nitro-benzyl)-1,4-dihydro-tetrazol-5-one,
1-(3-methyl-4-nitro-benzyl)-4-(3-methyl-phenyl)-1,4-dihydro-tetrazol-5-one,
1-(4-nitro-benzyl)-4-(3-trifluoromethyl-phenyl)-1,4-dihydro-tetrazol-5-one,
1-(3-methyl-4-nitro-benzyl)-4-(3-trifluoromethyl-phenyl)-1,4-dihydro-tetrazol-5-one,
1-(3-difluoromethoxy-phenyl)-4-(3-methyl-4-nitro-benzyl)-1,4-dihydro-tetrazol-5-one,
1-(3-methyl-4-nitro-benzyl)-4-(3-trifluoromethoxy-phenyl)-1,4-dihydro-tetrazol-5-one,
1-(4-fluoro-phenyl)-4-(3-methyl-4-nitro-benzyl)-1,4-dihydro-tetrazol-5-one,
1-(4-chloro-phenyl)-4-(3-methyl-4-nitro-benzyl)-1,4-dihydro-tetrazol-5-one,
1-(4-bromo-phenyl)-4-(3-methyl-4-nitro-benzyl)-1,4-dihydro-tetrazol-5-one,
1-(3-methyl-4-nitro-benzyl)-4-(4-methyl-phenyl)-1,4-dihydro-tetrazol-5-one,
1-(4-isopropyl-phenyl)-4-(3-methyl-4-nitro-benzyl)-1,4-dihydro-tetrazol-5-one,
1-(4-nitro-benzyl)-4-(4-trifluoromethyl-phenyl)-1,4-dihydro-tetrazol-5-one,
1-(2-chloro-4-nitro-benzyl)-4-(4-trifluoromethyl-phenyl)-1,4-dihydro-tetrazol-5-one,
1-(3-chloro-4-nitro-benzyl)-4-(4-trifluoromethyl-phenyl)-1,4-dihydro-tetrazol-5-one,
-1-(3-methyl-4-nitro-benzyl)-4-(4-trifluoromethyl-phenyl)-1,4-dihydro-tetrazol-5-one,
1-(4-difluoromethoxy-phenyl)-4-(3-methyl-4-nitro-benzyl)-1,4-dihydro-tetrazol-5-one,
1-(3-methyl-nitro-benzyl)-4-(4-trifluoromethoxy-phenyl)-1,4-dihydro-tetrazol-5-one,
1-(3-methyl-4-nitro-benzyl)-4-(4-trifluoromethylsulfanyl-phenyl)-1,4-dihydro-tetrazol-5-one,
1-(3-methyl-4-nitro-benzyl)-4-(4′-trifluoromethyl-biphenyl-4-yl)-1,4-dihydro-tetrazol-5-one,
1-(3′,5′-bis-trifluoromethyl-biphenyl-4-yl)-4-(3-methyl-4-nitro-benzyl)-1,4-dihydro-tetrazol-5-one,
1-(4-bromo-2-fluoro-phenyl)-4-(3-methyl-4-nitro-benzyl)-1,4-dihydro-tetrazol-5-one,
1-(2-fluoro-3-trifluoromethyl-phenyl)-4-(3-methyl-4-nitro-benzyl)-1,4-dihydro-tetrazol-5-one,
1-(3-bromo-4-trifluoromethoxy-phenyl)-4-(3-methyl-4-nitro-benzyl)-1,4-dihydro-tetrazol-5-one,
-(3-chloro-4-trifluoromethoxy-phenyl)-4-(3-methyl-4-nitro-benzyl)-1,4-dihydro-tetrazol-5-one,
1-(4-fluoro-3-trifluoromethyl-phenyl)-4-(3-methyl-4-nitro-benzyl)-1,4-dihydro-tetrazol-5-one,
1-(2-fluoro-5-trifluoromethyl-phenyl)-4-(3-methyl-4-nitro-benzyl)-1,4-dihydro-tetrazol-5-one,
1-(4-chloro-3-fluoromethyl-phenyl)-4-(3-methyl-4-nitro-benzyl)-1,4-dihydro-tetrazol-5-one,
1-(3,4-chloro-phenyl)-4-(3-methyl-4-nitro-benzyl)-1,4-dihydro-tetrazol-5-one,
1-(3,4-bis-trifluoromethyl-phenyl)-4-(3-methyl-4-nitro-benzyl)-1,4-dihydro-tetrazol-5-one,
1-(3-fluoro-5-trifluoromethyl-phenyl)-4-(3-methyl-4-nitro-benzyl)-1,4-dihydro-tetrazol-5-one,
1-(3,5-dichloro-phenyl)-4-(3-methyl-4-nitro-benzyl)-1,4-dihydro-tetrazol-5-one,
1-(3,5-dimethoxy-phenyl) (3-methyl-4-nitro-benzyl)-1,4-dihydro-tetrazol-5-one,
1-(3,5-bis-trifluoromethyl-phenyl)-4-(2-chloro-4-nitro-benzyl)-1,4-dihydro-tetrazol-5-one,
1-(3,5-bis-trifluoromethyl-phenyl)-4-(3-chloro-4-nitro-benzyl)-1,4-dihydro-tetrazol-5-one,
1-(3,5-bis-trifluoromethyl-phenyl)-4-(3-methyl-4-nitro-benzyl)-1,4-dihydro-tetrazol-5-one,
1-(3,5-bis-trifluoromethyl-phenyl)-4-(2-methoxy-4-nitro-benzyl)-1,4-dihydro-tetrazol-5-one,
1-(3,5-bis-trifluoromethyl-phenyl)-4-(3-methoxy-4-nitro-benzyl)-1,4-dihydro-tetrazol-5-one,
1-(3,5-bis-trifluoromethyl-phenyl)-4-(3,5-dimethyl-4-nitro-benzyl)-1,4-dihydro-tetrazol-5-one,
1-(3,5-bis-trifluoromethyl-phenyl)-4-[1-(3-methyl-4-nitro-phenyl)-ethyl]-1,4-dihydro-tetrazol-5-one,
1-(3-chloro-2-methoxy-5-methyl-phenyl)-4-(3-methyl-4-nitro-benzyl)-1,4-dihydro-tetrazol-5-one,
1-(2,2-difluoro-benzo[1,3]dioxol-5-yl)-4-(3-methyl-4-nitro-benzyl)-1,4-dihydro-tetrazol-5-one,
1-(3-methyl-4-nitro-benzyl)-4-(2,2,3,3-tetrafluoro-2,3-dihydro-benzo[1,4]dioxin-6-yl)-1,4-dihydrotetrazol-5-one,
1-(3-methyl-4-nitro-benzyl)(2,2,3-trifluoro-2,3-dihydro-benzo[1,4]dioxin-6-yl)-1,4-dihydrotetrazol-5-one,
1-(3-methyl-4-nitro-benzyl)-4-(2,3,3-trifluoro-2,3-dihydro-benzo[1,4]dioxin-6-yl)-1,4-dihydrotetrazol-5-one,
1-(3-methyl-4-nitro-benzyl)-4-(2,2,3,3,7-pentafluoro-2,3-dihydro-benzo[1,4]dioxin-6-yl)-1,4-dihydro-tetrazol-5-one,
1-(3,5-dichloro-2,6-diethyl-phenyl)-4-(3-methyl-4-nitro-benzyl)-1,4-dihydro-tetrazol-5-one,
1-benzyl-4-(3-methyl-4-nitro-benzyl)-1,4-dihydro-tetrazol-5-one,
1-(4-fluoro-benzyl)(3-methyl-4-nitro-benzyl)-1,4-dihydro-tetrazol-5-one,
1-(4-chloro-benzyl)-4-(3-methyl-4-nitro-benzyl)-1,4-dihydro-tetrazol-5-one,
1-(3-methyl-4-nitro-benzyl)-4-(4-trifluoromethyl-benzyl)-1,4-dihydro-tetrazol-5-one,
1-[1-(2-fluoro-phenyl)-ethyl]-4-(3-methyl-4-nitro-benzyl)-1,4-dihydro-tetrazol-5-one,
1-[1-(2-chloro-phenyl)-ethyl]-4-(3-methyl-4-nitro-benzyl)-1,4-dihydro-tetrazol-5-one,
1-(3-methyl-4-nitro-benzyl)-4-[1-(2-trifluoromethyl-phenyl)-ethyl]-1,4-dihydro-tetrazol-5-one,
1-[1-(3-fluoro-phenyl)-ethyl]-4-(3-methyl-4-nitro-benzyl)-1,4-dihydro-tetrazol-5-one,
1-[1-(3-chloro-phenyl)ethyl]-4-(3-methyl-4-nitro-benzyl)-1,4-dihydro-tetrazol-5-one,
1-(3-methyl-4-nitro-benzyl)-4-[1-(3-trifluoromethyl-phenyl)-ethyl]-1,4-dihydro-tetrazol-5-one,
1-[1-(4-fluoro-phenyl)-ethyl]-4-(3-methyl-4-nitro-benzyl)-1,4-dihydro-tetrazol-5-one,
1-[1-(4-chloro-phenyl)-ethyl]-4-(3-methyl-4-nitro-benzyl)-1,4-dihydro-tetrazol-5-one,
1-(3-methyl-4-nitro-benzyl)-4-[1-(4-trifluoromethyl-phenyl)-ethyl]-1,4-dihydro-tetrazol-5-one,
1-[1-(2,4-difluoro-phenyl)-ethyl](3-methyl-4-nitro-benzyl)-1,4-dihydro-tetrazol-5-one,
1-[1-(2,4-dichloro-phenyl)-ethyl]-4-(3-methyl-4-nitro-benzyl)-1,4-dihydro-tetrazol-5-one,
1-[1-(3,4-difluoro-phenyl)-ethyl]-4-(3-methyl-4-nitro-benzyl)-1,4-dihydro-tetrazol-5-one.

And as specific examples of the compounds of the formula (IV), starting materials in the preparation process (b), there can be mentioned, for example,
2-{2-methyl-4-[5-oxo-4-(2-chloro-phenyl)-4,5-dihydro-tetrazol-1-ylmethyl]-phenyl}-isoindol-1,3-dione,
4-fluoro-2-{2-methyl-4-[5-oxo-4-(2-chloro-phenyl)-4,5-dihydro-tetrazol-1-ylmethyl]-phenyl}-isoindol-1,3-dione,
4-chloro-2-{2-methyl-4-[5-oxo-4-(2-chloro-phenyl)-4,5-dihydro-tetrazol-1-ylmethyl]-phenyl}-isoindol-1,3-dione,
4-bromo-2-{2-methyl-4-[5-oxo-4-(2-chloro-phenyl)-4,5-dihydro-tetrazol-1-ylmethyl]-phenyl}-isoindol-1,3-dione,
4-iodo-2-{2-methyl-4-[5-oxo-4-(2-chloro-phenyl)-4,5-dihydro-tetrazol-1-ylmethyl]-phenyl}-isoindol-1,3-dione,
4,7-dichloro-2-{2-methyl-4-[5-oxo-4-(2-chloro-phenyl)-4,5-dihydro-tetrazol-1-ylmethyl]-phenyl}-isoindol-1,3-dione,
5,6-dichloro-2-{2-methyl-4-[5-oxo-4-(2-chloro-phenyl)-4,5-dihydro-tetrazol-1-ylmethyl]-phenyl}-isoindol-1,3-dione,
4-nitro-2-{2-methyl-4-[5-oxo(2-chloro-phenyl)-4,5-dihydro-tetrazol-1-ylmethyl]-phenyl}-isoindol-1,3-dione,
4-methyl-2-{2-methyl-[5-oxo-4-(2-chloro-phenyl)-4,5-dihydro-tetrazol-1-ylmethyl]-phenyl}-isoindol-1,3-dione,
2-{2-methyl-4-[5-oxo-4-(4-trifluoromethyl-phenyl)-4,5-dihydro-tetrazol-1-ylmethyl]-phenyl}-isoindol-1,3-dione,
4-fluoro-2-{2-methyl-4-[5-oxo-4-(4-trifluoromethyl-phenyl)-4,5-dihydro-tetrazol-1-ylmethyl]-phenyl}-isoindol-1,3-dione,
4-chloro-2-{2-methyl-4-[5-oxo-4-(4-trifluoromethyl-phenyl)-4,5-dihydro-tetrazol-1-ylmethyl]-phenyl}-isoindol-1,3-dione,
4-bromo-2-{2-methyl-4-[5-oxo-4-(4-trifluoromethyl-phenyl)-4,5-dihydro-tetrazol-1-ylmethyl]-phenyl}-isoindol-1,3-dione,
4-iodo-2-{2-methyl-4-[5-oxo-4-(4-trifluoromethyl-phenyl)-4,5-dihydro-tetrazol-1-ylmethyl]-phenyl}-isoindol-1,3-dione,
4,7-dichloro-2-{2-methyl-4-[5-oxo-4-(4-trifluoromethyl-phenyl)-4,5-dihydro-tetrazol-1-ylmethyl]-phenyl}-isoindol-1,3-dione,
5,6-dichloro-2-{2-methyl-4-[5-oxo-4-(4-trifluoromethyl-phenyl)-4,5-dihydro-tetrazol-1-ylmethyl]-phenyl}-isoindol-1,3-dione,
4-nitro-2-{2-methyl-4-[5-oxo-4-(4-trifluoromethyl-phenyl)-4,5-dihydro-tetrazol-1-ylmethyl]-phenyl}-isoindol-1,3-dione,
4-methyl-2-{2-methyl-4-[5-oxo-4-(4-trifluoromethyl-phenyl)-4,5-dihydro-tetrazol-1-ylmethyl]-phenyl)-isoindol-1,3-dione,
2-{2-methyl-4-[5-oxo-4-(3,5-bis-trifluoromethyl-phenyl)-4,5-dihydro-tetrazol-1-ylmethyl]-phenyl}-isoindol-1,3-dione,
4-fluoro-2-{2-methyl-4-[5-oxo-4-(3,5-bis-trifluoromethyl-phenyl)-4,5-dihydro-tetrazol-1-ylmethyl]-phenyl}-isoindol-1,3-dione,
4-chloro-2-{2-methyl-4-[5-oxo-4-(3,5-bis-trifluoromethyl-phenyl)-4,5-dihydro-tetrazol-1-ylmethyl]-phenyl}-isoindol-1,3-dione,
4-bromo-2-{2-methyl-4-[5-oxo-4-(3,5-bis-trifluoromethyl-phenyl)-4,5-dihydro-tetrazol-1-ylmethyl]-phenyl}-isoindol-1,3-dione,
4-iodo-2-{2-methyl-4-[5-oxo-4-(3,5-bis-trifluoromethyl-phenyl)-4,5-dihydro-tetrazol-1-ylmethyl]-phenyl}-isoindol-1,3-dione,
4,7-dichloro-2-{2-methyl-4-[5-oxo-4-(3,5-bis-trifluoromethyl-phenyl)-4,5-dihydro-tetrazol-1-ylmethyl]-phenyl}-isoindol-1,3-dione,
5,6-dichloro-2-{2-methyl-4-[5-oxo-4-(3,5-bis-trifluoromethyl-phenyl)-4,5-dihydro-tetrazol-1-ylmethyl]-phenyl}-isoindol-1,3-dione,
4-nitro-2-{2-methyl-4-[5-oxo-4-(3,5-bis-trifluoromethyl-phenyl)-4,5-dihydro-tetrazol-1-ylmethyl]-phenyl}-isoindol-1,3-dione,
4-methyl-2-{2-methyl-4-[5-oxo-4-(3,5-bis-trifluoromethyl-phenyl)-4,5-dihydro-tetrazol-1-ylmethyl]-phenyl}-isoindol-1,3-dione.

The compounds of the formula (V), starting materials in the preparation process (b), are either well-known compounds in the field of organic chemistry or can be synthesized according to the process described in DE-A 20 45 905, WO 01/23350 etc. As their specific examples there can be mentioned ethylamine, diethylamine, n-propylamine, isopropylamine, n-butylamine, sec-butylamine, isobutylamine, t-butylamine, t-amylamine, cyclopropylamine, cyclopentylamine, cyclohexylamine, 3-methylcyclohexylamine, 2-(methylthio)-ethylamine, 2-(ethylthio)-ethylamine, 1-methyl-2-(methylthio) ethylamine, 1,1-dimethyl-2-(methylthio)-ethylamine, etc.

Compounds of the formula (VI), starting materials in the preparation process (c), include known compounds or can be easily obtained according to the process described in EP-A 0 919 542, EP-A 1 006 107 etc. and as their specific examples there can be mentioned,
N-isopropyl-phthalamic acid,
3-fluoro-N-isopropyl-phthalamic acid,
3-chloro-N-isopropyl-phthalamic acid,
3-bromo-N-isopropyl-phthalamic acid,
3-iodo-N-isopropyl-phthalamic acid,
N-isopropyl-3-nitro-phthalamic acid,
N-(1-methyl-2-methylsulfanil-ethyl)-phthalamic acid,
3-fluoro-N-(1-methyl-2-methylsulfanil-ethyl)-phthalamic acid,
3-chloro-N-(1-methyl-2-methylsulfanil-ethyl)-phthalamic acid,
3-bromo-N-(1-methyl-2-methylsulfanil-ethyl)-phthalamic acid,
3-iodo-N-(1-methyl-2-methylsulfanil-ethyl)-phthalamic acid,
N-(1-methyl-2-methylsulfanil-ethyl)-3-nitro-phthalamic acid,
N-(1,1-dimethyl-2-methylsulfanil-ethyl)-phthalamic acid,
N-(1,1-dimethyl-2-methylsulfanil-ethyl)-3-fluoro-phthalamic acid,
3-chloro-N-(1,1-dimethyl-2-methylsulfanil-ethyl)-phthalamic acid,
3-bromo-N-(1,1-dimethyl-2-methylsulfanil-ethyl)-phthalamic acid,
N-(1,1-dimethyl-2-methylsulfanil-ethyl)-3-iodo-phthalamic acid,
N-(1,1-dimethyl-2-methylsulfanil-ethyl)-3-nitro-phthalamic acid,
N-isopropyl-3-methanesulfonyloxy-phthalamic acid,
N-(1-methyl-2-methylsulfanil-ethyl)-3-methanesulfonyloxy-phthalamic acid,
N-(1,1-dimethyl-2-methylsulfanil-ethyl)-3-methanesulfonyloxy-phthalamic acid.

The compounds of the above-mentioned formula (VI) can be easily obtained generally by reacting phthalic anhydrides of the formula 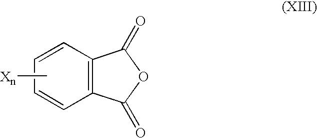
wherein X and n have the same definition as aforementioned,
and amines of the formula 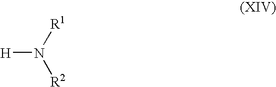
wherein R¹ and R² have the same definition as aforementioned.

The above-mentioned compounds of the formula (XII) and the compounds of the formula (XIV) are all well-known in the field of organic chemistry and specifically there can be mentioned the following as examples.

As examples of the compounds of the formula (XM) there can be mentioned,

phthalic anhydride, 3-fluorophthalic anhydride, 3-chlorophthalic anhydride, 3-bromophthalic anhydride, 3-iodophthalic anhydride, 3-methylphthalic anhydride, 3-nitrophthalic anhydride, 3,6-difluorophthalic anhydride, 3,6-dichlorophthalic anhydride, 4,5-dichlorophthalic anhydride, 3,4,5,6-tetrafluorophthalic anhydride, 3,4,5,6-tetrachlorophthalic anhydride, 3-methanesulfonyloxyphthalic anhydride.

As examples of the compounds of the formula (XIV) there can be mentioned,

ethylamine, n-propylamine, isopropylamine, n-butylamine, sec-butylamine, isobutylamine, t-butylamine, t-amylamine, cyclopropylamine, cyclopentylamine, cyclohexylamine, 2-(methylthio)-ethylamine, 2-(ethylthio)-ethylamine, 1-methyl-2-(methylthio)-ethylamine, 1,1-dimethyl-2-(methylthio)ethylamine.

These amines can be easily obtained also by the process described in DE-A 20 45 905, WO 01/23350.

The reaction for synthesizing the compounds of the formula (VI) can be conducted according to the process described in J. Org. Chem. 1981, 46, 175 etc.

Such a reaction can be conducted in an adequate diluent and as examples of the diluent used in that case there can be mentioned aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene; ethers, for example, ethyl ether, methyl ethyl ether, isopropyl ether, butyl ether, dioxane, dimethoxyethane (DME), tetrahydrofuran (THF), diethylene glycol dimethyl ether (DGM); ketones, for example, acetone, methyl ethyl ketone (MEK), methyl isopropyl ketone, methyl isobutyl ketone (MIBK), etc.; nitrites, for example, acetonitrile, propionitrile, acrylonitrile; esters, for example, ethyl acetate, amyl acetate.

The preparation process (e) can be conducted in the presence of a base and as such a base there can be mentioned tertiary amines, dialkylaminoanilines and pyridines, for example, triethylamine, 1,1,4,4-tetramethylethylenediamine (TMEDA), N,N-dimethylaniline, N,N-diethylaniline, pyridine, 4-dimethylaminopyridine (DMAP), 1,4-diazabicyclo[2.2.2]octane (DABCO) and 1,8-diazabicyclo[5.4.0]undec-7-ene (DBU), etc.

The reaction can be conducted in a substantially wide range of temperature. It can be conducted at the temperatures in a range of generally about −70° C. to about 100° C., preferably about 50° C. to about 80° C. Although said reaction is conducted desirably under normal pressure, it can be operated also under elevated pressure or under reduced pressure.

In conducting the reaction, the aimed compounds can be obtained, for example, by reacting 1 mole amount to 4 mole amount of the compounds of the formula (XIV) to 1 mole of the compounds of the formula X in a diluent, for example, acetonitrile.

The compounds of the formula (VII), starting materials in the preparation process (d), are novel compounds and can be easily obtained, for example, by reacting a compound represented by the formula (VIII-a) 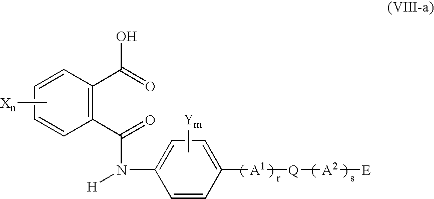
wherein X, n, A¹, r, Q, A², s and E have the same definition as aforementioned, in the presence of a condensing agent (cf. e.g. J. Med. Chem. 1967, 10, 982).

The compounds of the above-mentioned formula (VIII-a) are also novel compounds and can be easily obtained by reacting phthalic anhydrides of the aforementioned formula (X) and the compounds of the aforementioned formula (III), in which R³ is a hydrogen atom.

The above-mentioned reaction of a compound of the formula (VIII-a) and a compound of the formula (III), in which R³ is a hydrogen atom, can be conducted in an adequate diluent and as examples of the diluent used in that case there can be mentioned aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene; ethers, for example, ethyl ether, methyl ethyl ether, isopropyl ether, butyl ether, dioxane, dimethoxyethane (DME), tetrahydrofuran (THF), diethylene glycol dimethyl ether (GM); ketones, for example, acetone, methyl ethyl ketone (MEK), methyl isopropyl ketone, methyl isobutyl ketone (MIBK); nitriles, for example, acetonitrile, propionitrile, acrylonitrile, etc.; esters, for example, ethyl acetate, amyl acetate.

The reaction can be conducted in the presence of a base and as such a base there can be mentioned tertiary amines, dialkylaminoanilines and pyridines, for example, triethylamine, 1,1,4,4-tetramethylethylenediamine (TMEDA), N,N-dimethylaniline, N,N-diethylaniline, pyridine, 4-dimethylaminopyridine (DMAP), 1,4-diazabicyclo[2.2.2]octane (DABCO) and 1,8-diazabicyclo[5.4.0]undec-7-ene (DBU).

The reaction can be conducted in a substantially wide range of temperature. It can be conducted at the temperatures in a range of generally about −70° C. to about 100° C., preferably about −50° C. to about 80° C.

Although said reaction is conducted desirably under normal pressure, it can be operated also under elevated pressure or under reduced pressure.

In conducting the reaction, the aimed compounds can be obtained, for example, by reacting 1 mole amount to 4 mole amount of the compounds of the formula (III), in which R³ is a hydrogen atom, to 1 mole of the compounds of the formula (X) in a diluent, for example, acetonitrile.

As specific examples of the compounds of the above-mentioned formula (OM-a), there can be mentioned, for example,
N-{4-[4-(2-chloro-phenyl)-5-oxo-4,5-dihydro-tetrazol-1-ylmethyl]-2-methyl-phenyl}-6-iodo-phthalamic acid,
6-iodo-N-{2-methyl-4-[5-oxo-4-(2-trifluoromethyl-phenyl)-4,5-dihydro-tetrazol-1-ylmethyl]-phenyl}-phthalamic acid,
N-{4-[4-(4-fluoro-phenyl)-5-oxo-4,5-dihydro-tetrazol-1-ylmethyl]-2-methyl-phenyl}-6-iodo-phthalamic acid,
N-{4-[4-(4-chloro-phenyl)-5-oxo-4,5-dihydro-tetrazol-1-ylmethyl]-2-methyl-phenyl}-6-iodo-phthalamic acid,
6-iodo-N-{2-methyl-4-[5-oxo-4-(4-trifluoromethyl-phenyl)-4,5-dihydro-tetrazol-1-ylmethyl]-phenyl}-phthalamic acid, etc.

And as specific examples of the compounds of the above-mentioned formula (VII), there can be mentioned, for example,
1-(2-chloro-phenyl)-4-[4-(4-iodo-3-oxo-3H-isobenzofuran-1,4-ylideneamino)-3-methyl-benzyl]-1,4-dihydro-tetrazol-5-one,
1-[4-(4-iodo-3-oxo-3H-isobenzofuran-1-ylideneamino)-3-methyl-benzyl]-4-(2-trifluoromethyl-phenyl)-1,4-dihydro-tetrazol-5-one,
1-(2-fluoro-phenyl)-4-[4-(4-iodo-3-oxo-3H-isobenzofuran-4-ylideneamino)-3-methyl-benzyl]-1,4-dihydro-tetrazol-5-one,
1-(4-chloro-phenyl)-4-[4-(4-iodo-3-oxo-3H-isobenzofuran-1-ylideneamino)-3-methyl-benzyl]-1,4-dihydro-tetrazol-5-one,
1-[4-(4-iodo-3-oxo-3H-isobenzofuran-1-ylideneamino)-3-methyl-benzyl]4-(4-trifluoromethyl-phenyl)-1,4-dihydro-tetrazol-5-one, etc.

The compounds of the formula (V), also starting materials in the preparation process (d), have been described in the aforementioned preparation process (b).

The compounds of the formula (VIII), starting materials in the preparation process (e), are novel compounds and can be easily obtained, as described in the aforementioned preparation process (d), generally by reacting phthalic anhydrides of the aforementioned formula (Q with the compounds of the aforementioned formula (III).

The reaction is the same as already described in the aforementioned preparation process (d).

As specific examples of the compounds of the formula (VM) there can be mentioned,
N-{4-[4-(2-chloro-phenyl)-5-oxo-4,5-dihydro-tetrazol-1-ylmethyl]-2-methyl-phenyl}-N-methyl-6-iodo-phthalamic acid,
6-iodo-N-{2-methyl-4-[5-oxo-4-(2-trifluoromethyl-phenyl)-4,5-dihydro-tetrazol-1-ylmethyl]-phenyl}-N-methyl-phthalamic acid,
N-{4-[4-(4-fluoro-phenyl)-5-oxo-4,5-dihydro-tetrazol-1-ylmethyl]-2-methyl-phenyl}-N-methyl-6-iodo-phthalamic acid,
N-{4-[4-(4-chloro-phenyl)-5-oxo-4,5-dihydro-tetrazol-1-ylmethyl]-2-methyl-phenyl}-N-methyl-6-iodo-phthalamic acid,
6-iodo-N-{2-methyl-4-[5-oxo-4-(4-trifluoromethyl-phenyl)-4,5-dihydro-tetrazol-1-ylmethyl]-N-methyl-phenyl}-phthalamic acid.

The compounds of the formula (V), also starting materials in the preparation process (e), are identical with those in the aforementioned preparation processes (b) and (d).

As another preparation process for the compounds of the aforementioned formula (VIII), the common starting materials in the preparation process (d) and preparation process (e), in which X and Y represent other groups than bromo or iodo, compounds of the formula 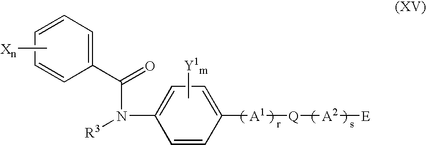
wherein n, R³, m, A¹, r, Q, A², s and E have the same definition as aforementioned, and X¹ and Y¹ each has a definition of the aforementioned X and Y but excluding bromo and iodo, is reacted with a metal reagent, for example, butyl lithium, and then reacted with carbon dioxide to obtain the compounds of the corresponding formula (VIII) (however, X and Y do not represent bromo or iodo).

The compounds of the above-mentioned formula (XV) are novel compounds and can be easily obtained generally by reacting a benzoic acid halide represented by the formula 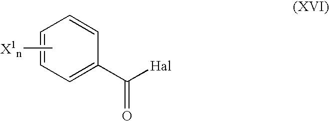
wherein X¹ and n have the same definition as aforementioned, and
Hal represents a halogen atom,
with the compounds of the aforementioned formula (I) 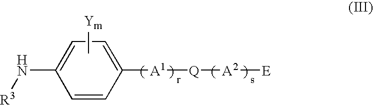
wherein R³, Y, m, A¹, r, Q, A², s and E have the same definition as aforementioned.

The compounds of the above-mentioned formula (XVI are well-known compounds in the field of organic chemistry and there can be mentioned specifically,

benzoyl chloride, 3-fluorobenzoyl chloride, 3-chlorobenzoyl chloride, 3-methylbenzoyl chloride, 3-nitrobenzoyl chloride.

The reaction to prepare the compounds of the above-mentioned formula (XV) can be conducted in an adequate diluent and as examples of the diluent used in that case there can be mentioned aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene; ethers, for example, ethyl ether, methyl ethyl ether, isopropyl ether, butyl ether, dioxane, dimethoxyethane (DME), tetrahydrofuran (THF); diethylene glycol dimethyl ether (DGM); esters, for example, ethyl acetate, amyl acetate.

The reaction can be conducted in the presence of an acid binder and as such an acid binder there can be mentioned, as inorganic base, hydroxides, carbonates, bicarbonates, etc. of alkali metals and alkaline earth metals, for example, sodium hydrogen carbonate, potassium hydrogen carbonate, sodium carbonate, potassium carbonate, lithium hydroxide, sodium hydroxide, potassium hydroxide, calcium hydroxide; as organic base, alcoholates, tertiary amines, dialkylaminoanilines and pyridines, for example, triethylamine, 1,1,4,4-tetramethylethylenediamine (TMEDA), N,N-dimethylaniline, N,N-diethylaniline, pyridine, 4-dimethylaminopyridine (DMAP), 1,4-diazabicyclo[2.2.2]octane (DABCO) and 1,8-diazabicyclo[5.4.0]undec-7-ene (DBU).

The reaction can be conducted in a substantially wide range of temperature. It can be conducted at the temperatures in a range of generally about −20 to about 150° C., preferably about 0° C. to about 100° C.

Although said reaction is conducted desirably under normal pressure, it can be operated also under elevated pressure or under reduced pressure.

In conducting the reaction, the aimed compounds can be obtained, for example, by reacting 1 mole amount to a little excess amount of the compounds of the formula (III) to 1 mole of the compounds of the formula (XVI) in a diluent, for example, 1,2-dichloroethane, in the presence of triethylamine.

The compounds of the formula (I), starting materials in the preparation process (f), are the compounds included in the aforementioned formula (I) of the present invention. By oxidizing C₁-C₆-alkylthio-C₁-C₆-alkyl, the definition of R^{1f} in the formula (If), compounds of the formula (I) corresponding to C₁-C₆-alkylsulfinyl-C₁-C₆-alkyl or C₁-C₆-alkylsulfonyl-C₁-C₆-alkyl can be obtained.

The compounds of the formula (If) can be prepared by the aforementioned preparation processes (a), (b), (c), (d) and/or (e).

As specific examples of the compounds of the formula (If) there can be mentioned, for example,
3-iodo-N²-(1-methyl-2-methylsulfanyl-ethyl)-N¹-{2-methyl-4-[5-oxo-4-(3-trifluoromethyl-phenyl)-4,5-dihydro-triazol-1-ylmethyl]-phenyl}-phthalamide,
N²-(1,1-dimethyl-2-methylsulfanyl-ethyl)-3-iodo-N¹-{2-methyl-4-[5-oxo-4-(3-trifluoromethylphenyl)-4,5-dihydro-triazol-1-ylmethyl]-phenyl}-phthalamide,
3-iodo-N²-(1-methyl-2-methylsulfanyl-ethyl)-N′-{2-methyl-4-[5-oxo-4-(4-trifluoromethyl-phenyl)-4,5-dihydro-triazol-1-ylmethyl]-phenyl}-phthalamide,
N²-(1,1-dimethyl-2-methylsulfanyl-ethyl)-3-iodo-N′-{2-methyl-4-[5-oxo-4-(4-trifluoromethylphenyl)-4,5-dihydro-triazol-1-ylmethyl]-phenyl}-phthalamide,
N¹-{4-[4-(3,5-bis-trifluoromethyl-phenyl)-5-oxo-4,5-dihydro-triazol-1-ylmethyl]-2-methyl-phenyl}-3-iodo-N²-(1-methyl-2-methylsulfanyl-ethyl)-phthalamide,
N¹-(4-[4-(3,5-bis-trifluoromethyl-phenyl)₅-oxo(4,5-dihydro-triazol-1-ylmethyl]-2-methyl-phenyl}-N²-(1,1-dimethyl-2-methylsulfanyl-ethyl)-3-iodo-phthalamide, etc.

The reaction of the aforementioned preparation process (a) can be conducted by using adequate diluents, singly or mixed, and as examples of the diluents used in that case there can be mentioned water; aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene; ethers, for example, ethyl ether, methyl ethyl ether, isopropyl ether, butyl ether, dioxane, dimethoxyethane (DME), tetrahydrofuran (THF), diethylene glycol dimethyl ether (DGM); nitriles, for example, acetonitrile, propionitrile, acrylonitrile; esters, for example, ethyl acetate, amyl acetate.

The preparation process (a) can be conducted in the presence of an acid catalyst and as examples of such an acid catalyst there can be mentioned mineral acids, for example, hydrochloric acid, sulfuric acid, organic acids, for example, acetic acid, trifluoroacetic acid, propionic acid, methanesulfonic acid, benzenesulfonic acid, p-toluenesulfonic acid.

The preparation process (a) can be conducted in a substantially wide range of temperature. It can be conducted at the temperatures in a range of generally about −20° C. to about 100° C., preferably about 0° C. to about 100° C.

Although said reaction is conducted desirably under normal pressure, it can be operated also under elevated pressure or under reduced pressure.

In conducting the preparation process (a), the aimed compounds can be obtained, for example, by reacting 1 mole amount to a little excess amount of the compounds of the formula (III) to 1 mole of the compounds of the formula (II) in a diluent, for example, 1,2-dichloroethane, in the presence of 0.01-0.1 mole amount of p-toluenesulfonic acid.

The preparation process (b) can be conducted in the presence of a base such as tertiary amines, dialkylaminoanilines and pyridines, for example, triethylamine, 1,1,4,4-tetramethylethylenediamine (TMEDA), N,N-dimethylaniline, N,N-diethylaniline, pyridine, 4-dimethylaminopyridine (DMAP), 1,4-diazabicyclo[2.2.2]octane (DABCO) and 1,8-diazabicyclo[5.4.0]undec-7-ene (DBU), etc.

The preparation process (b) can be conducted in a substantially wide range of temperature. It can be conducted at the temperatures in a range of generally about −20° C. to about 150° C., preferably room temperature to about 100° C. Although said reaction is conducted desirably under normal pressure, it can be operated also under elevated pressure or under reduced pressure.

In conducting the preparation process (b), the aimed compounds can be obtained, for example, by reacting 1 mole amount to 25 mole amount of the compounds of the formula (V) to 1 mole of the compounds of the formula (IV).

The aforementioned preparation processes (c), (d) and (e) can be conducted under the similar conditions as for the above-mentioned preparation process (a).

The reaction of the aforementioned preparation process (f) can be conducted in an adequate diluent and as examples of the diluents used in that case there can be mentioned aliphatic, alicyclic and aromatic hydrocarbons (may be optionally chlorinated), for example, benzene, toluene, xylene, dichloromethane, chloroform, carbon tetrachloride, 1,2-dichloroethane, chlorobenzene, dichlorobenzene; alcohols, for example, methanol, ethanol, isopropanol, butanol, acids: formic acid, acetic acid.

As oxidizing agent to be used there can be mentioned, for example, metachloroperbenzoic acid, peracetic acid, potassium metaperiodate, potassium hydrogen persulfate (oxone), hydrogen peroxide.

The preparation process (f) can be conducted in a substantially wide range of temperature. It can be conducted at the temperatures in a range of generally about −50° C. to about 150° C., preferably about −10° C. to about 100° C.

Although said reaction is conducted desirably under normal pressure, it can be operated also under elevated pressure or under reduced pressure.

In conducting the preparation process (f), the aimed compounds can be obtained, for example, by reacting 1 mole amount to 5 mole amount of an oxidizing agent to 1 mole of the compounds of the formula (If) in a diluent, for example, dichloromethane.

The reaction of the preparation process (f) can be conducted according to the process described in, for example, Jikken Kagaku Kohza (Lectures of experimental chemistry), compiled by the Chemical Society of Japan, 4^{th} ed., Vol. 24, page 350 (1992) published by Maruzen or ibid., page 365.

The compounds of the formula (I) of the present invention show strong insecticidal action. They can, therefore, be used as insecticidal agents. And the active compounds of the formula (I) of the present invention exhibit exact controlling effect against harmful insects without phytotoxicity against cultured plants. The compounds of the present invention can be used for controlling a wide variety of pests, for example, harmful sucking insects, biting insects and other plant-parasitic pests, stored grain pests, hygienic pests, etc. and applied for their extermination.

As examples of such pests there can be mentioned the following pests:

As insects, there can be mentioned coleoptera pests, for example, Callosobruchus Chinensis, Sitophilus zeamais, Tribolium castaneum, Epilachna vigintioctomaculata, Agriotes fuscicollis, Anomala rufocuprea, Leptinotarsa decemlineata, Diabrotica spp., Manochamus alternatus, Lissorhoptrus oryzophilus, Lyctus bruneus;

Lepidoptera pests, for example, Lymantria dispar, Malacosoma neustria, Pieris rapae, Spodoptera litura, Mamestra brassicae, Chilo suppressalis, Pyrausta nubilalis, Ephestia cautella, Adoxophyes orana, Carpocapsa pomonella, Agrotis fucosa, Galleria mellonella, Plutella maculipennis, Heliothis virescens, Phyllocnistis citrella;

Heimiptera pests, for example, Nephotettix cincticeps, Nilaparvata lugens, Pseudococcus comstocki, Unaspis yanonensis, Myzus persicae, Aphis pomi, Aphis gossypii, Rhopalosiphum pseudobrassicas, Stephanitis nashi, Nazara spp., Cimex lectularius, Trialeurodes vaporariorum, Psylla spp.;

Orthoptera pests, for example, Blatella germanica, Periplaneta americana, Gryllotalpa africana, Locusta migratoria migratoriodes;

Homoptera pests, for example, Reticulitermes speratus, Coptotermes formosanus;

Diptera pests, for example, Musca domestica, Aedes aegypti, Hylemia platura, Culex pipiens, Anopheles slnensis, Culex tritaeniorhynchus.

Moreover, as mites there can be mentioned, for example, Tetranychus telarius, Tetraiychus urticae, Panonychus citri, Aculops pelekassi, Tarsonemus spp.

Furthermore, as nematodes there can be mentioned, for example, Meloidogyne incognita, Bursaphelenchus lignicolus Manmiya et Kiyohara, Aphelenchoides basseyi, Heterodera glycines, Pratylenchus spp.

In addition, in the field of veterinary medicine, the novel compounds of the present invention can be effectively used against various harmful animal-parasitic pests (endoparasites and ectoparasites), for example, insects and helminthes. As examples of such animal-parasitic pests there can be mentioned the following pests:

As insects there can be mentioned, for example, Gastrophilus spp., Stomoxys spp., Trichodectes spp., Rhodnius spp., Ctenocephalides canis.

As mites there can be mentioned, for example, Ornithodoros spp., Ixodes spp., Boophilus spp.

In the present invention substances having insecticidal action against pests, which include all of them, are in some cases called as insecticides.

The active compounds of the present invention can be made into customary formulation forms, when they are used as insecticides. As formulation forms there can be mentioned, for example, solutions, emulsions, wettable powders, water dispersible granules, suspensions, powders, foaming agents, pastes, tablets, granules, aerosols, active compound-impregnated natural and synthetic substances, microcapsules, seed coating agents, formulations used with burning equipment (as burning equipment, for example, fumigation and smoking cartridges, cans, coils, etc.), ULV [cold mist, warm mist], etc.

These formulations can be prepared according to per se known methods, for example, by mixing the active compounds with extenders, namely liquid diluents; liquefied gas diluents; solid diluents or carriers, and optionally by using surface-active agents, namely emulsifiers and/or dispersants and/or foam-forming agents.

In case that water is used as extender, for example, organic solvents can be used also as auxiliary solvents.

As liquid diluents or carriers there can be mentioned, for example, aromatic hydrocarbons (for example, xylene, toluene, alkylnaphthalene etc.), chlorinated aromatic or chlorinated aliphatic hydrocarbons (for example, chlorobenzenes, ethylene chlorides, methylene chloride, etc.), aliphatic hydrocarbons [for example, cyclohexane etc. or paraffins (for example, mineral oil fractions etc.)], alcohols (for example, butanol, glycols and their ethers, esters, etc.), ketones (for example, acetone, methyl ethyl ketone, methyl isobutyl ketone, cyclohexanone, etc.), strongly polar solvents (for example, dimethylformamide, dimethyl sulfoxide, etc.), and water.

Liquefied gas diluents or carriers are substances that are gases at normal temperature and pressure and there can be mentioned, for example, aerosol propellants such as butane, propane, nitrogen gas, carbon dioxide, halogenated hydrocarbons.

As solid diluents there can be mentioned, for example, ground natural minerals (for example, kaolin, clay, talc, chalk, quartz, attapulgite, montmorillonite, diatomaceous earth, etc.), ground synthetic minerals (for example, highly dispersed silicic acid, alumina, silicates, etc.).

As solid carriers for granules there can be mentioned, for example, crushed and fractionated rocks (for example, calcite, marble, pumice, sepiolite, dolomite, etc.) synthetic granules of inorganic and organic meals, particles of organic materials (for example, saw dust, coconut shells, maize cobs, tobacco stalks, etc.) etc.

As emulsifiers and/or foam-forming agents there can be mentioned, for example, nonionic and anionic emulsifiers [for example, polyoxyethylene fatty acid esters, polyoxyethylene fatty acid alcohol ethers (for example, alkylaryl polyglycol ethers, alkylsulfonates, alkylsulfates, arylsulfonates, etc.)], albumin hydrolysis products, etc.

Dispersants include, for example, lignin sulfite waste liquor and methyl cellulose.

Tackifiers can also be used in formulations (powders, granules, emulsifiable concentrates). As said tackifiers there can be mentioned, for example, carboxymethyl cellulose, natural and synthetic polymers (for example, gum Arabic, polyvinyl alcohol, polyvinyl acetate, etc.).

Colorants can also be used. As said colorants there can be mentioned, for example, inorganic pigments (for example, iron oxide, titanium oxide, Prussian Blue, etc,), organic dyestuffs such as alizarin dyestuffs, azo dyestuffs or metal phthalocyanine dyestuffs, and further traces nutrients such as salts of iron, manganese, boron, copper, cobalt, molybdenum and zinc.

Said formulations can contain the aforementioned active components of the amount in the range of generally 0.1-95% by weight, preferably 0.5-90% by weight

The active compounds of the formula (I) of the present invention can exist also as a mixed agent with other active compounds, for example, insecticides, poisonous baits, bactericides, miticides, nematicides, fungicides, growth regulators or herbicides in the form of their commercially useful formulations or in the application forms prepared from such formulations. Here, as the above-mentioned insecticides, there can be mentioned, for example, organophosphorous agents, carbamate agents, carboxylate type chemicals, chlorinated hydrocarbon type chemicals, insecticidal substances produced by microbes, etc.

Further, the active compounds of the formula (I) of the present invention can exist also as a mixed agent with a synergist and such formulations and application forms can be mentioned as commercially useful. Said synergist itself must not be active, but is a compound that enhances the action of the active compound.

The content of the active compounds of the formula (I) of the present invention in a commercially useful application form can be varied in a wide range.

The concentration of the active compounds of the formula (I) of the present invention at the time of application can be, for example, in the range of 0.0000001-100% by weight, preferably in the range of 0.00001-1% by weight

The compounds of the formula (I) of the present invention can be used by usual methods suitable to the application forms.

In case of application against hygienic pests and stored grain pests the active compounds of the present invention have a good stability against alkali on a calcific substance and further show an excellent residual effectiveness in wood and soil.

Then the present invention will be described more specifically by examples. The present invention, however, should not be restricted only to them in any way.

### EXAMPLES

### Synthesis Example 1

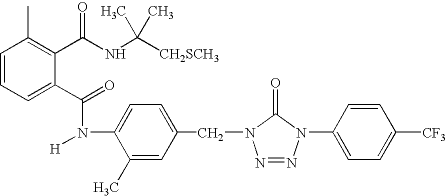

3-(1,1-Dimethyl-2-methylthioethylimino)-4-iodo-3H-isobenzofuran-1-one (0.94 g) and 1-(4-amino-3-methylbenzyl)-4-(4-trifluoromethylphenyl)-1,4-dihydrotetrazol-5-one (0.87 g) were dissolved in dichloromethane (10 ml), to which p-toluenesulfonic acid monohydrate (0.01 g) was added, and the mixture was stirred at room temperature for 3 hours. After finishing the reaction, water was added to the mixture and the organic layer was separated and dried with anhydrous magnesium sulfate. The solvent was distilled off under reduced pressure and the residue was purified by silica gel column chromatography to obtain N²-(1,1-dimethyl-2-methylthioethyl)-3-iodo-N′-[2-methyl-4-(5-oxo-4-(4-trifluoromethylphenyl)-4,5-dihydrotetrazol-1-ylmethyl)phenyl]phthalamide (0.6 g, mp. 83-87° C.).

### Synthesis Example 2

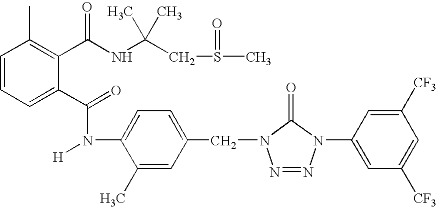

N′-{4-[4-3,5-bis-trifluoromethylphenyl)-5-oxo-4,5-dihydrotetrazol-1-ylmethyl]-2-methyl-phenyl}-N²-(1,1-dimethyl-2-methylthioethyl)-3-iodo-phthalamide (0.5 g) was dissolved in dichloromethane, to which m-chloroperbenzoic acid (0.18 g) was added, and the mixture was stirred at room temperature for 5 hours. After finishing the reaction the mixture was washed successively with aqueous solution of sodium thiosulfate, saturated aqueous solution of sodium hydrogen carbonate and saturated aqueous solution of sodium chloride and dried with anhydrous magnesium sulfate. After the solvent was distilled off, the obtained residue was purified by silica gel column chromatography to obtain N′-{4-[4-(3,5-bis-trifluoromethylphenyl)-5-oxo-4,5-dihydrotetrazol-1-ylmethyl]-2-methyl-phenyl}-3-iodo-N²-(2-methanesulfinyl-1,1-dimethylethyl)phthalamide (0.1 g, mp. 165-171° C.).

### Synthesis Example 3

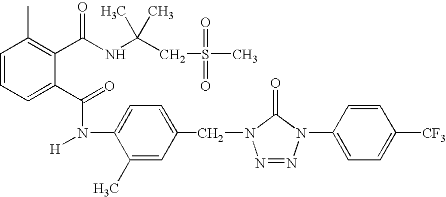

N²-(1,1-Dimethyl-2-methylthioethyl)-3-iodo-N-1-[2-methyl(5-oxo-4-(fluoromethylphenyl)-4,5-dihydrotetrazol-1-ylmethyl)phenyl]phthalamide (0.4 g) was dissolved in dichloromethane, to which m-chloroperbenzoic acid (0.24 g) was added, and the mixture was stirred at room temperature for 5 hours. After finishing the reaction the mixture was washed successively with aqueous solution of sodium thiosulfate, saturated aqueous solution of sodium hydrogen carbonate and saturated aqueous solution of sodium chloride and dried with anhydrous magnesium sulfate. After the solvent was distilled off, the obtained residue was purified by silica gel column chromatography to obtain 3-iodo-N²-(2-methanesulfonyl-1,1-dimethylethyl)-N¹-{2-methyl-4-[5-oxo-4-(4-trifluoromethylphenyl)-4,5-dihydrotetrazol-1-ylmethyl]phenyl}phthalamide (0.16 g, mp. 108-112° C.).

### Synthesis Example 4

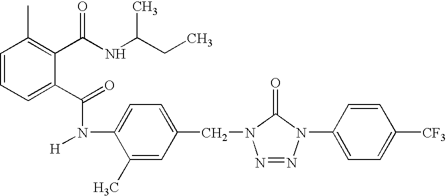

2-{2-Methyl-4-[5-oxo-4-(4-trifluoromethylphenyl)-4,5-dihydrotetrazol-1-ylmethyl]phenyl}isoindol-1,3-dione (0.25 g) was dissolved in sec-butylamine (5 ml) and the mixture was stirred at room temperature for 5 hours. After finishing the reaction, the solvent was distilled off under reduced pressure and the obtained residue was purified by silica gel column chromatography to obtain the objected N-sec-butyl-N-{2-methyl-4-[5-oxo-4-(4-trifluoromethylphenyl)-4,5-dihydrotetrazol-1-ylmethyl]phenyl}phthalamide (0.2 g, mp. 217-218° C.).

Examples of the compounds of the formula (I) of the present invention obtained in the similar manner to the Synthesis Examples 1 to 4 and the compounds of the formula (I) obtained easily by the preparation processes (a) to (f) are shown in the Table 1 to Table 4, together with the compounds obtained in the above-mentioned Synthesis Examples 1 to 4.

In all tables the abbreviations mean

Ph=phenyl, Me=methyl, Et=ethyl, n-Pr=n-propyl, i-Pr=iso-propyl.

TABLE 1

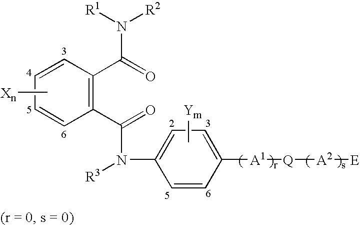

Q represents the following structures:

| | | | |
|---|---|---|---|
| 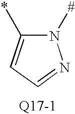 | 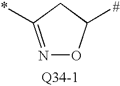 | 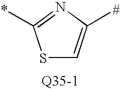 | 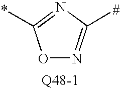 |
| 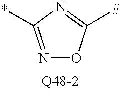 | 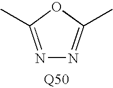 | 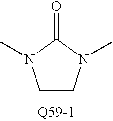 | 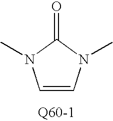 |

(wherein the bond marked with * connects with A¹ and the bond marked with # connects
with A²)

| Comp. | | | | | | | | | | m.p. |
|---|---|---|---|---|---|---|---|---|---|---|
| No. | R¹ | R² | R³ | Xₙ | Yₘ | A¹ | Q | A² | E | (° C.) |
| 1-1 | i-Pr | H | H | 3-I | 2-Me | — | Q17-1 | — | Ph-4-Cl | |
| 1-2 | C(Me)₂CH₂SMe | H | H | 3-I | 2-Me | — | Q17-1 | — | Ph-4-CF₃ | |
| 1-3 | i-Pr | H | H | 3-I | 2-Me | — | Q34-1 | — | Ph-4-CF₃ | |
| 1-4 | i-Pr | H | H | 3-I | 2-Me | — | Q35-1 | — | Ph-4-Cl | |
| 1-5 | i-Pr | H | H | 3-I | 2-Me | — | Q35-1 | — | Ph-4-CF₃ | |
| 1-6 | C(Me)₂CH₂SMe | H | H | 3-I | 2-Me | — | Q48-1 | — | Ph-4-CF₃ | |
| 1-7 | C(Me)₂CH₂SMe | H | H | 3-I | 2-Me | — | Q48-2 | — | Ph-4-CF₃ | |
| 1-8 | C(Me)₂CH₂SMe | H | H | 3-I | 2-Me | — | Q50 | — | Ph-4-CF₃ | |
| 1-9 | C(Me)₂CH₂SMe | H | H | 3-I | 2-Me | — | Q59-1 | — | Ph-4-CF₃ | |
| 1-10 | C(Me)₂CH₂SMe | H | H | 3-I | 2-Me | — | Q60-1 | — | Ph-4-CF₃ | |
| 1-11 | CH(Me)CH₂SMe | H | H | 3-I | 2-Me | — | Q50 | — | Ph-3,5-(CF₃)₂ | 228-231 |

TABLE 2

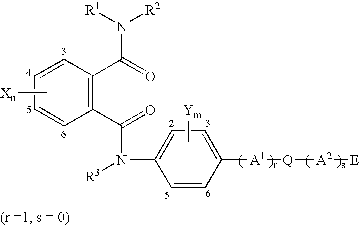

Q represents the following structures:

| | | | | | | |
|---|---|---|---|---|---|---|
| 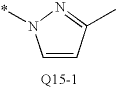 | 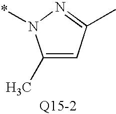 | 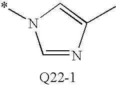 | 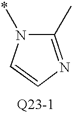 | 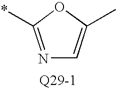 | 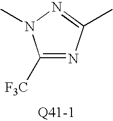 | 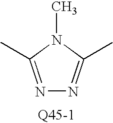 |
| 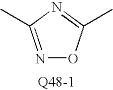 | 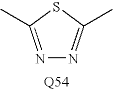 | 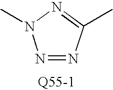 | 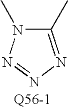 | 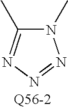 | 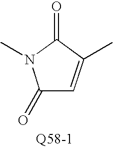 | 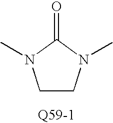 |
| 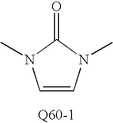 | 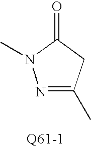 | 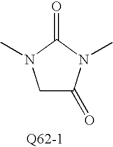 | 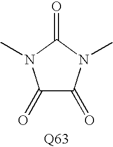 | 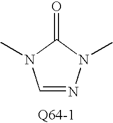 | 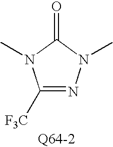 | 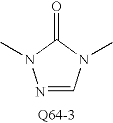 |

| | | | |
|---|---|---|---|
| 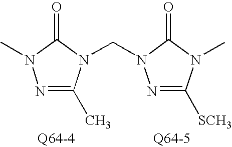 | 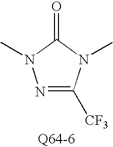 | 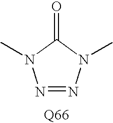 | 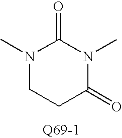 |

(wherein the bond marked with * connects with A¹ and the bond marked with # connects
with A²)

| Comp. | | | | | | | | | | m.p. |
|---|---|---|---|---|---|---|---|---|---|---|
| No. | R¹ | R² | R³ | Xₙ | Yₘ | A¹ | Q | A² | E | (° C.) |
| 2-1 | C(Me)₂CH₂SMe | H | H | 3-I | 2-Me | CH₂ | Q15-1 | — | Ph-4-CF₃ | 83-89 |
| 2-2 | C(Me)₂CH₂SMe | H | H | 3-I | 2-Me | CH₂ | Q15-2 | — | Ph-4-CF₃ | |
| 2-3 | C(Me)₂CH₂SMe | H | H | 3-I | 2-Me | CH₂ | Q22-1 | — | Ph-4-Cl | |
| 2-4 | C(Me)₂CH₂SMe | H | H | 3-I | 2-Me | CH₂ | Q23-1 | — | Ph | |
| 2-5 | C(Me)₂CH₂SMe | H | H | 3-I | 2-Me | CH₂ | Q29-1 | — | Ph-4-Cl | |
| 2-6 | C(Me)₂CH₂SMe | H | H | 3-I | 2-Me | CH₂S | Q45-1 | — | Ph-2,4-Cl₂ | |
| 2-7 | C(Me)₂CH₂SMe | H | H | 3-I | 2-Me | CH₂ | Q55-1 | — | Ph-4-CF₃ | 88-89 |
| 2-8 | C(Me)₂CH₂SMe | H | H | 3-I | 2-Me | CH₂ | Q55-1 | — | Ph-3,5-(CF₃)₂ | 114-117 |
| 2-9 | C(Me)₂CH₂SMe | H | H | 3-I | 2-Me | CH₂ | Q56-1 | — | Ph-2-Cl | 1) |
| 2-10 | C(Me)₂CH₂SMe | H | H | 3-I | 2-Me | CH₂S | Q56-2 | — | Ph | 105-107 |
| 2-11 | C(Me)₂CH₂SMe | H | H | 3-I | 2-Me | CH₂ | Q58-1 | — | Ph-4-Cl | |
| 2-12 | C(Me)₂CH₂SMe | H | H | 3-I | 2-Me | CH₂ | Q59-1 | — | Ph-4-CF₃ | 118-120 |
| 2-13 | C(Me)₂CH₂SMe | H | H | 3-I | 2-Me | CH₂ | Q60-1 | — | Ph-4-CF₃ | 2) |
| 2-14 | C(Me)₂CH₂SMe | H | H | 3-I | 2-Me | CH₂ | Q61-1 | — | Ph-3,5-(CF₃)₂ | |
| 2-15 | C(Me)₂CH₂SMe | H | H | 3-I | 2-Me | CH₂ | Q62-1 | — | Ph-4-CF₃ | 3) |
| 2-16 | C(Me)₂CH₂SMe | H | H | 3-I | 2-Me | CH₂ | Q63 | — | Ph-4-CF₃ | 131-134 |
| 2-17 | C(Me)₂CH₂SMe | H | H | 3-I | 2-Me | CH₂ | Q64-1 | — | Ph-2-F | 92-95 |
| 2-18 | C(Me)₂CH₂SMe | H | H | 3-I | 2-Me | CH₂ | Q64-1 | — | Ph-2-Cl | 4) |
| 2-19 | C(Me)₂CH₂SO₂Me | H | H | 3-I | 2-Me | CH₂ | Q64-1 | — | Ph-2-Cl | 5) |
| 2-20 | C(Me)₂CH₂SMe | H | H | 3-I | 2-Me | CH₂ | Q64-1 | — | Ph-2-CF₃ | 126-129 |
| 2-21 | C(Me)₂CH₂SMe | H | H | 3-I | 2-Me | CH₂ | Q64-1 | — | Ph-3-Cl | 88-93 |
| 2-22 | C(Me)₂CH₂SMe | H | H | 3-I | 2-Me | CH₂ | Q64-1 | — | Ph-3-F | 87-93 |
| 2-23 | C(Me)₂CH₂SO₂Me | H | H | 3-I | 2-Me | CH₂ | Q64-1 | — | Ph-3-Cl | 98-101 |
| 2-24 | C(Me)₂CH₂SO₂Me | H | H | 3-I | 2-Me | CH₂ | Q64-1 | — | Ph-3-F | 116-120 |
| 2-25 | C(Me)₂CH₂SMe | H | H | 3-I | 2-Me | CH₂ | Q64-1 | — | Ph-4-Cl | 102-104 |
| 2-26 | C(Me)₂CH₂SO₂Me | H | H | 3-I | 2-Me | CH₂ | Q64-1 | — | Ph-4-Cl | 131-134 |
| 2-27 | CH(Me)CH₂OMe | H | H | 3-I | 2-Me | CH₂ | Q64-1 | — | Ph-4-CF₃ | |
| 2-28 | CH(Me)CH₂SMe | H | H | 3-I | 2-Me | CH₂ | Q64-1 | — | Ph-4-CF₃ | |
| 2-29 | CH(Me)CH₂SOMe | H | H | 3-I | 2-Me | CH₂ | Q64-1 | — | Ph-4-CF₃ | |
| 2-30 | CH(Me)CH₂SO₂Me | H | H | 3-I | 2-Me | CH₂ | Q64-1 | — | Ph-4-CF₃ | |
| 2-31 | C(Me)₂CH₂NHCOMe | H | H | 3-I | 2-Me | CH₂ | Q64-1 | — | Ph-4-CF₃ | |
| 2-32 | C(Me)₂CH₂NHCO₂Me | H | H | 3-I | 2-Me | CH₂ | Q64-1 | — | Ph-4-CF₃ | |
| 2-33 | C(Me)₂CH═NOMe | H | H | 3-I | 2-Me | CH₂ | Q64-1 | — | Ph-4-CF₃ | |
| 2-34 | C(Me)₂CH₂CH═NOMe | H | H | 3-I | 2-Me | CH₂ | Q64-1 | — | Ph-4-CF₃ | |
| 2-35 | C(Me)₂CH₂SMe | H | H | 3-I | 2-Me | CH₂ | Q64-1 | — | Ph-4-CF₃ | 102-104 |
| 2-36 | CH(Me)CH₂OMe | H | H | 3-I | 2-Me | CH₂ | Q64-1 | — | Ph-3,5-(CF₃)₂ | |
| 2-37 | CH(Me)CH₂NHOOMe | H | H | 3-I | 2-Me | CH₂ | Q64-1 | — | Ph-3,5-(CF₃)₂ | |
| 2-38 | CH(Me)CH₂SMe | H | H | 3-I | 2-Me | CH₂ | Q64-1 | — | Ph-3,5-(CF₃)₂ | |
| 2-39 | CH(Me)CH₂SO₂Me | H | H | 3-I | 2-Me | CH₂ | Q64-1 | — | Ph-3,5-(CF₃)₂ | |
| 2-40 | C(Me)₂CH₂NHCOMe | H | H | 3-I | 2-Me | CH₂ | Q64-1 | — | Ph-3,5-(CF₃)₂ | |
| 2-41 | C(Me)₂CH₂NHCO₂Me | H | H | 3-I | 2-Me | CH₂ | Q64-1 | — | Ph-3,5-(CF₃)₂ | |
| 2-42 | C(Me)₂CH═NOMe | H | H | 3-I | 2-Me | CH₂ | Q64-1 | — | Ph-3,5-(CF₃)₂ | |
| 2-43 | C(Me)₂CH₂SMe | H | H | 3-I | 2-Me | CH₂ | Q64-1 | — | Ph-3,5-(CF₃)₂ | |
| 2-44 | C(Me)₂CH₂SMe | H | H | 3-I | 2-Me | CH₂ | Q64-2 | — | Ph-4-CF₃ | 89-92 |
| 2-45 | C(Me)₂CH₂SO₂Me | H | H | 3-OSO₂Me | 2-Me | CH₂ | Q64-1 | — | Ph-2-Cl | 6) |
| 2-46 | C(Me)₂CH₂SMe | H | H | 3-I | 2-Me | CH₂ | Q64-3 | — | Ph-2-Cl | 97-102 |
| 2-47 | C(Me)₂CH₂SMe | H | H | 3-I | 2-Me | CH₂ | Q64-5 | — | Ph-2-Cl | 123-127 |
| 2-48 | C(Me)₂CH₂SC₂Me | H | H | 3-I | 2-Me | CH₂ | Q64-3 | — | Ph-2-Cl | 135-139 |
| 2-49 | CH(Me)CH₂SMe | H | H | 3-I | 2-Me | CH₂ | Q64-3 | — | Ph-4-CF₃ | |
| 2-50 | C(Me)₂CH₂SMe | H | H | 3-I | 2-Me | CH₂ | Q64-3 | — | Ph-4-CF₃ | 98-99 |
| 2-51 | CH(Me)CH₂SMe | H | H | 3-I | 2-Me | CH₂ | Q64-3 | — | Ph-3,5-(CF₃)₂ | |
| 2-52 | C(Me)₂CH₂SMe | H | H | 3-I | 2-Me | CH₂ | Q64-3 | — | Ph-3,5-(CF₃)₂ | |
| 2-53 | C(Me)₂CH₂SMe | H | H | 3-I | 2-Me | CH₂ | Q64-5 | — | Ph-4-CF₃ | 121-126 |
| 2-54 | C(Me)₂CH₂SMe | H | H | 3-I | 2-Me | CH₂ | Q64-4 | — | Ph-4-CF₃ | 95-98 |
| 2-55 | C(Me)₂CH₂SC₂Me | H | H | 3-I | 2-Me | CH₂ | Q64-3 | — | Ph-4-CF₃ | 144-149 |
| 2-56 | Et | H | H | H | 2-Me | CH₂ | Q66 | — | Ph-4-CF₃ | |
| 2-57 | Et | Et | H | H | 2-Me | CH₂ | Q66 | — | Ph-4-CF₃ | |
| 2-58 | n-Pr | H | H | H | 2-Me | CH₂ | Q66 | — | Ph-4-CF₃ | 179-180 |
| 2-59 | i-Pr | H | H | H | 2-Me | CH₂ | Q66 | — | Ph-4-CF₃ | 7) |
| 2-60 | CH₂CH₂CH₂CH₃ | H | H | H | 2-Me | CH₂ | Q66 | — | Ph-4-CF₃ | |
| 2-61 | CH(Me)Et | H | H | H | 2-Me | CH₂ | Q66 | — | Ph-4-CF₃ | 217-218 |
| 2-62 | CH₂CH₂CH₂CH₂CH₃ | H | H | H | 2-Me | CH₂ | Q66 | — | Ph-4-CF₃ | |
| 2-63 | CH(Et)₂ | H | H | H | 2-Me | CH₂ | Q66 | — | Ph-4-CF₃ | 210 |
| 2-64 | CH(Me)n-Pr | H | H | H | 2-Me | CH₂ | Q66 | — | Ph-4-CF₃ | 193-194 |
| 2-65 | CH(Me)CH₂CH(Me)₂ | H | H | H | 2-Me | CH₂ | Q66 | — | Ph-4-CF₃ | 136-138 |
| 2-66 | CH₂-cyclohexyl | H | H | H | 2-Me | CH₂ | Q66 | — | Ph-4-CF₃ | 167-168 |
| 2-67 | CH(Me)CH₂SMe | H | H | H | 2-Me | CH₂ | Q66 | — | Ph-4-CF₃ | 166-169 |
| 2-68 | CH(Me)CH₂SOMe | H | H | H | 2-Me | CH₂ | Q66 | — | Ph-4-CF₃ | |
| 2-69 | CH(Me)CH₂SO₂Me | H | H | H | 2-Me | CH₂ | Q66 | — | Ph-4-CF₃ | 197-198 |
| 2-70 | C(Me)₂CH₂SMe | H | H | H | 2-Me | CH₂ | Q66 | — | Ph-4-CF₃ | 8) |
| 2-71 | C(Me)₂CH₂SOMe | H | H | H | 2-Me | CH₂ | Q66 | — | Ph-4-CF₃ | 89-92 |
| 2-72 | C(Me)₂CH₂SO₂Me | H | H | H | 2-Me | CH₂ | Q66 | — | Ph-4-CF₃ | 156-162 |
| 2-73 | cyclopropyl | H | H | H | 2-Me | CH₂ | Q66 | — | Ph-4-CF₃ | 204 |
| 2-74 | cyciopentyl | H | H | H | 2-Me | CH₂ | Q66 | — | Ph-4-CF₃ | 173-177 |
| 2-75 | cyclohexyl | H | H | H | 2-Me | CH₂ | Q66 | — | Ph-4-CF₃ | 111-112 |
| 2-76 | cyclohexyl-3-Me | H | H | H | 2-Me | CH₂ | Q66 | — | Ph-4-CF₃ | 191-193 |
| 2-77 | n-Pr | H | H | H | 2-Me | CH₂ | Q66 | — | Ph-3,5-(CF₃)₂ | |
| 2-78 | I-Pr | H | H | H | 2-Me | CH₂ | Q66 | — | Ph-3,5-(CF₃)₂ | 193-195 |
| 2-79 | CH₂CH₂CH₂CH₃ | H | H | H | 2-Me | CH₂ | Q66 | — | Ph-3,5-(CF₃)₂ | |
| 2-80 | CH(CH₃)Et | H | H | H | 2-Me | CH₂ | Q66 | — | Ph-3,5-(CF₃)₂ | |
| 2-81 | C(Me)₃ | H | H | H | 2-Me | CH₂ | Q66 | — | Ph-3,5-(CF₃)₂ | 190-194 |
| 2-82 | CH₂CH₂CH₂CH₂CH₃ | H | H | H | 2-Me | CH₂ | Q66 | — | Ph-3,5-(CF₃)₂ | |
| 2-83 | CH(Me)CH₂CH(Me)₂ | H | H | H | 2-Me | CH₂ | Q66 | — | Ph-3,5-(CF₃)₂ | |
| 2-84 | CH(Me)CH₂SMe | H | H | H | 2-Me | CH₂ | Q66 | — | Ph-3.5-(CF₃)₂ | 130-133 |
| 2-85 | CH(Me)CH₂SCMe | H | H | H | 2-Me | CH₂ | Q66 | — | Ph-3,5-(CF₃)₂ | |
| 2-86 | CH(Me)CH₂SC₂Me | H | H | H | 2-Me | CH₂ | Q66 | — | Ph-3,5-(CF₃)₂ | 159-163 |
| 2-87 | C(Me)₂CH₂SMe | H | H | H | 2-Me | CH₂ | Q66 | — | Ph-3,5-(CF₃₎₂ | 105-107 |
| 2-86 | C(Me)₂CH₂SC₂Me | H | H | H | 2-Me | CH₂ | Q66 | — | Ph-3,5-(CF₃₎₂ | 169-170 |
| 2-89 | i-Pr | H | H | 3-F | 2-Me | CH₂ | Q66 | — | Ph-3-CF₃ | |
| 2-90 | C(Me)₂CH₂SMe | H | H | 3-F | 2-Me | CH₂ | Q66 | — | Ph-3-CF₃ | |
| 2-91 | C(Me)₂CH₂SOMe | H | H | 3-F | 2-Me | CH₂ | Q66 | — | Ph-3-CF₃ | |
| 2-92 | C(Me)₂CH₂SO₂Me | H | H | 3-F | 2-Me | CH₂ | Q66 | — | Ph-3-CF₃ | |
| 2-93 | i-Pr | H | H | 3-F | 2-Me | CH₂ | Q66 | — | Ph-4-CF₃ | |
| 2-94 | C(Me)₂CH₂SMe | H | H | 3-F | 2-Me | CH₂ | Q66 | — | Ph-4-CF₃ | 57-69 |
| 2-95 | C(Me)₂CH₂SOMe | H | H | 3-F | 2-Me | CH₂ | Q66 | — | Ph-4-CF₃ | |
| 2-96 | C(Me)₂CH₂SO₂Me | H | H | 3-F | 2-Me | CH₂ | Q66 | — | Ph-4-CF₃ | 212-217 |
| 2-97 | i-Pr | H | H | 3-F | 2-Me | CH₂ | Q66 | — | Ph-3,5-(CF₃)₂ | |
| 2-98 | C(Me)₂CH₂SMe | H | H | 3-F | 2-Me | CH₂ | Q66 | — | Ph-3,5-(CF₃)₂ | 165-167 |
| 2-99 | C(Me)₂CH₂SOMe | H | H | 3-F | 2-Me | CH₂ | Q66 | — | Ph-3,5-(CF₃)₂ | |
| 2-100 | C(Me)₂CH_{2SO}₂Me | H | H | 3-F | 2-Me | CH₂ | Q66 | — | Ph-3,5-(CF₃)₂ | |
| 2-101 | i-Pr | H | H | 3-Cl | 2-Me | CH₂ | Q66 | — | Ph-2-Cl | |
| 2-102 | i-Pr | H | H | 3-Cl | 2-Me | CH₂ | Q66 | — | Ph-3-CF₃ | |
| 2-103 | CH(Me)CH₂SMe | H | H | 3-Cl | 2-Me | CH₂ | Q66 | — | Ph-3-CF₃ | |
| 2-104 | CH(Me)CH₂SOMe | H | H | 3-Cl | 2-Me | CH₂ | Q66 | — | Ph-3-CF₃ | |
| 2-105 | CH(Me)CH₂SO₂Me | H | H | 3-Cl | 2-Me | CH₂ | Q66 | — | Ph-3-CF₃ | |
| 2-1Q6 | C(Me)₂CH₂SMe | H | H | 3-Cl | 2-Me | CH₂ | Q66 | — | Ph-3-CF₃ | |
| 2-107 | C(Me)₂CH₂SOMe | H | H | 3-Cl | 2-Me | CH₂ | Q66 | — | Ph-3-CF₃ | |
| 2-108 | C(Me)₂CH₂SO₂Me | H | H | 3-Cl | 2-Me | CH₂ | Q66 | — | Ph-3-CF₃ | |
| 2-109 | i-Pr | H | H | 3-Cl | 2-Me | CH₂ | Q66 | — | Ph-4-CF₃ | |
| 2-110 | CH(Me)CH₂SMe | H | H | 3-Cl | 2-Me | CH₂ | Q66 | — | Ph-4-CF₃ | |
| 2-111 | CH(Me)CH₂SOMe | H | H | 3-Cl | 2-Me | CH₂ | Q66 | — | Ph-4-CF₃ | |
| 2-112 | CH(Me)CH₂SO₂Me | H | H | 3-Cl | 2-Me | CH₂ | Q66 | — | Ph-4-CF₃ | |
| 2-113 | C(Me)₂CH₂SMe | H | H | 3-Cl | 2-Me | CH₂ | Q66 | — | Ph-4-CF₃ | |
| 2-114 | C(Me)₂CH₂SOMe | H | H | 3-Cl | 2-Me | CH₂ | Q66 | — | Ph-4-CF₃ | |
| 2-115 | C(Me)₂CH₂SO₂Me | H | H | 3-Cl | 2-Me | CH₂ | Q66 | — | Ph-4-CF₃ | |
| 2-116 | i-Pr | H | H | 3-Cl | 2-Me | CH₂ | Q66 | — | Ph-3,5-(CF₃)₂ | |
| 2-117 | CH(Me)CH₂SMe | H | H | 3-Cl | 2-Me | CH₂ | Q66 | — | Ph-3,5-(CF₃)₂ | 93-96 |
| 2-118 | CH(Me)CH₂SOMe | H | H | 3-Cl | 2-Me | CH₂ | Q66 | — | Ph-3,5-(CF₃)₂ | |
| 2-119 | CH(Me)CH₂SO₂Me | H | H | 3-Cl | 2-Me | CH₂ | Q66 | — | Ph-3,5-(CF₃)₂ | 108-111 |
| 2-120 | C(Me)₂CH₂SMe | H | H | 3-Cl | 2-Me | CH₂ | Q66 | — | Ph-3,5-(CF₃)₂ | 100-103 |
| 2-121 | C(Me)₂CH₂SOMe | H | H | 3-Cl | 2-Me | CH₂ | Q66 | — | Ph-3,5-(CF₃)₂ | |
| 2-122 | C(Me)₂CH₂SO₂Me | H | H | 3-Cl | 2-Me | CH₂ | Q66 | — | Ph-3,5-(CF₃)₂ | 100-105 |
| 2-123 | i-Pr | H | H | 3-Cl | 2-Me | CH₂ | Q66 | — | Ph-3-OCF₂CF₂O-4 | |
| 2-124 | i-Pr | H | H | 3-Br | 2-Me | CH₂ | Q66 | — | Ph-4-CF₃ | |
| 2-125 | CH(Me)CH₂SMe | H | H | 3-Br | 2-Me | CH₂ | Q66 | — | Ph-4-CF₃ | |
| 2-126 | CH(Me)CH₂SOMe | H | H | 3-Br | 2-Me | CH₂ | Q66 | — | Ph-4-CF₃ | |
| 2-127 | CH(Me)CH₂SC₂Me | H | H | 3-Br | 2-Me | CH₂ | Q66 | — | Ph-4-CF₃ | |
| 2-128 | C(Me)₂CH₂SMe | H | H | 3-Br | 2-Me | CH₂ | Q66 | — | Ph-4-CF₃ | |
| 2-129 | C(Me)₂CH₂SOMe | H | H | 3-Br | 2-Me | CH₂ | Q66 | — | Ph-4-CF₃ | |
| 2-130 | C(Me)₂CH₂SO₂Me | H | H | 3-Br | 2-Me | CH₂ | Q66 | — | Ph-4-CF₃ | |
| 2-131 | i-Pr | H | H | 3-Br | 2-Me | CH₂ | Q66 | — | Ph-3,5-(CF₃)₂ | |
| 2-132 | CH(Me)CH₂SMe | H | H | 3-Br | 2-Me | CH₂ | Q66 | — | Ph-3,5-(CF₃)₂ | 97-102 |
| 2-133 | CH(Me)CH₂SCMe | H | H | 3-Br | 2-Me | CH₂ | Q66 | — | Ph-3,5-(CF₃)₂ | |
| 2-134 | CH(Me)CH₂SC₂Me | H | H | 3-Br | 2-Me | CH₂ | Q66 | — | Ph-3,5-(CF₃)₂ | 145-148 |
| 2-135 | C(Me)₂CH₂SMe | H | H | 3-Br | 2-Me | CH₂ | Q66 | — | Ph-3,5-(CF₃)₂ | 90-94 |
| 2-136 | C(Me)₂CH₂SCMe | H | H | 3-Br | 2-Me | CH₂ | Q66 | — | Ph-3,5-(CF₃)₂ | |
| 2-137 | C(Me)₂CH₂SC₂Me | H | H | 3-Br | 2-Me | CH₂ | Q66 | — | Ph-3,5-(CF₃)₂ | * |
| 2-138 | C(Me)₂CH₂SMe | H | H | 3-I | 2-Me | CH₂ | Q66 | — | Ph | 9) |
| 2-139 | C(Me)₂CH₂SC₂Me | H | H | 3-I | 2-Me | CH₂ | Q66 | — | Ph | 10) |
| 2-140 | C(Me)₂CH₂SMe | H | H | 3-I | 2-Me | CH₂ | Q66 | — | Ph-2-F | 82-86 |
| 2-141 | C(Me)₂CH,SC₂Me | H | H | 3-I | 2-Me | CH₂ | Q66 | — | Ph-2-F | 128-130 |
| 2-142 | i-Pr | H | H | 3-I | 2-Me | CH₂ | Q66 | — | Ph-2-Cl | 11) |
| 2-143 | i-Pr | H | H | 3-I | H | CH₂ | Q66 | — | Ph-2-Cl | 12) |
| 2-144 | CH(Me)CH₂SMe | H | H | 3-I | 2-Me | CH₂ | Q66 | — | Ph-2-Cl | |
| 2-145 | CH(Me)CH₂SMe | H | Et | 3-I | 2-Me | CH₂ | Q66 | — | Ph-2-Cl | |
| 2-146 | CH(Me)CH₂SMe | H | i-Pr | 3-I | 2-Me | CH₂ | Q66 | — | Ph-2-Cl | |
| 2-147 | C(Me)₂CH₂SMe | H | H | 3-I | 2-Me | CH₂ | Q66 | — | Ph-2-Cl | 100-103 |
| 2-148 | C(Me)₂CH₂NHCO₂Me | H | H | 3-I | 2-Me | CH₂ | Q66 | — | Ph-2-Cl | |
| 2-149 | C(Me)₂CH═NOMe | H | H | 3-I | 2-Me | CH₂ | Q66 | — | Ph-2-Cl | |
| 2-150 | C(Me)₂CH₂SMe | H | H | 3-I | 2-Me | CH(Me) | Q66 | — | Ph-2-Cl | 101-104 |
| 2-151 | C(Me)₂CH₂SMe | H | H | 3-I | H | CH₂ | Q66 | — | Ph-2-Cl | 13) |
| 2-152 | C(Me)₂CH₂SO₂Me | H | H | 3-I | 2-Me | CH₂ | Q66 | — | Ph-2-Cl | 98-103 |
| 2-153 | C(Me)₂CH₂SMe | H | H | 3-I | 2-Me | CH₂ | Q66 | — | Ph-2-Me | 14) |
| 2-154 | C(Me)₂CH₂SO₂Me | H | H | 3-I | 2-Me | CH₂ | Q66 | — | Ph-2-Me | 180-182 |
| 2-155 | C(Me)₂CH₂SMe | H | H | 3-I | 2-Me | CH₂ | Q66 | — | Ph-2-CF₃ | 96-100 |
| 2-156 | C(Me)₂CH₂SO₂Me | H | H | 3-I | 2-Me | CH₂ | Q66 | — | Ph-2-CF₃ | 139-146 |
| 2-157 | C(Me)₂CH₂SMe | H | H | 3-I | 2-Me | CH₂ | Q66 | — | Ph-2-OMe | 93-94 |
| 2-158 | C(Me)₂CH₂SMe | H | H | 3-I | 2-Me | CH₂ | Q66 | — | Ph-2-OCF₃ | 15) |
| 2-159 | C(Me)₂CH₂SO₂Me | H | H | 3-I | 2-Me | CH₂ | Q66 | — | Ph-2-OCF₃ | 237-239 |
| 2-160 | C(Me)₂CH₂SMe | H | H | 3-I | 2-Me | CH₂ | Q66 | — | Ph-3-Cl | 79-83 |
| 2-161 | C(Me)₂CH₂SMe | H | H | 3-I | 2-Me | CH₂ | Q66 | — | Ph-3-F | 79-82 |
| 2-162 | C(Me)₂CH₂SO₂Me | H | H | 3-I | 2-Me | CH₂ | Q66 | — | Ph-3-Cl | 114-115 |
| 2-163 | C(Me)₂CH₂SO₂Me | H | H | 3-I | 2-Me | CH₂ | Q66 | — | Ph-3-F | 95-98 |
| 2-164 | Et | Et | H | 3-I | 2-Me | CH₂ | Q66 | — | Ph-3-CF₃ | |
| 2-165 | i-Pr | H | H | 3-I | 2-Me | CH₂ | Q66 | — | Ph-3-CF₃ | |
| 2-166 | CH(Me)CH₂CN | H | H | 3-I | 2-Me | CH₂ | Q66 | — | Ph-3-CF₃ | |
| 2-167 | CH(Me)CH₂CONHMe | H | H | 3-I | 2-Me | CH₂ | Q66 | — | Ph-3-CF₃ | |
| 2-168 | CH(Me)CH₂OMe | H | H | 3-I | 2-Me | CH₂ | Q66 | — | Ph-3-CF₃ | |
| 2-169 | CH(Me)CH₂SMe | H | H | 3-I | 2-Me | CH₂ | Q66 | — | Ph-3-CF₃ | 98-101 |
| 2-170 | CH(Me)CH₂SOMe | H | H | 3-I | 2-Me | CH₂ | Q66 | — | Ph-3-CF₃ | |
| 2-171 | CH(Me)CH₂SO₂Me | H | H | 3-I | 2-Me | CH₂ | Q66 | — | Ph-3-CF₃ | 101-105 |
| 2-172 | C(Me)₂CH₂SMe | H | H | 3-I | H | CH₂ | Q66 | — | Ph-3-CF₃ | 156-159 |
| 2-173 | C(Me)₂CH₂SMe | H | H | 3-I | 2-Me | CH₂ | Q66 | — | Ph-3-CF₃ | 92-93 |
| 2-174 | C(Me)₂CH₂SMe | H | H | 3-I | 2-Me | O(CH₂)₂ | Q66 | — | Ph-3-CF₃ | |
| 2-175 | C(Me)₂CH₂SOMe | H | H | 3-I | 2-Me | CH₂ | Q66 | — | Ph-3-CF₃ | |
| 2-176 | C(Me)₂CH₂SO₂Me | H | H | 3-I | 2-Me | CH₂ | Q66 | — | Ph-3-CF₃ | 99-110 |
| 2-177 | C(Me)₂CH₂SMe | H | H | 3-I | 2-Me | CH₂ | Q66 | — | Ph-3-OCHF₂ | 87-96 |
| 2-178 | C(Me)₂CH₂SO₂Me | H | H | 3-I | 2-Me | CH₂ | Q66 | — | Ph-3-OCHF₂ | 165-168 |
| 2-179 | C(Me)₂CH₂SMe | H | H | 3-I | 2-Me | CH₂ | Q66 | — | Ph-3-OCF₃ | 86-89 |
| 2-180 | C(Me)₂CH₂SO₂Me | H | H | 3-I | 2-Me | CH₂ | Q66 | — | Ph-3-OCF₃ | 170-172 |
| 2-181 | C(Me)₂CH₂SMe | H | H | 3-I | 2-Me | CH₂ | Q66 | — | Ph-4-F | 77-80 |
| 2-182 | C(Me)₂CH₂SO₂Me | H | H | 3-I | 2-Me | CH₂ | Q66 | — | Ph-4-F | 148-158 |
| 2-183 | C(Me)₂CH₂SMe | H | H | 3-I | 2-Me | CH₂ | Q66 | — | Ph-4-Cl | 78-83 |
| 2-184 | C(Me)₂CH₂SO₂Me | H | H | 3-I | 2-Me | CH₂ | Q66 | — | Ph-4-Cl | 141-143 |
| 2-185 | C(Me)₂CH₂SMe | H | H | 3-I | 2-Me | CH₂ | Q66 | — | Ph-4-Br | 185-186 |
| 2-186 | C(Me)₂CH₂SMe | H | H | 3-I | 2-Me | CH₂ | Q66 | — | Ph-4-Me | 152-159 |
| 2-187 | C(Me)₂CH₂SO₂Me | H | H | 3-I | 2-Me | CH₂ | Q66 | — | Ph-4-Me | 192-193 |
| 2-188 | C(Me)₂CH₂SMe | H | H | 3-I | 2-Me | CH₂ | Q66 | — | Ph-4-i-Pr | 89-95 |
| 2-189 | C(Me)₂CH₂SO₂Me | H | H | 3-I | 2-Me | CH₂ | Q66 | — | Ph-4-i-Pr | 194-196 |
| 2-190 | Et | Et | H | 3-I | 2-Me | CH₂ | Q66 | — | Ph-4-CF₃ | |
| 2-191 | i-Pr | H | H | 3-I | 2-Me | CH₂ | Q66 | — | Ph-4-CF₃ | 16) |
| 2-192 | i-Pr | H | H | 3-I | 2-CF₃ | CH₂ | Q66 | — | Ph-4-CF₃ | |
| 2-193 | i-Pr | H | H | 3-I | 2-Cl | CH₂ | Q66 | — | Ph-4-CF₃ | |
| 2-194 | i-Pr | H | H | 3-I | 2,3-Cl₂ | CH₂ | Q66 | — | Ph-4-CF₃ | |
| 2-195 | i-Pr | H | Me | 3-I | 2-Me | CH₂ | Q66 | — | Ph-4-CF₃ | |
| 2-196 | i-Pr | H | Et | 3-I | 2-Me | CH₂ | Q66 | — | Ph-4-CF₃ | |
| 2-197 | CH(Me)CH₂CN | H | H | 3-I | 2-Me | CH₂ | Q66 | — | Ph-4-CF₃ | |
| 2-198 | CH(Me)CH₂CONHMe | H | H | 3-I | 2-Me | CH₂ | Q66 | — | Ph-4-CF₃ | |
| 2-199 | CH(Me)CH₂CON(Et)₂ | H | H | 3-I | 2-Me | CH₂ | Q66 | — | Ph-4-CF₃ | |
| 2-200 | CH(Me)CH₂CSNHEt | H | H | 3-I | 2-Me | CH₂ | Q66 | — | Ph-4-CF₃ | |
| 2-201 | CH(Me)CH₂NHCOMe | H | H | 3-I | 2-Me | CH₂ | Q66 | — | Ph-4-CF₃ | |
| 2-202 | CH(Me)CH₂N(Me)SC₂Me | H | H | 3-I | 2-Me | CH₂ | Q66 | — | Ph-4-CF₃ | |
| 2-203 | CH(Me)CH₂OMe | H | H | 3-I | 2-Me | CH₂ | Q66 | — | Ph-4-CF₃ | |
| 2-204 | CH(Me)CH₂OEt | H | H | 3-I | 2-Me | CH₂ | Q66 | — | Ph-4-CF₃ | |
| 2-205 | CH(Me)CH₂CH₂OMe | H | H | 3-I | 2-Me | CH₂ | Q66 | — | Ph-4-CF₃ | |
| 2-206 | CH(Me)CH₂CH₂OEt | H | H | 3-I | 2-Me | CH₂ | Q66 | — | Ph-4-CF₃ | |
| 2-207 | CH(Me)CH₂OCONHEt | H | H | 3-I | 2-Me | CH₂ | Q66 | — | Ph-4-CF₃ | |
| 2-208 | CH(Me)CH₂OCONEt₂ | H | H | 3-I | 2-Me | CH₂ | Q66 | — | Ph-4-CF₃ | |
| 2-209 | CH(Me)CH₂SMe | H | H | 3-I | 2-Me | CH₂ | Q66 | — | Ph-4-CF₃ | 17) |
| 2-210 | CH(Me)CH₂SMe | H | H | 3-I | 2-Cl | CH₂ | Q66 | — | Ph-4-CF₃ | |
| 2-211 | CH(Me)CH₂SMe | H | Et | 3-I | 2-Me | CH₂ | Q66 | — | Ph-4-CF₃ | |
| 2-212 | CH(Me)CH₂SMe | H | i-Pr | 3-I | 2-Me | CH₂ | Q66 | — | Ph-4-CF₃ | |
| 2-213 | CH(Me)CH₂SCMe | H | H | 3-I | 2-Me | CH₂ | Q66 | — | Ph-4-CF₃ | |
| 2-214 | CH(Me)CH₂SC₂Me | H | H | 3-I | 2-Me | CH₂ | Q66 | — | Ph-4-CF₃ | 213-214 |
| 2-215 | CH(Me)CH₂SCONHEt | H | H | 3-I | 2-Me | CH₂ | Q66 | — | Ph-4-CF₃ | |
| 2-216 | CH(Me)CH₂SCSNHEt | H | H | 3-I | 2-Me | CH₂ | Q66 | — | Ph-4-CF₃ | |
| 2-217 | CH(Me)CH₂SO₂NHEt | H | H | 3-I | 2-Me | CH₂ | Q66 | — | Ph-4-CF₃ | |
| 2-218 | CH(Me)CH₂SO₂NEt₂ | H | H | 3-I | 2-Me | CH₂ | Q66 | — | Ph-4-CF₃ | |
| 2-219 | C(Me)₂CH₂SMe | H | H | 3-I | H | CH₂ | Q66 | — | Ph-4-CF₃ | 158-160 |
| 2-220 | C(Me)₂CH₂SMe | H | H | 3-I | 2-Me | CH₂ | Q66 | — | Ph-4-CF₃ | 83-87 |
| 2-221 | C(Me)₂CH₂SMe | H | H | 3-I | 2-Me | O(CH₂)₂ | Q66 | — | Ph-4-CF₃ | |
| 2-222 | C(Me)₂CH₂SMe | H | Et | 3-I | 2-Me | CH₂ | Q66 | — | Ph-4-CF₃ | 180-184 |
| 2-223 | C(Me)₂CH₂SMe | H | H | 3-I | 2-Cl | CH₂ | Q66 | — | Ph-4-CF₃ | 125-130 |
| 2-224 | C(Me)₂CH₂SMe | H | H | 3-I | 3-Cl | CH₂ | Q66 | — | Ph-4-CF₃ | 121-125 |
| 2-225 | C(MehCH₂SOMe | H | H | 3-I | 2-Me | CH₂ | Q66 | — | Ph-4-CF₃ | |
| 2-226 | C(Me)₂CH₂SOMe | H | H | 3-I | 2-Cl | CH₂ | Q66 | — | Ph-4-CF₃ | |
| 2-227 | C(Me)₂CH₂SC₂Me | H | H | 3-I | 2-Me | CH₂ | Q66 | — | Ph-4-CF₃ | 108-112 |
| 2-228 | C(Me)₂CH₂NHCOMe | H | H | 3-I | 2-Me | CH₂ | Q66 | — | Ph-4-CF₃ | |
| 2-229 | C(Me)₂CH₂NHCO₂Me | H | H | 3-I | 2-Me | CH₂ | Q66 | — | Ph-A-CF₃ | |
| 2-230 | C(Me)₂CH═NOMe | H | H | 3-I | 2-Me | CH₂ | Q66 | — | Ph-4-CF₃ | |
| 2-231 | C(Me)₂CH₂CH═NOMe | H | H | 3-I | 2-Me | CH₂ | Q66 | — | Ph-4-CF₃ | |
| 2-232 | C(Me)₂CH₂SC₂Me | H | H | 3-I | 2-Cl | CH₂ | Q66 | — | Ph-4-CF₂ | 159-165 |
| 2-233 | C(Me)₂CH₂SC₂Me | H | H | 3-I | H | CH₂ | Q66 | — | Ph-4-CF₃ | 161-163 |
| 2-234 | C(Me)₂CH₂SMe | H | H | 3-I | 2-Me | CH₂ | Q66 | — | Ph-4-OCF₃ | 117-119 |
| 2-235 | C(Me)₂CH₂SMe | H | H | 3-I | 2-Me | CH₂ | Q66 | — | Ph-4-SCF₃ | |
| 2-236 | C(Me)₂CH₂SC₂Me | H | H | 3-I | 2-Me | CH₂ | Q66 | — | Ph-4-SCF₃ | |
| 2-237 | C(Me)₂CH₂SMe | H | H | 3-I | 2-Me | CH₂ | Q66 | — | Ph-4-(Ph-4-CF₃) | |
| 2-238 | C(Me)₂CH₂SC₂Me | H | H | 3-I | 2-Me | CH₂ | Q66 | — | Ph-4-(Ph-4-CF₃) | |
| 2-239 | C(Me)₂CH₂SMe | H | H | 3-I | 2-Me | CH₂ | Q66 | — | Ph-4-[Ph-3,5-(CF₃)₂] | 110-117 |
| 2-240 | C(Me)₂CH₂SC₂Me | H | H | 3-I | 2-Me | CH₂ | Q66 | — | Ph-4-[Ph-3,5-(CF₃)₂] | 127-131 |
| 2-241 | C(Me)₂CH₂SMe | H | H | 3-I | 2-Me | CH₂ | Q66 | — | Ph-2-F-3-CF₃ | 107 |
| 2-242 | C(Me)₂CH₂SMe | H | H | 3-I | 2-Me | CH₂ | Q66 | — | Ph-2-F-4-Br | 80-82 |
| 2-243 | C(Me)₂CH₂SMe | H | H | 3-I | 2-Me | CH₂ | Q66 | — | Ph-3-F-5-CF₃ | 79-84 |
| 2-244 | C(Me)₂CH₂SMe | H | H | 3-I | 2-Me | CH₂ | Q66 | — | Ph-2-F-5-CF₃ | 190-194 |
| 2-245 | C(Me)₂CH₂SMe | H | H | 3-I | 2-Me | CH₂ | Q66 | — | Ph-3-Br-4-OCF₃ | 143-146 |
| 2-246 | C(Me)₂CH₂SMe | H | H | 3-I | 2-Me | CH₂ | Q66 | — | Ph-2-Cl-5-CF₃ | 97-99 |
| 2-247 | C(Me)₂CH₂SMe | H | H | 3-I | 2-Me | CH₂ | Q66 | — | Ph-3-CF₃-4-Cl | 95-99 |
| 2-248 | C(Me)₂CH₂SMe | H | H | 3-I | 2-Me | CH₂ | Q66 | — | Ph-3-Cl-4-OCF₃ | 147-149 |
| 2-249 | C(Me)₂CH₂SC₂Me | H | H | 3-I | 2-Me | CH₂ | Q66 | — | Ph-3-Cl-4-OCF₃ | 18) |
| 2-250 | C(Me)₂CH₂SMe | H | H | 3-I | 2-Me | CH₂ | Q66 | — | Ph-3-CF₃-4-F | 86-90 |
| 2-251 | C(Me)₂CH₂SC₂Me | H | H | 3-I | 2-Me | CH₂ | Q66 | — | Ph-3-CF₃-4-F | 179-189 |
| 2-252 | i-Pr | H | H | 3-I | 2-Me | CH₂ | Q66 | — | Ph-3,4-(CF₃)₂ | |
| 2-253 | C(Me)₂CH₂SMe | H | H | 3-I | 2-Me | CH₂ | Q66 | — | Ph-3,4-(CF₃)₂ | 112-118 |
| 2-254 | C(Me)₂CH₂SOMe | H | H | 3-I | 2-Me | CH₂ | Q66 | — | Ph-3,4-(CF₃)₂ | |
| 2-255 | C(Me)₂CH₂SC₂Me | H | H | 3-I | 2-Me | CH₂ | Q66 | — | Ph-3,4-(CF₃)₂ | |
| 2-256 | C(Me)₂CH₂SMe | H | H | 3-I | 2-Me | CH₂ | Q66 | — | Ph-3,5-Cl₂ | 145-147 |
| 2-257 | C(Me)₂CH₂SMe | H | H | 3-I | 2-Me | CH₂ | Q66 | — | Ph-3,5-(CMe)₂ | |
| 2-258 | C(Me)₂CH₂SMe | H | H | 3-I | 2-Me | CH₂ | Q66 | — | Ph-3-CF₃-5-F | 107-112 |
| 2-259 | Et | H | Et | 3-I | 2-Me | CH₂ | Q66 | — | Ph-3,5-(CF₃)₂ | |
| 2-260 | i-Pr | H | H | 3-I | 2-Me | CH₂ | Q66 | — | Ph-3,5-(CF₃)₂ | 195-196 |
| 2-261 | CH(Me)CH₂CN | H | H | 3-I | 2-Me | CH₂ | Q66 | — | Ph-3,5-(CF₃)₂ | |
| 2-262 | CH(Me)CH₂CONHMe | H | H | 3-I | 2-Me | CH₂ | Q66 | — | Ph-3,5-(CF₃)₂ | |
| 2-263 | CH(Me)CH₂CONEt₂ | H | H | 3-I | 2-Me | CH₂ | Q66 | — | Ph-3,5-(CF₃)₂ | |
| 2-264 | CH(Me)CH₂NHCOMe | H | H | 3-I | 2-Me | CH₂ | Q66 | — | Ph-3,5-(CF₃)₂ | |
| 2-265 | CH(Me)CH₂OMe | H | H | 3-I | 2-Me | CH₂ | Q66 | — | Ph-3~5-(CF₃)₂ | 86-89 |
| 2-266 | CH(Me)CH₂OEt | H | H | 3-I | 2-Me | CH₂ | Q66 | — | Ph-3,5-(CF₃)₂ | |
| 2-267 | CH(Me)CH₂CH₂CMe | H | H | 3-I | 2-Me | CH₂ | Q66 | — | Ph-3,5-(CF₃)₂ | |
| 2-268 | CH(Me)CH₂CH₂CEt | H | H | 3-I | 2-Me | CH₂ | Q66 | — | Ph-3,5-(CF₃)₂ | |
| 2-269 | CH(Me)CH₂OCONHEt | H | H | 3-I | 2-Me | CH₂ | Q66 | — | Ph-3,5-(CF₃)₂ | |
| 2-270 | CH(Me)CH₂SMe | H | H | 3-I | 2-Me | CH₂ | Q66 | — | Ph-3,5-(CF₃)₂ | 101-103 |
| 2-271 | CH(Me)CH₂SMe | H | Et | 3-I | 2-Me | CH₂ | Q66 | — | Ph-3,5-(CF₃)₂ | |
| 2-272 | CH(Me)CH₂SMe | H | H | 3-I | 2-Cl | CH₂ | Q66 | — | Ph-3,5-(CF₃)₂ | |
| 2-273 | CH(Me)CH₂SCMe | H | H | 3-I | 2-Me | CH₂ | Q66 | — | Ph-3,5-(CF₃)₂ | * |
| 2-274 | CH(Me)CH₂SC₂Me | H | H | 3-I | 2-Me | CH₂ | Q66 | — | Ph-3,5-(CF₃)₂ | 187-190 |
| 2-275 | C(Me)₂CH₂NHCOMe | H | H | 3-I | 2-Me | CH₂ | Q65 | — | Ph-3,5-(CF₃)₂ | |
| 2-276 | C(Me)₂CH₂NHCO₂Me | H | H | 3-I | 2-Me | CH₂ | Q66 | — | Ph-3,5-(CF₃)₂ | |
| 2-277 | C(Me)₂OH═NOMe | H | H | 3-I | 2-Me | CH₂ | Q66 | — | Ph-3,5-(CF₃)₂ | |
| 2-278 | C(Me)₂OH₂OH═NOMe | H | H | 3-I | 2-Me | CH₂ | Q66 | — | Ph-3,5-(CF₃)₂ | |
| 2-279 | C(Me)₂CH₂OCSNHMe | H | H | 3-I | 2-Me | CH₂ | Q66 | — | Ph-3,5-(CF₃)₂ | |
| 2-280 | C(Me)₂CH₂OCSNMe₂ | H | H | 3-I | 2-Me | CH₂ | Q66 | — | Ph-3,5-(CF₃)₂ | |
| 2-281 | C(Me)₂CH₂SMe | H | H | 3-I | 2-Me | CH(Me) | Q66 | — | Ph-3,5-(CF₃)₂ | 118-122 |
| 2-282 | C(Me)₂CH₂SMe | H | H | 3-I | 2-OMe | CH₂ | Q66 | — | Ph-3,5-(CF₃)₂ | 133-137 |
| 2-283 | C(Me)₂CH₂SMe | H | H | 3-I | 3-Cl | CH₂ | Q66 | — | Ph-3,5-(CF₃)₂ | 76-80 |
| 2-284 | C(Me)₂CH₂SMe | H | H | 3-I | 3-OMe | CH₂ | Q66 | — | Ph-3,5-(CF₃)₂ | 104-108 |
| 2-285 | C(Me)₂CH₂SMe | H | H | 3-I | 2,6-Me₂ | CH₂ | Q66 | — | Ph-3,5-(CF₃)₂ | 102-104 |
| 2-286 | C(Me)₂CH₂SMe | H | H | 3-I | 2-Me | CH₂ | Q66 | — | Ph-3,5-(CF₃)₂ | 115-117 |
| 2-287 | C(Me)₂CH₂SMe | H | H | 3-I | 2-Cl | CH₂ | Q66 | — | Ph-3,5-(CF₃)₂ | |
| 2-288 | C(Me)₂CH₂SMe | H | Et | 3-I | 2-Me | CH₂ | Q66 | — | Ph-3,5-(CF₃)₂ | 84-87 |
| 2-289 | C(Me)₂CH₂SOMe | H | H | 3-I | 2-Me | CH₂ | Q66 | — | Ph-3,5-(CF₃)₂ | 165-171 |
| 2-290 | C(Me)₂CH₂SOMe | H | H | 3-I | 2-Cl | CH₂ | Q66 | — | Ph-3,5-(CF₃)₂ | |
| 2-291 | C(Me)₂CH₂SO₂Me | H | H | 3-I | 2-OMe | CH₂ | Q66 | — | Ph-3,5-(CF₃)₂ | 74-78 |
| 2-292 | C(Me)₂CH₂SO₂Me | H | H | 3-I | 2,6-Me₂ | CH₂ | Q66 | — | Ph-3,5-(CF₃)₂ | 171-173 |
| 2-293 | C(Me)₂CH₂SO₂Me | H | H | 3-I | 2-Me | CH₂ | Q66 | — | Ph-3,5-(CF₃)₂ | 116-118 |
| 2-294 | C(Me)₂CH₂SO₂Me | H | H | 3-I | 2-Cl | CH₂ | Q66 | — | Ph-3,5-(CF₃)₂ | |
| 2-295 | C(Me)₂CH₂SMe | H | H | 3-I | 2-Me | CH₂ | Q66 | — | Ph-2-OMe-3-Cl-5-Me | 94-96 |
| 2-296 | C(Me)₂CH₂SO₂Me | H | H | 3-I | 2-Me | CH₂ | Q66 | — | Ph-2-OMe-3-Cl-5-Me | 152-153 |
| 2-297 | C(Me)₂CH₂SMe | H | H | 3-I | 2-Me | CH₂ | Q66 | — | Ph-2,6-Et₂-3,4-Cl₂ | 95-97 |
| 2-298 | C(Me)₂CH₂SMe | H | H | 3-I | 2-Me | CH₂ | Q66 | — | Ph-3-OCF₂O-4 | |
| 2-299 | C(Me)₂CH₂SOMe | H | H | 3-I | 2-Me | CH₂ | Q66 | — | Ph-3-OCF₂O-4 | |
| 2-300 | C(Me)₂CH₂SO₂Me | H | H | 3-I | 2-Me | CH₂ | Q68 | — | Ph-3-OCF₂O-4 | |
| 2-301 | C(Me)₂CH₂SMe | H | H | 3-I | 2-Me | CH₂ | Q66 | — | Ph-3-OCHFOF₂O-4 | |
| 2-302 | C(Me)₂CH₂SOMe | H | H | 3-I | 2-Me | CH₂ | Q66 | — | Ph-3-OCHFOF₂O-4 | |
| 2-303 | C(Me)₂CH₂SO₂Me | H | H | 3-I | 2-Me | CH₂ | Q66 | — | Ph-3-OCHFOF₂O-4 | |
| 2-304 | C(Me)₂CH₂SMe | H | H | 3-I | 2-Me | CH₂ | Q66 | — | Ph-3-OCF₂CHFO-4 | |
| 2-305 | C(Me)₂CH₂SOMe | H | H | 3-I | 2-Me | CH₂ | Q66 | — | Ph-3-OCF₂CHFO-4 | |
| 2-3Q6 | C(Me)₂CH₂SO₂Me | H | H | 3-I | 2-Me | CH₂ | Q66 | — | Ph-3-OCF₂CHFO-4 | |
| 2-307 | C(Me)₂CH₂SMe | H | H | 3-I | 2-Me | CH₂ | Q66 | — | Ph-3-OCF₂CF₂O-4 | 86-88 |
| 2-308 | C(Me)₂CH₂SOMe | H | H | 3-I | 2-Me | CH₂ | Q66 | — | Ph-3-OCF₂CF₂O-4 | |
| 2-309 | C(Me)₂CH₂SO₂Me | H | H | 3-I | 2-Me | CH₂ | Q66 | — | Ph-3-OCF₂CF₂O-4 | |
| 2-310 | C(Me)₂CH₂SMe | H | H | 3-I | 2-Me | CH₂ | Q66 | — | Ph-2-F- | 19) |
| | | | | | | | | | 4-OCF₂CF₂O-5 | |
| 2-311 | C(Me)₂CH₂SO₂Me | H | H | 3-I | 2-Me | CH₂ | Q66 | — | Ph-2-F- | 117-119 |
| | | | | | | | | | 4-OCF₂CF₂O-5 | |
| 2-312 | CH(Me)CH₂SMe | H | H | 3-I | 2-Me | CH₂ | Q66 | — | 3-pyridine | |
| 2-313 | C(Me)₂CH₂SMe | H | H | 3-I | 2-Me | CH₂ | Q66 | — | 3-pyridine | |
| 2-314 | CH(Me)CH₂SMe | H | H | 3-I | 2-Me | CH₂ | Q66 | — | 2-thiaphene | |
| 2-315 | C(Me)₂CH₂SMe | H | H | 3-I | 2-Me | CH₂ | Q66 | — | 2-(thiophene-5-Cl) | |
| 2-316 | C(Me)₂CH₂SMe | H | H | 3-Me | 2-Me | CH₂ | Q68 | — | Ph-3-CF₃ | |
| 2-317 | C(Me)₂CH₂SMe | H | H | 3-Me | 2-Me | CH₂ | Q66 | — | Ph-4-CF₃ | |
| 2-318 | C(Me)₂CH₂SMe | H | H | 3-Me | 2-Me | CH₂ | Q66 | — | Ph-3,5-(CF₃)₂ | 166-173 |
| 2-319 | i-Pr | H | H | 3-CN | 2-Me | CH₂ | Q66 | — | Ph-3-CF₃ | |
| 2-320 | i-Pr | H | H | 3-CF₃ | 2-Me | CH₂ | Q66 | — | Ph-3-CF₃ | |
| 2-321 | i-Pr | H | H | 3-NHSO₂Me | 2-Me | CH₂ | Q66 | — | Ph-3-CF₃ | |
| 2-322 | i-Pr | H | H | 3-N(SO₂Me)₂ | 2-Me | CH₂ | Q66 | — | Ph-3-CF₃ | |
| 2-323 | i-Pr | H | H | 3-NO₂ | 2-Me | CH₂ | Q66 | — | Ph-4-CF₃ | 20) |
| 2-324 | i-Pr | H | H | 3-NO₂ | 2-Me | CH₂ | Q66 | — | Ph-3,5-(CF₃)₂ | |
| 2-325 | C(Me)₂CH₂SMe | H | H | 3-NO₂ | 2-Me | CH₂ | Q66 | — | Ph-3,5-(CF₃)₂ | |
| 2-326 | C(Me)₂CH₂SMe | H | H | 3-OSO₂Me | 2-Me | CH₂ | Q66 | — | Ph | 150-154 |
| 2-327 | C(Me)₂CH₂SO₂Me | H | H | 3-OSO₂Me | 2-Me | CH₂ | Q66 | — | Ph | 21) |
| 2-328 | i-Pr | H | H | 3-OSO₂Me | H | CH₂ | Q66 | — | Ph-2-Cl | 22) |
| 2-329 | C(Me)₂CH₂SMe | H | H | 3-OSO₂Me | 2-Me | CH₂ | Q66 | — | Ph-2-Cl | 94-104 |
| 2-330 | C(Me)₂CH₂SO₂Me | H | H | 3-OSO₂Me | 2-Me | CH₂ | Q66 | — | Ph-2-Cl | 23) |
| 2-331 | C(Me)₂CH₂SMe | H | H | 3-OSO₂Me | 2-Me | CH₂ | Q66 | — | Ph-3-Cl | 24) |
| 2-332 | C(Me)₂CH₂SMe | H | H | 3-OSO₂CF₃ | 2-Me | CH₂ | Q66 | — | Ph-3-Cl | |
| 2-333 | C(Me)₂CH₂SMe | H | H | 3-OSO₂Me | 2-Me | CH₂ | Q66 | — | Ph-3-CF₃ | 115-119 |
| 2-334 | C(Me)₂CH₂SO₂Me | H | H | 3-OSO₂Me | 2-Me | CH₂ | Q66 | — | Ph-3-CF₃ | 170-179 |
| 2-335 | C(Me)₂CH₂SMe | H | H | 3-OSO₂Me | 2-Me | CH₂ | Q66 | — | Ph-4-Cl | 25) |
| 2-336 | C(Me)₂CH₂SO₂Me | H | H | 3-OSO₂Me | 2-Me | CH₂ | Q66 | — | Ph-4-Cl | 26) |
| 2-337 | C(Me)₂CH₂SMe | H | H | 3-OSO₂Me | 2-Me | CH₂ | Q66 | — | Ph-4-CF₃ | 151-153 |
| 2-338 | C(Me)₂CH₂SMe | H | H | 3-OSO₂Me | 2-Me | CH₂ | Q66 | — | Ph-3,5-(CF₃₎₂ | 86-88 |
| 2-339 | C(Me)₂CH₂SO₂Me | H | H | 3-OSO₂Me | 2-Me | CH₂ | Q66 | — | Ph-3,5-(CF₃₎₂ | 184-185 |
| 2-340 | C(Me)₂CH₂SMe | H | H | 3-OSO₂CF₃ | 2-Me | CH₂ | Q66 | — | Ph-4-CF₃ | |
| 2-341 | C(Me)₂CH₂SMe | H | H | 4-Me | 2-Me | CH₂ | Q66 | — | Ph-4-CF₃ | |
| 2-342 | C(Me)₂CH₂SMe | H | H | 4-Me | 2-Me | CH₂ | Q66 | — | Ph-3,5-(CF₃)₂ | 154-156 |
| 2-343 | i-Pr | H | H | 4-NO₂ | 2-Me | CH₂ | Q66 | — | Ph-4-CF₃ | 143-148 |
| 2-344 | C(Me)₂CH₂SMe | H | H | 4-NO₂ | 2-Me | CH₂ | Q66 | — | Ph-3,5-(CF₃)₂ | |
| 2-345 | C(Me)₂CH₂SMe | H | H | 6-Me | 2-Me | CH₂ | Q66 | — | Ph-3,5-(CF₃)₂ | 160-164 |
| 2-346 | C(Me)₂CH₂SMe | H | H | 6-I | 2-Me | CH₂ | Q66 | — | Ph-4-CF₃ | 218-220 |
| 2-347 | C(Me)₂CH₂SMe | H | H | 3,6-Cl₂ | 2-Me | CH₂ | Q66 | — | Ph-a-CF₃ | |
| 2-348 | C(Me)₂CH₂SMe | H | H | 3,6-Cl₂ | 2-Me | CH₂ | Q66 | — | Ph-4-CF₃ | |
| 2-349 | C(Me)₂CH₂SMe | H | H | 3,6-Cl₂ | 2-Me | CH₂ | Q66 | — | Ph-3,5-(CF₃)₂ | |
| 2-350 | C(Me)₂CH₂SMe | H | H | 4,5-Cl₂ | 2-Me | CH₂ | Q66 | — | Ph-3,5-(CF₃)₂ | >250 |
| 2-351 | C(Me)₂CH₂SO₂Me | H | H | 4,5-Cl₂ | 2-Me | CH₂ | Q66 | — | Ph-3,5-(CF₃)₂ | 189-188 |
| 2-352 | C(Me)₂CH₂SMe | H | H | 3,4,5,6-Cl₄ | 2-Me | CH₂ | Q66 | — | Ph-3-CF₃ | |
| 2-353 | C(Me)₂CH₂SMe | H | H | 3,4,5,6-Cl₄ | 2-Me | CH₂ | Q66 | — | Ph-4-CF₃ | |
| 2-354 | C(Me)₂CH₂SMe | H | H | 3,4,5,6-Cl₄ | 2-Me | CH₂ | Q66 | — | Ph-3,5-(CF₃)₂ | 209 |
| 2-355 | C(Me)₂CH₂SO₂Me | H | H | 3,4,5,6-Cl₄ | 2-Me | CH₂ | Q66 | — | Ph-3,5-(CF₃)₂ | |
| 2-356 | C(Me)₂CH₂SMe | H | H | 3,4,5,6-Br₄ | 2-Me | CH₂ | Q66 | — | Ph-3,5-(CF₃)₂ | 209-210 |
| 2-357 | C(Me)₂CH₂SMe | H | H | 4-C(Me)₃ | 2-Me | CH₂ | Q66 | — | Ph-3,5-(CF₃)₂ | 157-164 |
| 2-358 | C(Me)₂CH₂SMe | H | H | 3-I | 2-Me | CH₂ | Q69-1 | — | Ph-4-CF₃ | |
| 2-359 | CH(Me)CH₂SMe | H | H | 3-Cl | 2-Me | CH₂ | Q66 | — | Ph-3,5-(CF₃)₂ | 98-102 |
| | (S)-isomer | | | | | | | | | |
| 2-360 | C(Me)₂CH₂SO₂Me | H | H | 3,4,5-6,Br₄ | 2-Me | CH₂ | Q66 | — | Ph-3,5-(CF₃)₂ | 192-195 |
| 2-361 | CH(Me)CH₂SMe | H | H | H | 2-Me | CH₂ | Q66 | — | Ph-3,5-(CF₃)₂ | 137-140 |
| | (S)-isomer | | | | | | | | | |
| 2-362 | CH(Me)CH₂SO₂Me | H | H | H | 2-Me | CH₂ | Q66 | — | Ph-3,5-(CF₃)₂ | 186-188 |
| | (S)-isomer | | | | | | | | | |
| 2-363 | CH(Me)CH₂SMe | H | H | H | 2-Me | CH₂ | Q66 | — | Ph-3-CF₃ | 160-163 |
| 2-364 | CH(Me)CH₂SO₂Me | H | H | H | 2-Me | CH₂ | Q66 | — | Ph-3-CF₃ | 174-175 |
| 2-365 | CH(Me)CH₂SEt | H | H | H | 2-Me | CH₂ | Q66 | — | Ph-a-CF₃ | 142-144 |
| | (S)-isomer | | | | | | | | | |
| 2-366 | CH(Me)CH₂SO₂Et | H | H | H | 2-Me | CH₂ | Q66 | — | Ph-3-CF₃ | 123-129 |
| | (S)-isomer | | | | | | | | | |
| 2-367 | CH(Me)CH₂SEt | H | H | H | 2-Me | CH₂ | Q66 | — | Ph-4-CF₃ | 158-159 |
| | (S)-isomer | | | | | | | | | |
| 2-368 | CH(Me)CH₂SO₂Et | H | H | H | 2-Me | CH₂ | Q66 | — | Ph-4-CF₃ | 192-195 |
| | (S)-isomer | | | | | | | | | |
| 2-369 | CH(Me)CH₂SEt | H | H | H | 2-Me | CH₂ | Q66 | — | Ph-3,5-(CF₃)₂ | 144-150 |
| | (S)-isomer | | | | | | | | | |
| 2-370 | CH(Me)CH₂SO₂Et | H | H | H | 2-Me | CH₂ | Q66 | — | Ph-3,5-(CF₃)₂ | 185-187 |
| | (S)-isomer | | | | | | | | | |
| 2-371 | C(Me)₂CH₂SO₂Me | H | H | 3-I | 2-Me | CH₂ | Q55-1 | — | Ph-3,5-(CF₃)₂ | 231-232 |
| 2-372 | CH(Me)CH₂SMe | H | H | 3-I | 2-Me | CH₂ | Q66 | — | Ph-3,5-(CF₃)₂ | 160-169 |
| | (S)-isomer | | | | | | | | | |
| 2-373 | CH(Me)CH₂SMe | H | H | 3-I | 2-Me | CH₂ | Q66 | — | Ph-3,5-(CF₃)₂ | 104-109 |
| | (R)-isomer | | | | | | | | | |
| 2-374 | CH₂CH₂SMe | H | H | 3-I | 2-Me | CH₂ | Q66 | — | Ph-3,5-(CF₃)₂ | 196-199 |
| 2-375 | CH₂CH₂SEt | H | H | 3-I | 2-Me | CH₂ | Q66 | — | Ph-3,5-(CF₃)₂ | 179-183 |
| 2-376 | C(Me)₂CH₂SO₂Et | H | H | 3-I | 2-Me | CH₂ | Q66 | — | Ph-3-NO₂ | 98-100 |
| 2-377 | CH(Me)CH₂SO₂Me | H | H | 3-I | 2-Me | CH₂ | Q66 | — | Ph-3,5-(CF₃)₂ | 193-195 |
| | (S)-isomer | | | | | | | | | |
| 2-378 | CH(Me)CH₂SO₂Me | H | H | 3-I | 2-Me | CH₂ | Q66 | — | Ph-3,5-(CF₃)₂ | 178-187 |
| | (R)-isomer | | | | | | | | | |
| 2-379 | C(Me)₂CH₂SMe | H | H | 3-I | 2-Me | CH₂ | Q64-6 | — | Ph-3,5-(CF₃)₂ | 104-111 |
| 2-380 | C(Me)₂CH₂SMe | H | H | 3-I | 2-Me | CH₂ | Q55-1 | — | Ph-3-CF₃ | 92-98 |
| 2-381 | C(Me)₂CH₂SO₂Me | H | H | 3-I | 2-Me | CH₂ | Q55-1 | — | Ph-3-CF₃ | 183-184 |
| 2-382 | C(Me)₂CH₂SMe | H | H | 3-I | 2-Me | CH₂ | Q41-1 | — | Ph | 94-96 |
| 2-384 | CH(Me)CH₂SEt | H | H | 3-I | 2-Me | CH₂ | Q66 | — | Ph-3-CF₃ | 77-82 |
| | (S)-isomer | | | | | | | | | |
| 2-385 | CH(Me)CH₂SO₂Et | H | H | 3-I | 2-Me | CH₂ | Q66 | — | Ph-3-CF₃ | 118-127 |
| | (S)-isomer | | | | | | | | | |
| 2-386 | CH(Me)CH₂SEt | H | H | 3-I | 2-Me | CH₂ | Q66 | — | Ph-4-CF₃ | 182-185 |
| | (S)-isomer | | | | | | | | | |
| 2-387 | CH(Me)CH₂SO₂Et | H | H | 3-I | 2-Me | CH₂ | Q66 | — | Ph-4-CF₃ | 204-207 |
| | (S)-isomer | | | | | | | | | |
| 2-388 | CH(Me)CH₂SEt | H | H | 3-I | 2-Me | CH₂ | Q66 | — | Ph-3,5-(CF₃)₂ | 194-196 |
| | (S)-isomer | | | | | | | | | |
| 2-389 | CH(Me)CH₂SO₂Et | H | H | 3-I | 2-Me | CH₂ | Q66 | — | Ph-3,5-(CF₃)₂ | 222-223 |
| | (S)-isomer | | | | | | | | | |
| 2-390 | CH(Me)CH₂SCH₂Et | H | H | 3-I | 2-Me | CH₂ | Q66 | — | Ph-3,5-(CF₃)₂ | 91-95 |
| | (S)-isomer | | | | | | | | | |
| 2-391 | CH(Me)CH₂SO₂n-Pr | H | H | 3-I | 2-Me | CH₂ | Q66 | — | Ph-3,5-(CF₃)₂ | 189-190 |
| | (S)-isomer | | | | | | | | | |
| 2-392 | CH(Et)CH₂SMe | H | H | 3-I | 2-Me | CH₂ | Q66 | — | Ph-3,5-(CF₃)₂ | 189-191 |
| 2-393 | cyclhexyl-2-SMe | H | H | 3-I | 2-Me | CH₂ | Q66 | — | Ph-3,5-(CF₃)₂ | 169-173 |
| 2-394 | C(Me)₂CH₂SMe | H | H | 3-I | 2-Me | CH₂ | Q41-1 | — | Ph-3,5-(CF₃)₂ | 101-106 |
| 2-395 | C(Me)₂CH₂SMe | H | H | 3-I | 2-Me | CH₂ | Q15-1 | — | Ph-3,5-(CF₃)₂ | 89-91 |
| 2-398 | C(Me)₂CH₂SMe | H | H | 3-I | 2-Me | CH₂ | Q64-2 | — | Ph-3,5-(CF₃)₂ | 116-119 |
| 2-397 | C(Me)₃ | H | H | 3-I | 2-Me | CH₂ | Q66 | — | Ph-3,5-(CF₃)₂ | 141-144 |
| 2-398 | cyclopentyl-1-CH₂SMe | H | H | 3-I | 2-Me | CH₂ | Q66 | — | Ph-3,5-(CF₃)₂ | 186-187 |
| 2-399 | CH₂CH(Me)SMe | H | H | 3-I | 2-Me | CH₂ | Q66 | — | Ph-3,5-(CF₃)₂ | 103-107 |
| 2-400 | C(Me)₂CH₂SO₂Me | H | H | 3-NO₂ | 2-Me | CH₂ | Q66 | — | Ph-3,5-(CF₃)₂ | 182-185 |
| 2-401 | CH(Me)CH₂SMe | H | H | 3-OSO₂Me | 2-Me | CH₂ | Q66 | — | Ph-3,5-(CF₃)₂ | 88-94 |
| 2-402 | CH(Me)CH₂SMe | H | H | 3-OSO₂CF₃ | 2-Me | CH₂ | Q66 | — | Ph-3,5-(CF₃)₂ | 87-94 |
| 2-403 | CH(Me)CH₂SMe | H | H | 3-OSO₂Et | 2-Me | CH₂ | Q66 | — | Ph-3,5-(CF₃)₂ | 88-94 |
| 2-404 | CH(Me)CH₂SMe | H | H | 3-OSO₂Ph | 2-Me | CH₂ | Q66 | — | Ph-3,5-(CF₃)₂ | 89-91 |
| 2-405 | CH(Me)CH₂SMe | H | H | 3-OCO-Me | 2-Me | CH₂ | Q66 | — | Ph-3,5-(CF₃)₂ | 76-80 |
| 2-4Q6 | C(Me)₂CH₂SMe | H | H | 3-I | 2-Me | CH₂ | Q64-6 | — | Ph-2-Cl | 111-114 |
| 2-407 | C(Me)₂CH₂SO₂Me | H | H | 3-I | 2-Me | CH₂ | Q64-6 | — | Ph-2-Cl | 27) |
| 2-408 | C(Me)₂CH₂SMe | H | H | 3-I | 2-Me | (CH₂)₂ | Q66 | — | Ph-3.5-(CF₃)₂ | 111-120 |
| 2-409 | CH(Me)CH₂SMe | H | H | 3-I | 2-Me | CH₂ | Q66 | — | Ph-3,5-(CF3)₂ | 105-108 |
| 2-410 | CH(Me)CH₂SO₂Me | H | H | 3-I | 2-Me | CH₂ | Q66 | — | Ph-3,5-(CF3)₂ | 119-121 |
| 2-411 | CH(Me)CH₂SO₂Me | H | H | 3-I | 2-Me | CH₂ | Q48-1 | — | Ph-3,5-(CF₃)₂ | 199-202 |
| 2-412 | CH(Me)CH₂SMe | H | H | 3-I | 2-Me | CH₂ | Q54 | — | Ph-3,5-(CF₃)₂ | 213-214 |
| 2-413 | C(Me)₂CH₂SMe | H | Et | 3-I | 2-Me | CH₂ | Q66 | — | Ph-3-CF₃ | 121-123 |
| 2-414 | C(Me)₂CH₂SO₂Me | H | Et | 3-I | 2-Me | CH₂ | Q66 | — | Ph-3-CF₃ | 98-101 |
| 2-415 | C(Me)₂CH₂SO₂Me | H | Et | 3-I | 2-Me | CH₂ | Q66 | — | Ph-4-CF₃ | 112-115 |
| 2-416 | C(Me)₂CH₂SO₂Me | H | Et | 3-I | 2-Me | CH₂ | Q66 | — | Ph-3,5-(CF₃)₂ | 99-102 |
| 2-417 | C(Me)₂CF₃ | H | H | 3-I | 2-Me | CH₂ | Q55-1 | — | Ph-3,5-(CF₃)₂ | 174-177 |
| 2-418 | CH_{2CH}₂CH₂CF₃ | H | H | 3-I | 2-Me | CH₂ | Q55-1 | — | Ph-3,5-(CF₃)₂ | 184-185 |
| 2-419 | CH(Me)CF₃ | H | H | 3-I | 2-Me | CH₂ | Q55-1 | — | Ph-3,5-(CF₃)₂ | >250 |
| 2-420 | CH₂CF₂CF₃ | H | H | 3-I | 2-Me | CH₂ | Q55-1 | — | Ph-3,5-(CF₃)₂ | 220-221 |

1) ¹H-NMR (CDCl₃, ppm): 1.4 (6H, s), 1.9 (3H, s), 2.3 (3H, s), 2.8 (2H, s), 5.7 (2H, s), 6.0 (1H, s), 7.0-8.3 (11H, m)
2) ¹H-NMR (CDCl₃, ppm): 1.4 (6H, s), 2.0 (3H, s), 2.2 (3H, s), 2.9 (2H, s), 4.8 (2H, s), 6.3 (1H, d), 6.4 (1H, s), 6.6 (1H, d), 7.0-8.5 (11H, m)
3) ¹H-NMR (ODCl₃, ppm): 1.4 (6H, s), 2.0 (3H, s), 2.3 (3H, s), 2.8 (2H, s), 3.9 (2H, s), 4.6 (2H, s), 6.1 (1H, s), 7.0-8.4 (11H, m)
4) ¹H-NMR (ODCl₃, ppm): 1.4 (6H, s), 2.0 (3H, s), 2.2 (3H, s), 2.9 (2H, s), 4.8 (2H, s), 6.1 (1H, s), 7.1-8.4 (12H, m)
5) ¹H-NMR (CDCl₃, ppm): 1.6 (6H, s), 2.2 (3H, s), 2.6 (3H, s), 3.5 (2H, s), 4.9 (2H, s), 6.2 (1H, s), 7.1-8.2 (12H, m)
6) ¹H-NMR (CDCl₃, ppm): 1.6 (6H, s), 2.3 (3H, s), 2.6 (3H, s), 3.3 (3H, s), 3.6 (2H, s), 4.9 (2H, s), 6.8 (1H, s), 7.1-8.1 (12H, m)
7) ¹H-NMR (CDCl₃, ppm): 1.2 (6H, d), 2.3 (3H, s), 4.2 (1H, m), 5.1 (2H, s), 6.0 (1H, m), 7.2-8.6 (12H, m)
8) ¹H-NMR (CDCl₃, ppm): 1.4 (6H, s), 2.1 (3H, s), 2.3 (3H, s), 3.0 (2H, s), 5.1 (2H, s), 6.1 (1H, s), 7.2-8.9 (12H, m)
9) ¹H-NMR (CDCl₃, ppm): 1.4 (6H, s), 2.0 (3H, s), 2.3 (3H, s), 2.9 (2H, s), 5.1 (2H, s), 6.1 (1H, s), 7.2-8.3 (12H, m)
10) ¹H-NMR (CDCl₃, ppm): 1.7 (6H, s), 2.3 (3H, s), 2.6 (3H, s), 3.5 (2H, s), 5.1 (2H, s), 6.2 (1H, s), 7.0-8.2 (12H, m)
11) ¹H-NMR (DMSO-d₆, ppm): 1.0 (6H, d), 2.2 (3H, s), 4.0 (1H, m), 5.1 (2H, a), 7.0-8.2 (11H, m), 9.4 (1H, s)
12) ¹H-NMR (CDCl₃, ppm): 1.1 (6H, d), 4.1 (1H, m), 5.1 (2H, s), 5.9 (1H, d), 7.0-8.0 (11H, m), 8.9 (1H, s)
13) ¹H-NMR (CDCl₃, ppm): 1.4 (6H, s), 2.0 (3H, s), 2.9 (2H, s), 5.1 (2H, s), 6.1 (1H, s), 7.0-8.0 (11H, m), 8.9 (1H, s)
14) ¹H-NMR (CDCl₃, ppm): 1.4 (6H, s), 2.0 (3H, s), 2.2 (3H, s), 2.3 (3H, s), 2.9 (2H, s), 5.1 (2H, s), 6.0 (1H, s), 7.1-8.3 (11H, m)
15) ¹H-NMR (CDCl₃, ppm): 1.4 (6H, s), 2.0 (3H, s), 2.3 (3H, s), 2.9 (2H, s), 5.1 (2H, s), 6.1 (1H, s), 7.0-8.4 (11H, m)
16) ¹H-NMR (CDCl₃, ppm): 1.1 (6H, d), 2.3 (3H, s), 4.1 (1H, m), 5.1 (2H, s), 5.9 (1H, m), 7.1-8.3 (11H, m)
17) ¹H-NMR (CDCl₃, ppm): 1.2 (3H, d), 2.0 (3H, s), 2.3 (3H, s), 2.7 (2H, dd), 4.1 (1H, m), 5.1 (2H, s), 6.1 (1H, d), 7.1-8.3 (11H, m)
18) ¹H-NMR (CDCl₃, ppm): 1.6 (6H, s), 2.2 (3H, s), 2.6 (3H, s), 3.5 (2H, s), 5.1 (2H, s), 6.2 (1H, s), 7.1-8.1 (10H, m)
19) ¹H-NMR (CDCl₃, ppm): 1.4 (6H, s), 2.0 (3H, s), 2.3 (3H, s), 2.8 (2H, s), 5.1 (2H, s), 6.1 (1H, s), 7.0-8.4 (9H, m)
20) ¹H-NMR (CDCl₃, ppm): 1.1 (6H, d), 2.3 (3H, s), 4.2 (1H, m), 5.1 (2H, s), 5.9 (1H, m), 7.2-8.3 (11H,m)
21) ¹H-NMR (CDCl₃, ppm): 1.6 (6H, s), 2.2 (3H, s), 2.6 (3H, s), 3.2 (3H, s), 3.5 (2H, s), 5.1 (2H, s), 6.7 (1H, s), 7.2-8.0 (12H, m)
22) ¹H-NMR (CDCl₃, ppm): 1.1 (6H, d), 3.2 (3H, s), 4.1 (1H, m), 5.1 (2H, s), 6.2 (1H, d), 7.3-7.9
23) ¹H-NMR (CDCl₃, ppm): 1.6 (6H, s), 2.3 (3H, s), 2.6 (3H, s), 3.2 (3H, s), 3.6 (2H, s), 5.1 (2H, s), 6.7 (1H, s), 7.2-8.1 (11H, m)
24) ¹H-NMR (CDCl₃, ppm): 1.3 (6H, s), 2.0 (3H, s), 2.3 (3H, s), 2.9 (2H, s), 3.3 (3H, s), 5.1 (2H, s), 6.6 (1H, s), 7.2-8.5 (11H, m)
25) ¹H-NMR (CDCl₃, ppm): 1.4 (6H, s), 1.9 (3H, s), 2.3 (3H, s), 2.9 (2H, s), 3.2 (3H, s), 5.1 (2H, s), 6.3 (1H, s), 7.2-8.3 (11H, m)
26) ¹H-NMR (CDCl₃, ppm): 1.6 (6H, s), 2.3 (3H, s), 2.6 (3H, s), 3.3 (3H, s), 3.7 (2H, s), 5.1 (2H, s), 6.8 (1H, s), 7.2-8.1 (11H, m)
27) ¹H-NMR (CDCl₃, ppm): 1.6 (6H, s), 2.3 (3H, s), 2.6 (3H, s), 3.5 (2H, d), 5.0 (2H, s), 6.4 (1H, s), 7.1-8.2 (11H, m)

TABLE 3

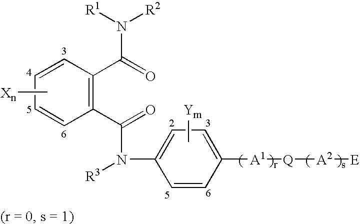

Q represents the following structures:

| | | |
|---|---|---|
| 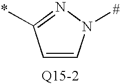 | 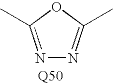 | 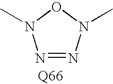 |

(wherein the bond marked with * connects with A1 and the bond marked with # connects
with A²)

| Comp. | | | | | | | | | | m.p. |
|---|---|---|---|---|---|---|---|---|---|---|
| No. | R¹ | R² | R³ | Xₙ | Yₘ | A¹ | Q | A² | E | (° C.) |
| 3-1 | C(Me)₂CH₂SMe | H | H | H | 2-Me | — | Q15-2 | CH₂ | Ph-4-CF₃ | |
| 3-2 | C(Me)₂CH₂SMe | H | H | H | 2-Me | — | Q66 | CH₂ | Ph | |
| 3-3 | C(Me)₂CH₂SMe | H | H | H | 2-Me | — | Q66 | CH₂CH₂ | Ph-4-Cl | |
| 3-4 | C(Me)₂CH₂SMe | H | H | H | 2-Me | — | Q66 | CH₂CH₂CH₂ | Ph-4-Cl | |
| 3-5 | C(Me)₂CH₂SMe | H | H | H | 2-Me | — | Q66 | CH₂CH═CH | Ph | |
| 3-6 | C(Me)₂CH₂SMe | H | H | 3-I | 2-Me | — | Q66 | CH₂ | Ph-3-CF₃ | 126-131 |
| 3-7 | C(Me)₂CH₂SMe | H | H | 3-I | 2-Me | — | Q66 | CH₂ | Ph-4-CF₃ | 131-136 |
| 3-8 | C(Me)₂CH₂SMe | H | H | 3-I | 2-Me | — | Q66 | CH₂ | Ph-3-OCHF₂ | 117-119 |
| 3-9 | C(Me)₂CH₂SO₂Me | H | H | 3-I | 2-Me | — | Q66 | CH₂ | Ph-3-CF₃ | |
| 3-10 | C(Me)₂CH₂SO₂Me | H | H | 3-I | 2-Me | — | Q66 | CH₂ | Ph-3-OCHF₂ | |
| 3-11 | C(Me)₂CH₂SO₂Me | H | H | 3-I | 2-Me | — | Q66 | CH₂ | Ph-4-CF₃ | |
| 3-12 | CH(Me)CH₂SMe | H | H | 3-I | 2-Me | — | Q50 | CH₂ | Ph-3,5-(CF₃)₂ | 212-214 |

TABLE 4

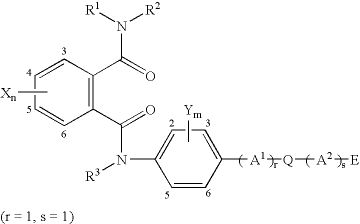

Q represents the following structures:

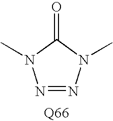

| Comp. | | | | | | | | | | m.p. |
|---|---|---|---|---|---|---|---|---|---|---|
| No. | R¹ | R² | R³ | Xₙ | Yₘ | A¹ | Q | A² | E | (° C.) |
| 4-1 | CH(CH₃)₂ | H | H | 3-I | 2-Me | CH₂ | Q66 | CH₂ | Ph | 99-103 |
| 4-2 | C(Me)₂CH₂SMe | H | H | 3-I | 2-Me | CH₂ | Q66 | CH₂ | Ph | 85-91 |
| 4-3 | C(Me)₂CH₂SMe | H | H | 3-I | 2-Me | CH₂ | Q66 | CH₂ | Ph-4-CF₃ | 90-96 |
| 4-4 | C(Me)₂CH₂SO₂Me | H | H | 3-I | 2-Me | CH₂ | Q66 | CH₂ | Ph-4-CF₃ | 111-115 |
| 4-5 | C(Me)₂CH₂SMe | H | H | 3-I | 2-Me | CH₂ | Q66 | CH(Me) | Ph-2-F | 113-119 |
| 4-6 | C(Me)₂CH₂SMe | H | H | 3-I | 2-Me | CH₂ | Q66 | CH(Me) | Ph-2-Cl | 114-118 |
| 4-7 | C(Me)₂CH₂SO₂Me | H | H | 3-I | 2-Me | CH₂ | Q66 | CH(Me) | Ph-2-Cl | 202-206 |
| 4-8 | C(Me)₂CH₂SMe | H | H | 3-I | 2-Me | CH₂ | Q66 | CH(Me) | Ph-2-CF₃ | 104-107 |
| 4-9 | C(Me)₂CH₂SMe | H | H | 3-I | 2-Me | CH₂ | Q66 | CH(Me) | Ph-3-F | 88-94 |
| 4-10 | C(Me)₂CH₂SMe | H | H | 3-I | 2-Me | CH₂ | Q66 | CH(Me) | Ph-3-Cl | 83-86 |
| 4-11 | C(Me)₂CH₂SMe | H | H | 3-I | 2-Me | CH₂ | Q66 | CH(Me) | Ph-3-CF₃ | 72-77 |
| 4-12 | C(Me)₂CH₂SO₂Me | H | H | 3-I | 2-Me | CH₂ | Q66 | CH(Me) | Ph-3-CF₃ | * |
| 4-13 | C(Me)₂CH₂SMe | H | H | 3-I | 2-Me | CH₂ | Q66 | CH(Me) | Ph-4-F | 92-98 |
| 4-14 | C(Me)₂CH₂SMe | H | H | 3-I | 2-Me | CH₂ | Q66 | CH(Me) | Ph-4-CF₃ | 85-89 |
| 4-15 | C(Me)₂CH₂SO₂Me | H | H | 3-I | 2-Me | CH₂ | Q66 | CH(Me) | Ph-4-CF₃ | 111-115 |
| 4-16 | C(Me)₂CH₂SMe | H | H | 3-I | 2-Me | CH₂ | Q66 | CH(Me) | Ph-2,4-F₂ | 75-78 |
| 4-17 | C(Me)₂CH₂SMe | H | H | 3-I | 2-Me | CH₂ | Q66 | CH(Me) | Ph-2,4-Cl₂ | 136-139 |
| 4-18 | C(Me)₂CH₂SO₂Me | H | H | 3-I | 2-Me | CH₂ | Q66 | CH(Me) | Ph-2,4-Cl₂ | 182-187 |
| 4-19 | C(Me)₂CH₂SMe | H | H | 3-I | 2-Me | CH₂ | Q66 | CH(Me) | Ph-3,4-F₂ | 87-93 |
| 4-20 | C(Me)₂CH₂SO₂Me | H | H | 3-I | 2-Me | CH₂ | Q66 | CH(Me) | Ph-3,4-F₂ | 100-108 |

* ¹H-NMR (CDCl₃, ppm): 1.6 (6H, s), 1.9 (3H, d), 2.3 (3H, s), 2.5 (3H, s), 3.5 (2H, s), 5.0 (2H, s), 5.5 (1H, q), 6.3 (1H, s), 7.0-8.1 (11H, m)

### Synthesis Example 5

### Starting Material Synthesis

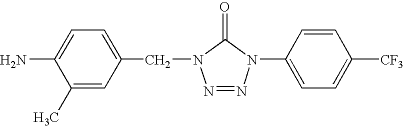

To an ethanol solution (100 mL) of 1-(3-methyl-4-nitrobenzyl) (4-trifluoromethylphenyl)-1,4-dihydrotetrazol-5-one (9.48 g) 10% palladium carbon (0.25 g) was added and the mixture was stirred under hydrogen atmosphere at room temperature for 6 hours. After finishing the reaction, palladium carbon was filtered off and the solvent was distilled off under reduced pressure to obtain 1-(4-amino-3-methyl-benzyl)-4-(4-trifluoromethyl-phenyl)-1,4-dihydrotetrazol-5-one (8.11 g, mp. 210-211° C.).

### Synthesis Example 6

### Starting Material Synthesis

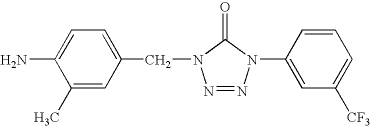

In a similar manner as Synthesis Example 5, by using 1-(3-methyl-4-nitro-benzyl)-4-(3-trifluoromethyl-phenyl)-1,4-dihydrotetrazol-5-one, 1-(4-amino-3-methyl-benzyl)-4-(3-trifluoromethyl-phenyl)-1,4-dihydrotetrazol-5-one was obtained (mp. 89-94° C.).

### Synthesis Example 7

### Starting Material Synthesis

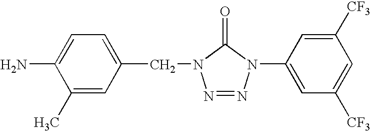

In a similar manner as Synthesis Example 5, by using 1-(3,5-bis-trifluoromethyl-phenyl)-4-(3-methyl-4-nitro-benzyl)-1,4-dihydro-tetrazol-5-one, 1-(4-amino-3-methyl-benzyl)-4-(3,5-bis-trifluoromethyl-phenyl)-1,4-dihydro-tetrazol-5-one was obtained (mp. 129-130° C.).

### Synthesis Example 8

### Starting Material Synthesis

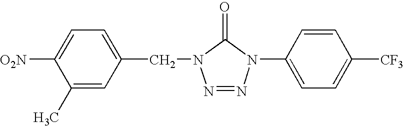

3-Methyl-4-nitrobenzyl chloride (1.6 g), 1-(4-trifluoromethylphenyl)-1,4-dihydrotetrazol-5-one (2.0 g) and potassium carbonate (1.4 g) were stirred in DMF (50 ml) at room temperature for 5 hours. After finishing the reaction, water (100 ml) was added and the mixture was extracted with ethyl acetate. The organic layer was washed with a saturated aqueous solution of sodium chloride (100 ml) and dried with magnesium sulfate. After the solvent was distilled off, the obtained residue was purified by silica gel column chromatography to obtain 1-(3-methyl-4-nitrobenzyl)-4-(4-trifluoromethylphenyl)-1,4-dihydrotetrazol-5-one [2.6 g, ¹H-NMR (CDCl₃, ppm); 2.6 (3H, s), 5.3 (2H, s), 7.4-8.3 (7H, m)].

### Synthesis Example 9

### Starting Material Synthesis

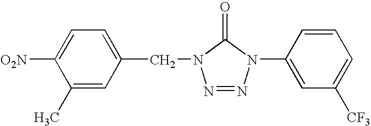

In a similar manner as Synthesis Example 8, by using 1-(3-trifluoromethyl-phenyl)-4-dihydro-tetrazol-5-one, 1-(3-methyl-4-nitro-benzyl)-4-(3-trifluoromethyl-phenyl)-1,4-dihydrotetrazol-5-one was obtained [¹H-NMR (CDCl₃, ppm); 2.6 (3H, s), 5.2 (2H, s), 7.3-8.2 (7H, m)].

### Synthesis Example 10

### Starting Material Synthesis

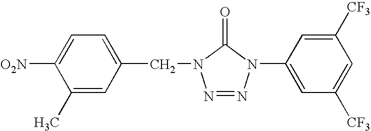

In a similar manner as Synthesis Example 8, by using 1-(3,5-bis-trifluoromethyl-phenyl)-1,4-dihydrotetrazol-5-one in place of 1-(4-trifluoromethyl-phenyl)-1,4-dihydro-tetrazol-5-one, 1-(3,5-bis-trifluoromethyl-phenyl)-4-(3-methyl-nitro-benzyl)-1,4-dihydro-tetrazol-5-one was obtained [¹H-NMR (CDCl₃, ppm); 2.6 (3H, s), 5.2 (2H, s), 7.2-8.0 (4H, m), 8.5 (2H, bs)].

### Synthesis Example 11

### Starting Material Synthesis

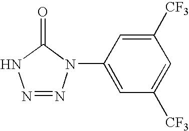

3,5-Bis(trifluoromethyl)phenyl isocyanate (10.20 g) and trimethylsilyl azide (9.36 g) were stirred at 120-130° C. for 10 hours. After the reaction mixture was brought to the room temperature, excess of trimethylsilyl azide was distilled off under reduced pressure and the obtained crude crystals were washed with petroleum ether to obtain 1-(3,5-bis-trifluoromethyl-phenyl)-1,4-dihydro-tetrazol-5-one (11.05 g, mp. 145-147° C.).

### Synthesis Example 12

### Starting Material Synthesis

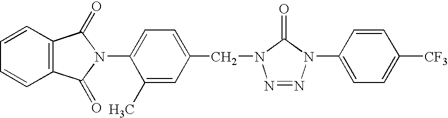

Phthalic anhydride (1.0 g) and 1-(4-amino-3-methylbenzyl)-4-(4-trifluoromethylphenyl)-1,4-dihydrotetrazol-5-one (2.4 g) were refluxed in 60 ml of acetic acid for 3 hours. After finishing the reaction the solvent was distilled off under reduced pressure to obtain the objected 2-{2-methyl-4-[5-oxo-4-(4-trifluoromethylphenyl)-4,5-dihydrotetrazol-1-ylmethyl]phenyl}isoindol-1,3-dione [3.0 g, ¹H NMR (DMSO-d₆, ppm); 2.1 (3H, s), 5.2 (2H, s), 7.3-8.2 (1H, m)].

### Synthesis Example 13

### Starting Material Synthesis

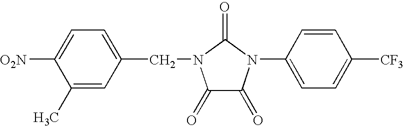

1-(3-Methyl-4-nitrobenzyl)-3-(4-trifluoromethylphenyl)urea (1.0 g) was dissolved in 20 ml of dichloromethane, to which 5 ml of dichloromethane solution of oxalyl chloride (0.49 g) was added at room temperature, and the mixture was stirred for 8 hours. After the solvent was distilled off under reduced pressure, the obtained residue was purified by silica gel column chromatography to obtain the objected 1-(3-methyl-4-nitrobenzyl)-3-(4-trifluoromethylphenyl)imidazolidin-2,4,5-trione [1.1 g, ¹H NMR (CDCl₃, ppm); 2.6 (3H, s), 4.9 (2H, s), 7.3-8.0 (7H, m)].

### Synthesis Example 14

### Starting Material Synthesis

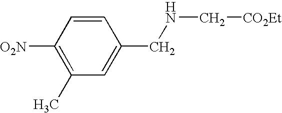

Methanol solution (5 ml) of 3-methyl-4-nitrobenzaldehyde (0.9 g) was added to a methanol suspension (5 ml) of glycine ethyl ester acetate (1.1 g) and sodium cyanotrihydroborate (0.53 g) at 0° C. After stirring the mixture at room temperature for 10 hours, 2N hydrochloric acid (10 ml) and ethyl acetate (10 ml) were added thereto. After removing the organic layer, 1N aqueous solution of sodium hydroxide (30 ml) was added to the aqueous layer and extracted with ethyl acetate. After washing the organic layer with a saturated aqueous solution of sodium chloride (20 ml), it was dried with anhydrous magnesium sulfate. After the solvent was distilled off under reduced pressure, the obtained residue was purified by silica gel column chromatography to obtain the objected ethyl(3-methyl-4-nitrobenzylamino)acetate [0.9 g, ¹H NMR (CDCl₃, ppm); 1.2 (3H, t), 2.6 (3H, s), 3.4 (2H, s), 3.9 (2H, s), 4.2 (2H, q), 4.8 (2H, s), 7.2-8.1 (3H, m)].

### Synthesis Example 15

### Starting Material Synthesis

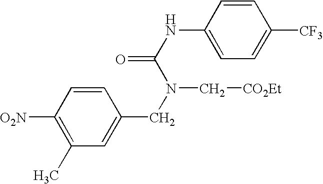

4-(trifluoromethyl)phenylisocyanate (0.83 g) was added to a diethyl ether solution (50 ml) of ethyl(3-methyl-4-nitrobenzylamino)acetate (0.9 g) and the mixture was stirred vigorously at room temperature for 7 hours. By filtering the crystals a crude product ethyl[1-(3-methyl-4-nitrobenzyl)-3-(4-trifluoromethylphenyl)ureido]acetate (0.8 g) was obtained and used in the next reaction without purification.

### Synthesis Example 16

### Starting Material Synthesis

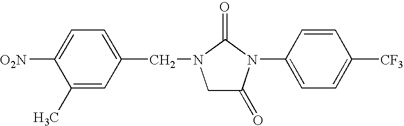

Acetic acid solution (10 ml) of ethyl[1-(3-methyl-4-nitrobenzyl)-3-(4-trifluoromethylphenyl)ureido]acetate (0.5 g) and concentrated hydrochloric acid (3 ml) was refluxed for 5 hours. After adding water (50 ml) the mixture was extracted with ethyl acetate. After washing the organic layer with water and a saturated aqueous solution of sodium chloride, it was dried with anhydrous magnesium sulfate. After the solvent was distilled off under reduced pressure, the obtained residue was purified by silica gel column chromatography to obtain the objected 1-(3-methyl-4-nitrobenzyl)-3-(4-trifluoromethylphenyl)imidazolidin-2,4-dione [0.3 g, ¹H NMR (CDCl₃, ppm); 2.7 (3H, s), 4.0 (2H, s), 4.8 (2H, s), 7.2-8.2 (7H, m)].

### Synthesis Example 17

### Starting Material Synthesis

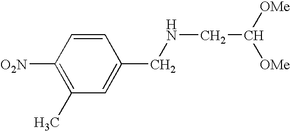

4-Chloromethyl-2-methyl-1-nitrobenzene (1.9 g), aminoacetaldehyde dimethyl acetal (6.3 g) and potassium carbonate (6.2 g) were mixed in acetonitrile (200 ml) and the mixture was refluxed for 20 hours. After adding water the mixture was extracted with ethyl acetate. After washing the organic layer with a saturated aqueous solution of sodium chloride, it was dried with anhydrous magnesium sulfate. After the solvent was distilled off under reduced pressure, the obtained residue was purified by silica gel column chromatography to obtain the objected (2,2-dimethoxyethyl)-3-(methyl-4-nitrobenzyl)amine [2.5 g, ¹H NMR (CDCl₃, ppm); 2.6 (3H, s), 2.8 (2H, d), 3.5 (6H, s), 3.9 (2H, s), 4.6 (1H, m), 7.2-8.1 (4H, m)].

### Synthesis Example 18

### Starting Material Synthesis

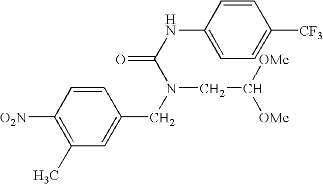

(2,2-Dimethoxyethyl)-3-(methyl-4-nitrobenzyl)amine (1.2 g) was dissolved in ether (50 ml), to which 4-(trifluoromethyl)phenyl isocyanate (1.3 g) was added at room temperature, and the mixture was stirred vigorously for 7 hours. After finishing the reaction, water was added to the mixture and it was extracted with ethyl acetate. After drying the organic layer with anhydrous magnesium sulfate, the solvent was distilled off under reduced pressure to obtain a crude product 1-(2,2-dimethoxyethyl)-1-(3-metyl-4-nitrobenzyl)-4-(trifluoromethylphenyl)urea (1.8 g), which was used in the next reaction without purification.

### Synthesis Example 19

### Starting Material Synthesis

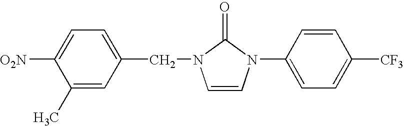

1-(2,2-Dimethoxyethyl)-1-(3-methyl-4-nitrobenzyl)-3-(4-(trifluoromethylphenyl)urea (1.8 g) was dissolved in THF (5 ml), to which 50% aqueous solution of trifluoroacetic acid (20 ml), and the mixture was stirred at room temperature. After finishing the reaction and adding water, the mixture was extracted with ethyl acetate. After washing the organic layer with water and a saturated aqueous solution of sodium chloride, it was dried with anhydrous magnesium sulfate. After the solvent was distilled off under reduced pressure, the obtained residue was purified by silica gel column chromatography to obtain the objected 1-(3-methyl-4-nitrobenzyl)-3-(4-(trifluoromethylphenyl)-1,3-dihydroimidazol-2-one [1.2 g, ¹H NMR (CDCl₃, ppm); 2.6 (3H, s), 4.9 (2H, s), 6.4 (1H, d), 6.7 (1H, d), 7.2-8.1 (7H, m)].

### Biological Test Example 1

### Test Against Larva of Spodoptera litura

Preparation of Test Agent:

Solvent: Dimethylformamide 3 parts by weight

Emulsifier: Polyoxyethylene alkyl phenyl ether 1 part by weight

In order to make an appropriate formulation of an active compound, 1 part by weight of the active compound was mixed with the above-mentioned amount of solvent containing the above-mentioned amount of emulsifier and the mixture was diluted with water to a prescribed concentration.

Test Method:

Leaves of sweet potato were soaked in the test agent diluted to a prescribed concentration with water, dried in the air and put in a dish of 9 cm diameter. 10 larvae of Spodoptera litura at the third instar were placed on the leaves and kept in a room at the constant temperature of 25° C. After 2 and 4 days further leaves of sweet potato were added and after 7 days the number of dead larvae was counted and the rate of death was calculated.

In this test the results of 2 dishes at 1 section were averaged.

Test Results:

As specific examples the compounds of the compound no. 2-7,2-35, 2-67, 2-71, 2-72, 2-96, 2-140, 2-141, 2-142, 2-147, 2-173, 2-176, 2-181, 2-182, 2-270, 2-283, 2-293, 2-323, 2-333 and 2-337 showed 100% of rate of death at 20 ppm concentration of effective component.

### Biological Test Example 2

### Test Against Larva of Cnaphalocrocis medinalis Guenee

Test Method:

Rice seedlings (cultivar: Tamanishiki) of 4-5 leaf stage, planted in a vinyl pot (9 cm diameter) were sprayed with the diluted aqueous solution of the prescribed concentration of the active compound prepared in the same manner as in the above mentioned Biological Test Example 1. After drying, top ⅓ part of the leaves of the plants was cut and put into a Petri-dish (9 cm diameter), in which a piece of filter paper (9 cm diameter) was laid and moistened. Five larvae of Cnaphalocrocis medinalis at the second instar were released in the Petri-dish and the dish was placed in a room at the constant temperature of 25° C. After 2 and 4 days, another ⅓ part of the plant leaves was cut and added to the dish. After seven days, the number of dead larvae was counted and the rate of death was calculated. In this test the results of 2 dishes at 1 treatment were averaged.

Test Results:

As specific examples the compounds of the compound no. 2-12, 2-17, 2-50, 2-54, 2-140, 2-141, 2-154, 2-172, 2-173, 2-234, 2-248, 2-253, 2-256, 2-310, 2-333, 2-337, 4-8,4-15 and 4-16 showed 100% of rate of death at 20 ppm concentration of effective component.

### Formulation Example 1

### Granule

To a mixture of 10 parts of the compound of the present invention (o. 2-7), 30 parts of bentonite (montmorillonite), 58 parts of talc and 2 parts of ligninsulfonate salt, 25 parts of water are added, well kneaded, made into granules of 10-40 mesh by an extrusion granulator and dried at 40-50° C. to obtain granules.

### Formulation Example 2

### Granules

95 Parts of clay mineral particles having particle diameter distribution in the range of 0.2-2 mm are put in a rotary mixer. While rotating it 5 parts of the compound of the present invention (No. 2-173) are sprayed together with a liquid diluent, wetted uniformly and dried at 40-50° C. to obtain granules.

### Formulation Example 3

### Emulsifiable Concentrate

30 Parts of the compound of the present invention (No. 2-140), 55 parts of xylene, 8 parts of polyoxyethylene alkyl phenyl ether and 7 parts of calcium alkylbenzenesulfonate are mixed and stirred to obtain an emulsifiable concentrate.

### Formulation Example 4

### Wettable Powder

Parts of the compound of the present invention (No. 2-333), 80 parts of a mixture of white carbon (hydrous amorphous silicon oxide fine powders) and powder clay (1:5), 2 parts of sodium alkylbenzenesulfonate and 3 parts of sodium alkylnaphthalenesulfonate-formalin-condensate are crushed and mixed to make a wettable powder.

### Formulation Example 5

### Water Dispersible Granule

Parts of the compound of the present invention (No. 2-337), 30 parts of sodium ligninsulfonate, 15 parts of bentonite and 35 parts of calcined diatomaceous earth powder are well mixed, added with water, extruded with 0.3 mm screen and dried to obtain water dispersible granules.

1-7. (canceled)

8. A phthalamide derivative of formula (I) 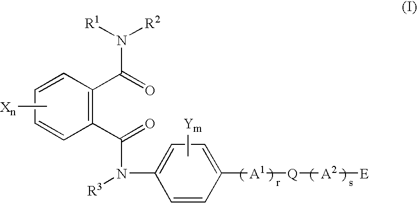
wherein
X represents hydrogen, halogen, C₁-C₆-alkyl, C₁-C₆-haloalkyl, nitro, cyano, C₁-C₆-alkylsulfonyloxy, C₁-C₆-haloalkylsulfonyloxy, phenylsulfonyloxy, C₁-C₆-alkylthio-C₁-C₆-alkyl, C₁-C₆-alkylsulfinyl-C₁-C₆-alkyl, C₁-C₆-alkylsulfonyl-C₁-C₆-alkyl, C₁-C₆-alkylsulfonylamino, bis(C₁-C₆-alkylsulfonyl)amino, or C₁-C₆-alkoxy-carbonyl,
n represents 1, 2, 3, or 4,
Y represents hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-haloalkylthio, or cyano,
m represents 1, 2, 3, or 4,
R¹ represents C₁-C₈-alkyl that is optionally mono- or polysubstituted by substituents selected from the group consisting of cyano, nitro, C₁-C₆-alkylaminosulfonyl, N,N-di(C₁-C₆-alkyl)aminosulfonyl, C₁-C₆-alkylsulfonylamino, N—C₁-C₆-alkylsulfonyl-N—C₁-C₆-alkylamino, C₁-C₆-alkyl-carbonylamino, halo-C₁-C₆-alkyl, N—C₁-C₆-alkyl-carbonyl-N—C₁-C₆-alkylamino, C₁-C₆-alkylthio-carbonylamino, N—C₁-C₆-alkylthiocarbonyl-N—C₁-C₆-alkylamino, C₁-C₆-alkoxyimino-C₁-C₆-alkyl, C₁-C₆-alkyl-aminocarbonyl, N,N-di(C₁-C₆-alkyl)aminocarbonyl, C₁-C₆-alkyl-aminothiocarbonyl, N,N-di(C₁-C₆-alkyl)-aminothiocarbonyl, C₁-C₆-alkoxy-carbonylamino, C₁-C₆-alkoxy-carbonyl-C₁-C₆-alkylamino, C₁-C₆-alkylamino-carbonyloxy, N,N-di(C₁-C₆-alkyl)amino-carbonyloxy, C₁-C₆-alkoxy-thiocarbonylamino, C₁-C₆-alkoxy-thiocarbonyl-C₁-C₆-alkylamino, C₁-C₆-alkylamino-thiocarbonyloxy, N,N-di(C₁-C₆-alkyl)amino-thiocarbonyloxy, C₁-C₆-alkylthio-carbonylamino, C₁-C₆-alkylthiocarbonyl-C₁-C₆-alkylamino, C₁-C₆-alkylamino-carbonylthio, N,N-di(C₁-C₆-alkyl)amino-carbonylthio, C₁-C₆-alkylthio-thiocarbonylamino, C₁-C₆-alkylthio-thiocarbonyl-C₁-C₆-alkylamino, C₁-C₆-alkylamino-thiocarbonylthio, N,N-di(C₁-C₆-alkyl)amino-thiocarbonylthio, C₃-C₆-cycloalkyl, C₁-C₆-alkoxy-C₁-C₆-alkyl, C₁-C₆-alkylthio-C₁-C₆-alkyl, C₁-C₆-alkylsulfinyl-C₁-C₆-alkyl, and C₁-C₆-alkylsulfonyl-C₁-C₆-alkyl; or represents C₃-C₈-cycloalkyl that is optionally substituted by substituents selected from the group consisting of C₁-C₄-alkyl, C₁-C₄-alkylthio, and C₁-C₂-alkylthio-C₁-C₂-alkyl,
R² represents hydrogen or C₁-C₆-alkyl,
R³ represents hydrogen or C₁-C₆-alkyl,
A¹ represents straight chain or branched chain C₁-C₈-alkylene, C₁-C₈-haloalkylene, C₂-C₈-alkenylene, C₂-C₈-haloalkenylene, C₂-C₈-alkynylene, C₂-C₈-haloalkynylene, C₁-C₈-alkylene-amino, C₁-C₈-alkylene(C₁-C₆-alkylamino), C₁-C₈-alkyleneoxy, or C₁-C₈-alkylenethio,
r represents 0 or 1,
A² represents straight chain or branched chain C₁-C₈-alkylene, C₁-C₈-haloalkylene, C₂-C₈-alkenylene, C₂-C₈-haloalkenylene, C₂-C₈-alkynylene, or C₂-C₈-haloalkynylene,
s represents 0 or 1,
Q represents a 5- or 6-membered heterocyclic group containing 1 to 4 heteroatoms selected from 0 to 4 nitrogen atoms, 0 to 1 oxygen atom, and 0 to 1 sulphur atom, with the proviso that Q does not simultaneously contain an oxygen atom and a sulphur atom, wherein the heterocyclic group optionally has one to three 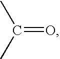
one to three 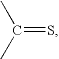
one 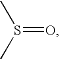
or one 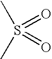
as ring constituents and optionally is substituted with one or more identical or different substituents W¹,
W¹ represents halogen, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio, C₁-C₆-haloalkylsulfinyl, C₁-C₆-haloalkylsulfonyl, C₃-C₆-cycloalkyl, C₁-C₆-alkylthio-C₁-C₆-alkyl, C₁-C₆-alkylsulfinyl-C₁-C₆-alkyl, or C₁-C₆-alkylsulfonyl-C₁-C₆-alkyl,
E represents phenyl, biphenyl, naphthyl, pyridyl, pyridazinyl, pyrimidinyl, pyrazinyl, thienyl, furyl, or pyrrolyl, each of which is optionally substituted with one or more identical or different substituents W², and
W² represents halogen, nitro, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio, C₁-C₆-haloalkylsulfinyl, C₁-C₆-haloalkylsulfonyl, C₃-C₆-cycloalkyl, C₁-C₆-alkylthio-C₁-C₆-alkyl, C₁-C₆-alkylsulfinyl-C₁-C₆-alkyl, or C₁-C₆-alkylsulfonyl-C₁-C₆-alkyl, or two adjacent substituents W² together represent C₃-C₅-alkylene, C₃-C₅-haloalkylene, oxy-C₂-C₄-alkylene, oxy-C₂-C₄-haloalkylene, C₂-C₄-alkyleneoxy, C₂-C₄-haloalkyleneoxy, C₁-C₃-alkylenedioxy, or C₁-C₃-haloalkylenedioxy.

9. A compound according to claim 8, wherein
X represents hydrogen, halogen, C₁-C₄-alkyl, C₁-C₄-haloalkyl, nitro, cyano, C₁-C₄-alkylsulfonyloxy, C₁-C₄-haloalkylsulfonyloxy, phenylsulfonyloxy, C₁-C₄-alkylthio-C₁-C₄-alkyl, C₁-C₄-alkylsulfinyl-C₁-C₄-alkyl, C₁-C₄-alkylsulfonyl-C₁-C₄-alkyl, C₁-C₄-alkylsulfonylamino, bis(C₁-C₄-alkylsulfonyl)amino, or C₁-C₄-alkoxy-carbonyl,
n represents 1, 2, 3, or 4,
Y represents hydrogen, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, or cyano,
m represents 1, 2, 3, or 4,
R¹ represents C₁-C₆-alkyl that is optionally mono- or polysubstituted by substituents selected from the group consisting of cyano, nitro, C₁-C₄-alkylaminosulfonyl, N,N-di(C₁-C₄-alkyl)aminosulfonyl, C₁-C₄-alkylsulfonylamino, N—C₁-C₄-alkylsulfonyl-N—C₁-C₄-alkylamino, C₁-C₄-alkyl-carbonylamino, halo-C₁-C₄-alkyl, N—C₁-C₄-alkyl-carbonyl-N—C₁-C₄-alkylamino, C₁-C₄-alkylthio-carbonylamino, N—C₁-C₄-alkylthiocarbonyl-N—C₁-C₄-alkylamino, C₁-C₄-alkoxyimino-C₁-C₄-alkyl, C₁-C₄-alkyl-aminocarbonyl, N,N-di(C₁-C₄-alkyl)aminocarbonyl, C₁-C₄-alkyl-aminothiocarbonyl, N,N-di(C₁-C₄-alkyl)-aminothiocarbonyl, C₁-C₄-alkoxy-carbonylamino, C₁-C₄-alkoxy-carbonyl-C₁-C₄-alkylamino, C₁-C₄-alkylamino-carbonyloxy, N,N-di(C₁-C₄-alkyl)amino-carbonyloxy, C₁-C₄-alkoxy-thiocarbonylamino, C₁-C₄-alkoxy-thiocarbonyl-C₁-C₄-alkylamino, C₁-C₄-alkylamino-thiocarbonyloxy, N,N-di(C₁-C₄-alkyl)amino-thiocarbonyloxy, C₁-C₄-alkylthio-carbonylamino, C₁-C₄-alkylthio-carbonyl-C₁-C₄-alkylamino, C₁-C₄-alkylamino-carbonylthio, N,N-di(C₁-C₄-alkyl)amino-carbonylthio, C₁-C₄-alkylthio-thiocarbonylamino, C₁-C₄-alkylthio-thiocarbonyl-C₁-C₄-alkylamino, C₁-C₄-alkylamino-thiocarbonylthio, N,N-di(C₁-C₄-alkyl)amino-thiocarbonylthio, C₃-C₆-cycloalkyl, C₁-C₄-alkoxy-C₁-C₄-alkyl, C₁-C₄-alkylthio-C₁-C₄-alkyl, C₁-C₄-alkylsulfinyl-C₁-C₄-alkyl, and C₁-C₄-alkylsulfonyl-C₁-C₄-alkyl; or represents C₃-C₆-cycloalkyl that is optionally substituted by C₁-C₂-alkyl, C₁-C₂-alkylthio or C₁-C₂-alkylthio-C₁-C₂-alkyl,
R² represents hydrogen or C₁-C₄-alkyl,
R³ represents hydrogen or C₁-C₄-alkyl,
A¹ represents straight chain or branched chain C₁-C₆-alkylene, C₁-C₆-haloalkylene, C₂-C₆-alkenylene, C₂-C₆-haloalkenylene, C₂-C₆-alkynylene, C₂-C₆-haloalkynylene, C₁-C₆-alkylene-amino, C₁-C₆-alkylene(C₁-C₄-alkylamino), C₁-C₆-alkyleneoxy, or C₁-C₆-alkylenethio,
r represents 0 or 1,
A² represents straight chain or branched chain C₁-C₆-alkylene, C₁-C₆-haloalkylene, C₂-C₆-alkenylene, C₂-C₆-haloalkenylene, C₂-C₆-alkynylene, or C₂-C₆-haloalkynylene,
s represents 0 or 1,
Q represents pyridinylene, pyridazinylene, pyrimidinylene, or pyrazinylene, each of which is optionally substituted with one or more identical or different substituents W¹, or further represents a group 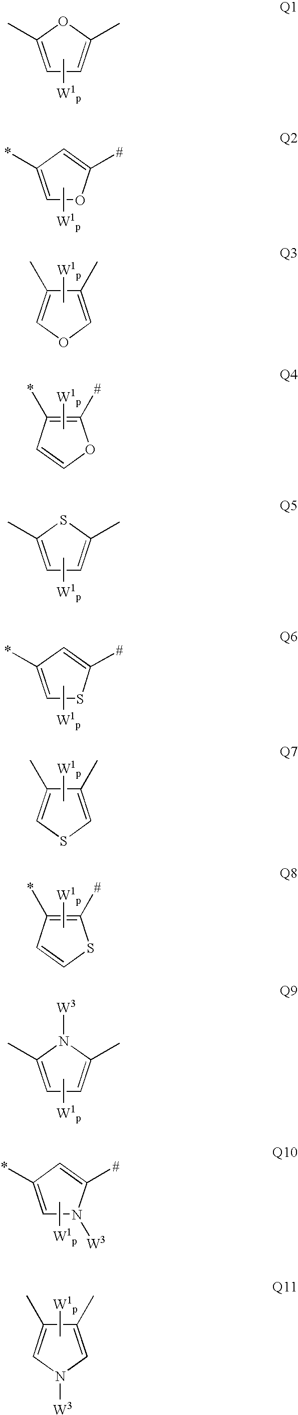 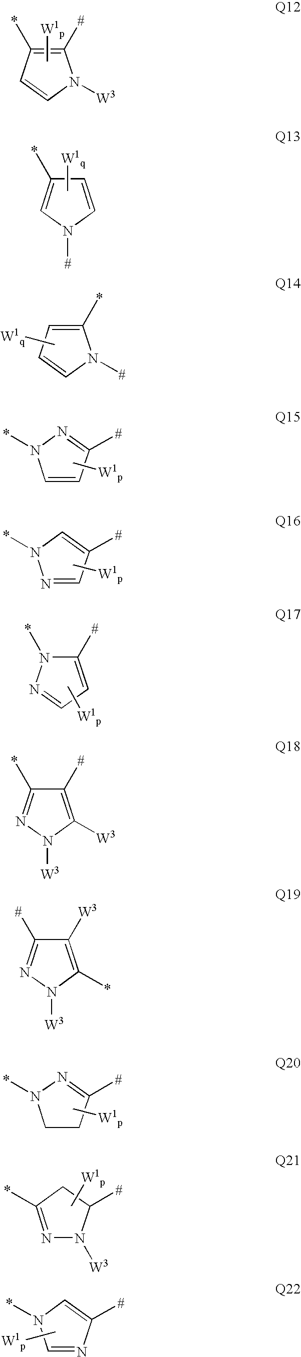 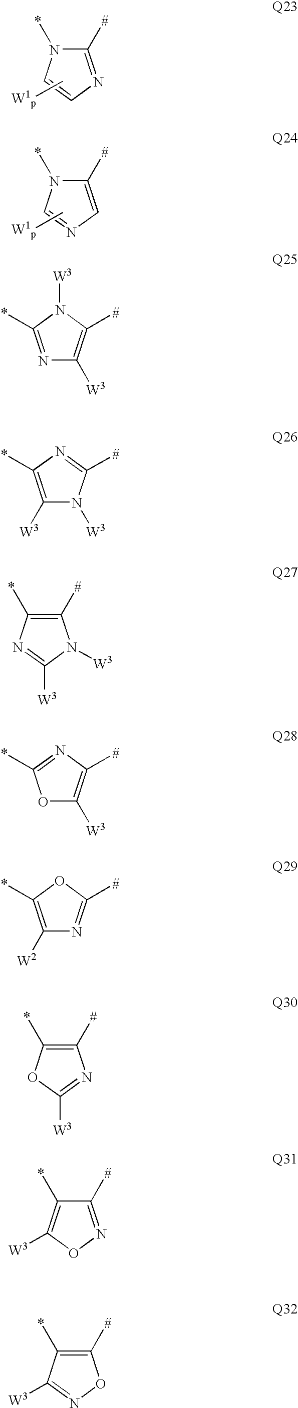 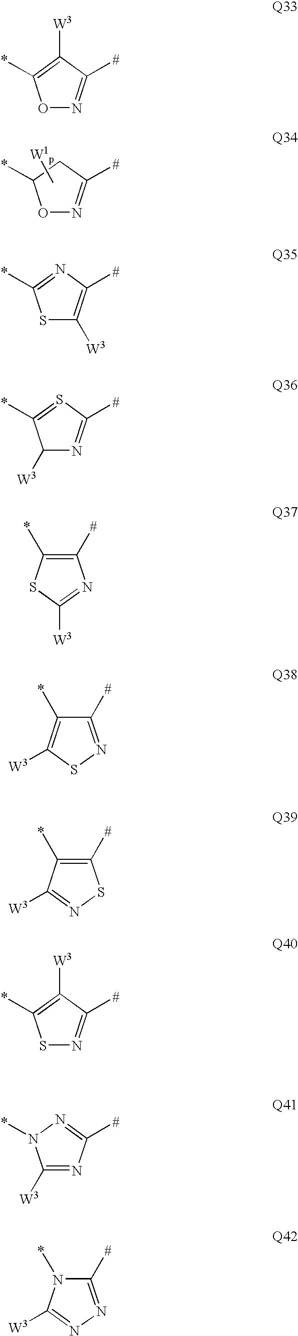 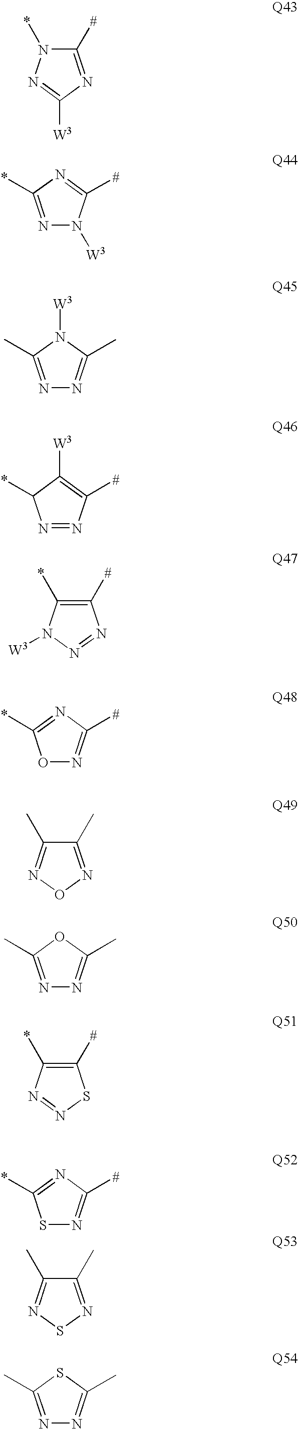 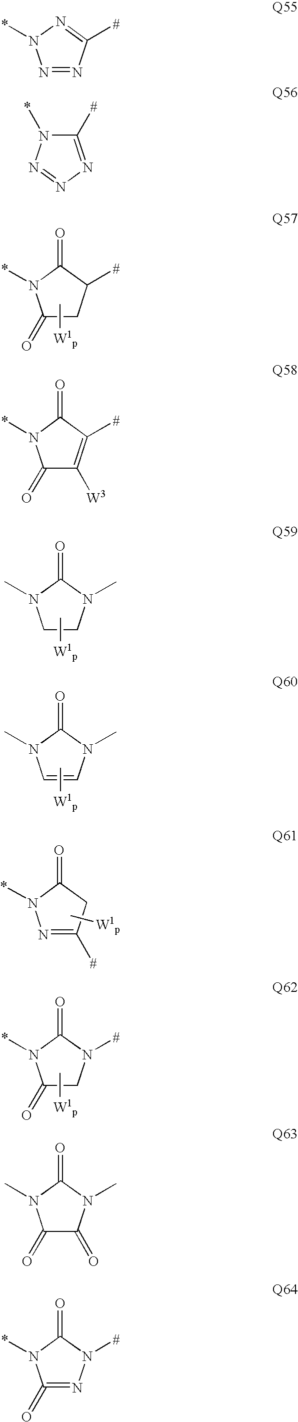 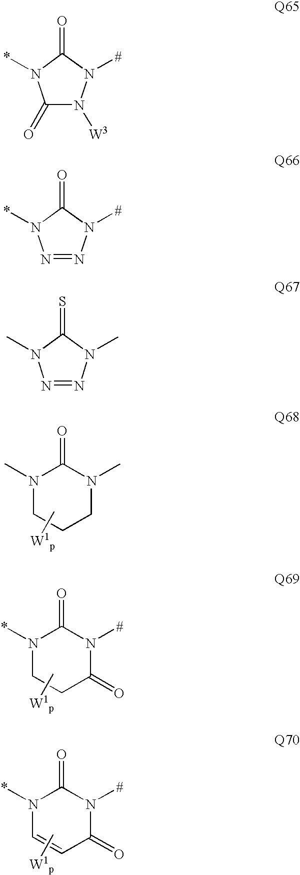
wherein the bond marked with * connects with A¹ and the bond marked with # connects with A² or the bond marked with # connects with A¹ and the bond marked with * connects with A²,
W¹ represents halogen, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio, C₁-C₆-haloalkylsulfinyl, C₁-C₆-haloalkylsulfonyl, C₃-C₆-cycloalkyl, C₁-C₆-alkylthio-C₁-C₆-alkyl, C₁-C₆-alkylsulfinyl-C₁-C₆-alkyl, C₁-C₆-alkylsulfonyl-C₁-C₆-alkyl,
E represents phenyl, biphenyl, naphthyl, pyridyl, pyridazinyl, pyrimidinyl, pyrazinyl, thienyl, furyl, or pyrrolyl, each of groups is optionally substituted with one or more identical or different substituents W²,
W² represents halogen, nitro, C₁-C₆-alkyl, C₁-C₆-alkoxy, C₁-C₆-alkylthio, C₁-C₆-alkylsulfinyl, C₁-C₆-alkylsulfonyl, C₁-C₆-haloalkyl, C₁-C₆-haloalkoxy, C₁-C₆-haloalkylthio, C₁-C₆-haloalkylsulfinyl, C₁-C₆-haloalkylsulfonyl, C₃-C₆-cycloalkyl, C₁-C₆-alkylthio-C₁-C₆-alkyl, C₁-C₆-alkylsulfinyl-C₁-C₆-alkyl, or C₁-C₆-alkylsulfonyl-C₁-C₆-alkyl, or two adjacent substituents W² together represent C₃-C₅-alkylene, C₃-C₅-haloalkylene, oxy-C₂-C₄-alkylene, oxy-C₂-C₄-haloalkylene, C₂-C₄-alkyleneoxy, C₂-C₄-haloalkyleneoxy, C₁-C₃-alkylenedioxy, or C₁-C₃-haloalkylenedioxy,
W³ represents hydrogen or has the same definition as substituent W¹,
p represents 0, 1, or 2, and
q represents 0, 1, 2 or 3.

10. A process for the preparation of compounds of formula (I) according to claim 8 comprising
(a) for compounds of formula (I) in which R² represents hydrogen, reacting a compound of formula (II) 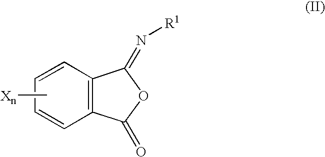
wherein R¹, X, and n have the same definitions as given for formula (I) in claim 8,
with a compound of formula (III) 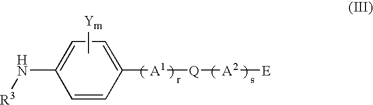
wherein R³, Y, m, A¹, r, Q, A², s, and E have the same definition as given for formula (I) in claim 8,
in the presence of inert solvents, or
(b) for compounds of formula (I) in which R³ represents hydrogen,
reacting a compound of formula (IV) 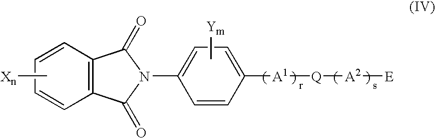
wherein X, n, Y, m, A¹, r, Q, A², s, and E have the same definition as given for formula (I) in claim 8,
with a compound of formula (V) 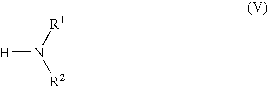
wherein R¹ and R² have the same definition as given for formula (I) in claim 8,
in the presence of inert solvents and optionally in the presence of a base, or
(c) reacting a compound of formula (VI) 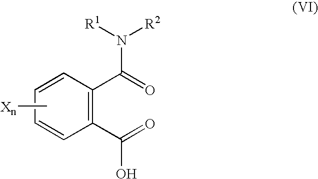
wherein X, n, R¹ and R² have the same definition as given for formula (I) in claim 8,
with a compound of formula (III), 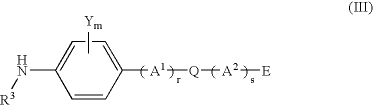
wherein R³, Y, m, A¹, r, Q, A², s and E have the same definition as given for formula (I) in claim 8,
in the presence of inert solvents, or
(d) for compounds of formula (I) in which R³ represents hydrogen,
reacting a compound of formula (VII) 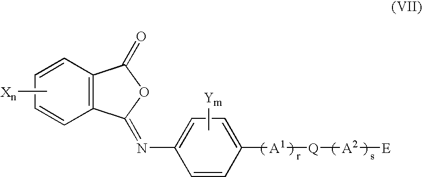
wherein X, n, Y, m, A¹, r, Q, A², s, and E have the same definition as given for formula (I) in claim 8,
with a compound of formula (V), 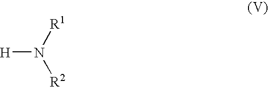
wherein R¹ and R² have the same definition as given for formula (I) in claim 8,
in the presence of inert solvents, or
(e) reacting a compound of formula (VII) 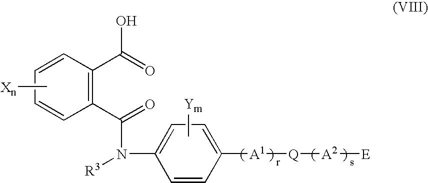
wherein X, n, R³, Y, m, A¹, r, Q, A², s, and E have the same definition as given for formula (I) in claim 8,
with a compound of formula (V), 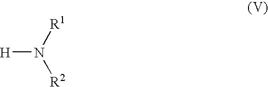
wherein R¹ and R² have the same definition as given for formula (I) in claim 8,
in the presence of inert solvents, or
(f) for compounds of formula (I) in which R¹ represents C₁-C₆-alkylsulfinyl-C₁-C₆-alkyl, or C₁-C₆-alkylsulfonyl-C₁-C₆-alkyl,
reacting a compound of formula (If) 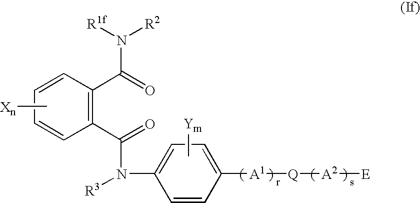
wherein
R^{1f} represents C₁-C₆-alkylthio-C₁-C₆-alkyl, and
X, n, R², R³, Y, m, A¹, r, Q, A², s and E have the same definition as given for formula (I) in claim 8,
with an oxidizing agent in the presence of inert solvents.

11. A pesticide comprising one or more compounds of formula (I) according to claim 8.

12. A method of combating harmful insects comprising allowing an effective amount of a compound of formula (I) according to claim 8 to act on pests and/or their habitat.

13. A process for preparing compositions for combating harmful insects comprising mixing one or more compounds of formula (I) according to claim 8 with one or more extenders and/or surface active agents.
